(19) United States
(12) Patent Application Publication
(10) Pub. No.: US 2026/0288023 A1
(43) Pub. Date: Sep. 24, 2026

(54) ELECTROPHOTOGRAPHIC PHOTORECEPTOR, PROCESS CARTRIDGE, AND IMAGE FORMING APPARATUS

(71) Applicant: FUJIFILM Business Innovation Corp., Tokyo (JP)

(72) Inventors: Tomoya SASAKI, Kanagawa (JP); Masahiro IWASAKI, Kanagawa (JP); Yuki OYAMADA, Kanagawa (JP); Kosuke NARITA, Kanagawa (JP)

(73) Assignee: FUJIFILM Business Innovation Corp., Tokyo (JP)

(21) Appl. No.: 19/306,356

(22) Filed: Aug. 21, 2025

(30) Foreign Application Priority Data
Mar. 24, 2025 (JP) 2025-049117

(51) Int. Cl. G03G 5/06; G03G 5/047; G03G 5/05

(52) U.S. Cl. CPC G03G 5/0648; G03G 5/047; G03G 5/0546; G03G 5/0564; G03G 2215/00957; G03G 2215/00962; G03G 2221/183

(57) ABSTRACT

An electrophotographic photoreceptor includes a conductive substrate; an undercoat layer that is disposed on the conductive substrate and contains a binder resin and an electron transport material represented by a general formula (P) below; and a photosensitive layer that is disposed on the undercoat layer and contains at least one resin of a polyarylate resin containing a dicarboxylic unit represented by a formula (A) below and a diol unit represented by a formula (B) below and a polycarbonate resin containing a biphenyl-containing constitutional unit represented by a formula (BP) below in an amount of more than 15 mol % relative to all constitutional units,

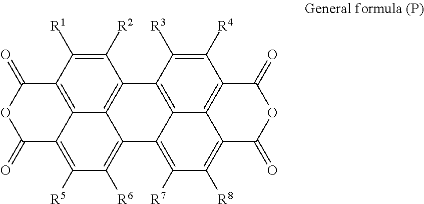

in which in the general formula (P), R¹, R², R³, R⁴, R⁵, R⁶, R⁷, and R⁸ each independently represent a hydrogen atom, an alkyl group, an alkoxy group, an aralkyl group, an aryl group, an alkoxycarbonyl group, or a halogen atom,

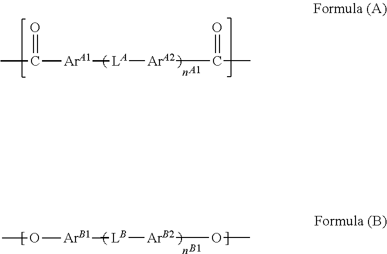

in the formula (A), Ar^{A1} and Ar^{A2} are each independently an aromatic ring that may have a substituent, L^{A} is a single bond or a divalent linking group, n^{A1} is 0, 1, or 2,
in the formula (B), Ar^{B1} and Ar^{B2} are each independently an aromatic ring that may have a substituent, L^{B} is a single bond, an oxygen atom, a sulfur atom, or —C(Rb¹)(Rb²)—, n^{B1} is 0, 1, or 2, Rb¹ and Rb² are each independently a hydrogen atom, an alkyl group having 1 or more and 20 or less carbon atoms, an aryl group having 6 or more and 12 or less carbon atoms, or an aralkyl group having 7 or more and 20 or less carbon atoms, Rb¹ and Rb² may be bonded together to form a cyclic alkyl group,

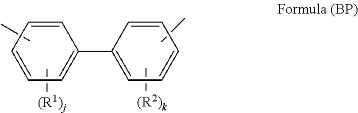

in the formula (BP), j is an integer of 0 or more and 4 or less, j R¹'s are each independently a methyl group or an ethyl group, k is an integer of 0 or more and 4 or less, and k R²'s are each independently a methyl group or an ethyl group.

### CROSS-REFERENCE TO RELATED APPLICATIONS

This application is based on and claims priority under 35 USC 119 from Japanese Patent Application No. 2025-049117 filed Mar. 24, 2025.

### BACKGROUND

### (i) Technical Field

The present disclosure relates to an electrophotographic photoreceptor, a process cartridge, and an image forming apparatus.

### (ii) Related Art

Japanese Unexamined Patent Application Publication No. 2011-095665 discloses an electrophotographic photoreceptor in which an intermediate layer and a photosensitive layer are disposed on a conductive support, wherein the intermediate layer contains a polyolefin resin and an organic electron transport material, and the organic electron transport material is a compound selected from the group consisting of imide-based compounds, benzimidazole-based compounds, quinone-based compounds, cyclopentadienylidene-based compounds, azo-based compounds, and derivatives of the foregoing.

Japanese Unexamined Patent Application Publication No. 2024-176961 discloses an electrophotographic photoreceptor including a conductive substrate, an undercoat layer disposed on the conductive substrate, and a photosensitive layer disposed on the undercoat layer, wherein the undercoat layer contains a binder resin and a perinone compound having a specified structure, the photosensitive layer contains a polyester resin (1) having a specified structure, and a mass ratio of the polyester resin (1) to the photosensitive layer is 15 mass % or more.

### SUMMARY

Electrophotographic photoreceptors of the related art including a conductive substrate, an undercoat layer, and a photosensitive layer employ undercoat layers containing a binder resin and an electron transport material (A), (B), or (C) below to thereby control the charge retention property, but undergo fluctuation in the charging potential due to variations in humidity and temperature in some cases. By contrast, aspects of non-limiting embodiments of the present disclosure relate to an electrophotographic photoreceptor that suppresses both of fluctuation in the charging potential due to variations in humidity and temperature (hereafter also referred to as “fluctuation in the charging potential due to environmental variations”) and fluctuation in the post-exposure potential due to variations in humidity and temperature (hereafter also referred to as “fluctuation in the post-exposure potential due to environmental variations”), compared with the case of employing the undercoat layer containing a binder resin and an electron transport material (A), (B), or (C) below or the case of employing, as the binder resin of the photosensitive layer, a bisphenol Z polycarbonate resin below (hereafter also referred to as PC-C2) alone.

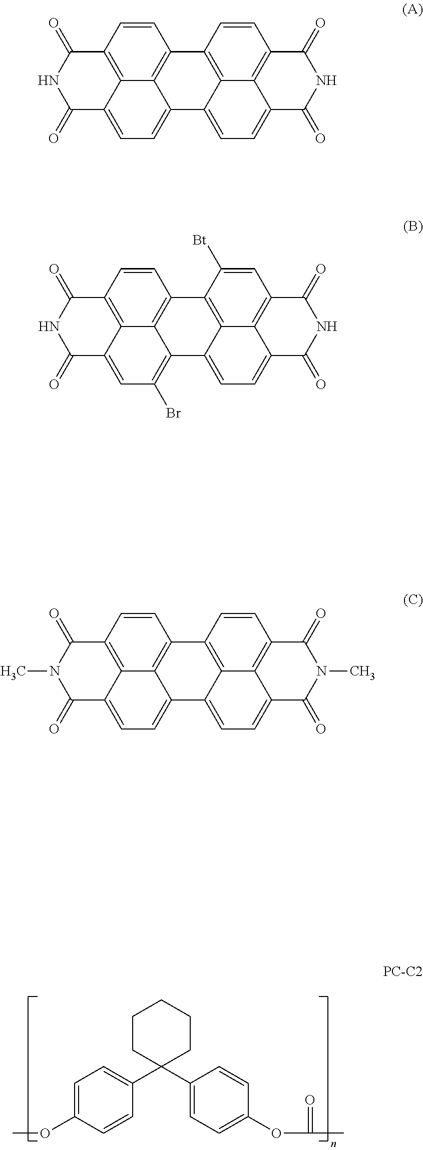

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an electrophotographic photoreceptor including:
a conductive substrate;
an undercoat layer that is disposed on the conductive substrate and contains a binder resin and an electron transport material represented by a general formula (P) below; and
a photosensitive layer that is disposed on the undercoat layer and contains at least one resin of a polyarylate resin containing a dicarboxylic unit represented by a formula (A) below and a diol unit represented by a formula (B) below and a polycarbonate resin containing a biphenyl-containing constitutional unit represented by a formula (BP) below in an amount of more than 15 mol % relative to all constitutional units,

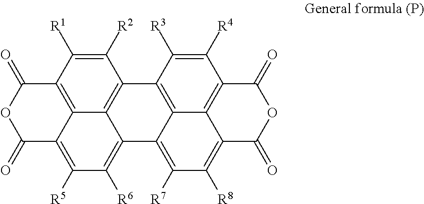

wherein in the general formula (P), R¹, R², R³, R⁴, R⁵, R⁶, R⁷, and R⁸ each independently represent a hydrogen atom, an alkyl group, an alkoxy group, an aralkyl group, an aryl group, an alkoxycarbonyl group, or a halogen atom,

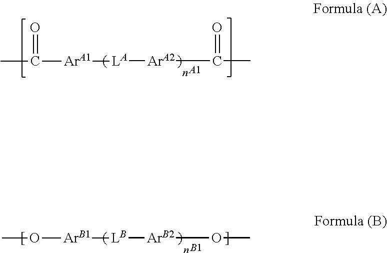

in the formula (A), Ar^{A1} and Ar^{A2} are each independently an aromatic ring that may have a substituent, L^{A} is a single bond or a divalent linking group, n^{A1} is 0, 1, or 2,
in the formula (B), Ar^{B1} and Ar^{B2} are each independently an aromatic ring that may have a substituent, L^{B} is a single bond, an oxygen atom, a sulfur atom, or —C(Rb¹)(Rb²)—, n^{B1} is 0, 1, or 2, Rb¹ and Rb² are each independently a hydrogen atom, an alkyl group having 1 or more and 20 or less carbon atoms, an aryl group having 6 or more and 12 or less carbon atoms, or an aralkyl group having 7 or more and 20 or less carbon atoms, Rb¹ and Rb² may be bonded together to form a cyclic alkyl group,

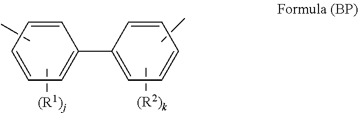

in the formula (BP), j is an integer of 0 or more and 4 or less, j R¹'s are each independently a methyl group or an ethyl group, k is an integer of 0 or more and 4 or less, and k R²'s are each independently a methyl group or an ethyl group.

### BRIEF DESCRIPTION OF THE DRAWINGS

Exemplary embodiments of the present disclosure will be described in detail based on the following figures, wherein:

FIG. 1 is a partial sectional view illustrating an example of the layer configuration of an electrophotographic photoreceptor according to the present disclosure;

FIG. 2 is a partial sectional view illustrating another example of the layer configuration of an electrophotographic photoreceptor according to the present disclosure;

FIG. 3 is a schematic configuration view illustrating an example of an image forming apparatus according to the present disclosure; and

FIG. 4 is a schematic configuration view illustrating another example of an image forming apparatus according to the present disclosure.

### DETAILED DESCRIPTION

Hereinafter, exemplary embodiments of the present disclosure will be described. Such descriptions and Examples are examples of the exemplary embodiments and do not limit the scope of the exemplary embodiments.

In the present disclosure, numerical ranges described as “a value to another value” represent a range respectively including the value and the other value as the minimum value and the maximum value.

In the present disclosure, in stepwise-described numerical ranges, the upper limit value or the lower limit value described in a numerical range may be replaced by the upper limit value or the lower limit value of another stepwise-described numerical range. In the present disclosure, in numerical ranges, the upper limit values or the lower limit values described in the numerical ranges may be replaced by values described in Examples.

In the present disclosure, the term “step” includes not only an independent step, but also a step that is not clearly distinguished from other steps as long as an object of the step is achieved.

In the present disclosure, when exemplary embodiments are described with reference to drawings, the configurations of the exemplary embodiments are not limited to the configurations in the drawings. The sizes of the members in the drawings are conceptual and the relative sizes among the members are not limited thereto.

In the present disclosure, components may each contain a plurality of substances. In the present disclosure, when the amounts of components in compositions are referred to and such a composition contains, as a component, a plurality of substances, the amount of the component means the total amount of the plurality of substances in the composition unless otherwise specified.

In the present disclosure, components may each include a plurality of types of particles. When a composition contains a component including a plurality of types of particles, the particle diameter of the component means that of the mixture of the plurality of types of particles in the composition unless otherwise specified.

In the present disclosure, alkyl groups and alkylene groups include linear groups, branched groups, and cyclic groups unless otherwise specified.

In the present disclosure, for organic groups, aromatic rings, linking groups, alkyl groups, alkylene groups, aryl groups, aralkyl groups, alkoxy groups, aryloxy groups, and the like, hydrogen atoms in such groups may be substituted with halogen atoms.

In the present disclosure, compounds may be represented by structural formulas in which symbols (C and H) representing carbon atoms and hydrogen atoms in hydrocarbon groups and/or hydrocarbon chains are omitted.

In the present disclosure, “constitutional units” of copolymers or resins have the same meaning as monomer units.

### Electrophotographic Photoreceptor

An electrophotographic photoreceptor according to the present disclosure (hereafter also referred to as “photoreceptor”) includes a conductive substrate, an undercoat layer disposed on the conductive substrate, and a photosensitive layer disposed on the undercoat layer.

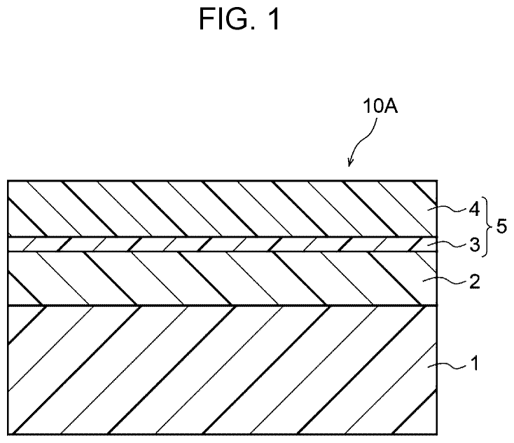

FIG. 1 is a partial sectional view schematically illustrating an example of the layer configuration of the photoreceptor according to the present disclosure. In FIG. 1, a photoreceptor 10A includes a multilayer photosensitive layer. The photoreceptor 10A has a structure in which, on a conductive substrate 1, an undercoat layer 2, a charge generation layer 3, and a charge transport layer 4 are stacked in this order, and the charge generation layer 3 and the charge transport layer 4 constitute a photosensitive layer 5 (namely, a functionally separated photosensitive layer). The photoreceptor 10A may include an intermediate layer (not shown) between the undercoat layer 2 and the charge generation layer 3.

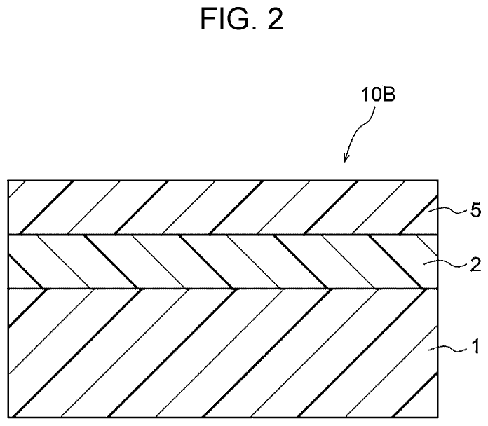

FIG. 2 is a partial sectional view schematically illustrating another example of the layer configuration of the photoreceptor according to the present disclosure. In FIG. 2, a photoreceptor 10B includes a single-layer photosensitive layer. The photoreceptor 10B has a structure in which, on a conductive substrate 1, an undercoat layer 2 and a photosensitive layer 5 are stacked in this order. The photoreceptor 10B may include an intermediate layer (not shown) between the undercoat layer 2 and the photosensitive layer 5.

The electrophotographic photoreceptor according to the present disclosure includes a conductive substrate, an undercoat layer that is disposed on the conductive substrate and contains a binder resin and an electron transport material represented by a general formula (P) below, and a photosensitive layer that is disposed on the undercoat layer and includes at least one resin of a polyarylate resin containing a dicarboxylic unit represented by a formula (A) below and a diol unit represented by a formula (B) below, and a polycarbonate resin containing a biphenyl-containing constitutional unit represented by a formula (BP) below in an amount of more than 15 mol % relative to all constitutional units.

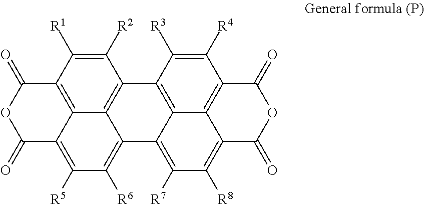

In the general formula (P), R¹, R², R³, R⁴, R⁵, R⁶, R⁷, and R⁸ each independently represent a hydrogen atom, an alkyl group, an alkoxy group, an aralkyl group, an aryl group, an alkoxycarbonyl group, or a halogen atom.

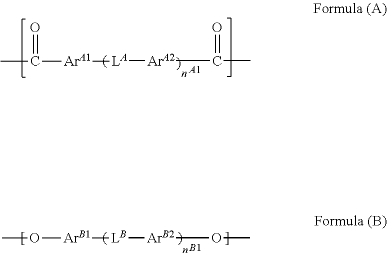

In the formula (A), Ar^{A1} and Ar^{A2} are each independently an aromatic ring that may have a substituent, L^{A} is a single bond or a divalent linking group, and n^{A1} is 0, 1, or 2.

In the formula (B), Ar^{B1} and Ar^{B2} are each independently an aromatic ring that may have a substituent, L^{B} is a single bond, an oxygen atom, a sulfur atom, or —C(Rb¹)(Rb²)—, and n^{B1} is 0, 1, or 2. Rb¹ and Rb² are each independently a hydrogen atom, an alkyl group having 1 or more and 20 or less carbon atoms, an aryl group having 6 or more and 12 or less carbon atoms, or an aralkyl group having 7 or more and 20 or less carbon atoms, and Rb¹ and Rb² may be bonded together to form a cyclic alkyl group.

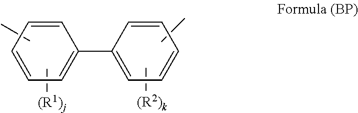

In the formula (BP), j is an integer of 0 or more and 4 or less, j R¹'s are each independently a methyl group or an ethyl group, k is an integer of 0 or more and 4 or less, and k R²'s are each independently a methyl group or an ethyl group.

When the photosensitive layer of the photoreceptor according to the present disclosure is, as in the photoreceptor 10A illustrated in FIG. 1, a multilayer photosensitive layer including a charge generation layer and a charge transport layer, at least the charge transport layer contains at least one resin of “polyarylate resin containing a dicarboxylic unit represented by the formula (A) and a diol unit represented by the formula (B)” and “polycarbonate resin containing a biphenyl-containing constitutional unit represented by the formula (BP) in an amount of more than 15 mol % relative to all constitutional units”. The charge generation layer may or may not contain the polyarylate resin or the polycarbonate resin.

In the related art, when photoreceptors including an undercoat layer and a photosensitive layer are subjected to variation in humidity or temperature (for example, variation from 10° C., 15% RH to 30° C., 85% RH), the undercoat layer and the photosensitive layer may each expand due to moisture absorption or contract due to drying. In this case, when the undercoat layer contains, for example, an imide-based electron transport material (for example, the above-described compounds (A), (B), and (C)), the layer is particularly susceptible to the effect of humidity or temperature, which tends to cause disordered orientation of the electron transport material and fluctuations in the bonding state at the interface where the photosensitive layer and the undercoat layer face each other. As a result, the charging potential and the post-exposure potential each tend to considerably fluctuate before and after environmental variations.

By contrast, the photoreceptor according to the present disclosure has the above-described features, so that both of fluctuation in the charging potential and fluctuation in the post-exposure potential due to environmental variations may be suppressed. The mechanism for this is not necessarily clarified, but is inferred as follows. The photoreceptor according to the present disclosure contains, in the undercoat layer, the electron transport material represented by the general formula (P). The electron transport material represented by the general formula (P) may have excellent molecular orientation and, even when humidity or temperature varies and the undercoat layer expands or contracts, the orientation within the layer may tend to be maintained.

The photoreceptor according to the present disclosure contains, in the photosensitive layer, at least one of the polyarylate resin having the specified structure and the polycarbonate resin having the specified amount and the specified structure. The polyarylate resin and the polycarbonate resin having the structure and the amount may each have high aggregatability and hence, in a photosensitive layer containing such a resin, contraction and moisture absorption of the photosensitive layer may be suppressed even when humidity or temperature varies.

Thus, in the photoreceptor according to the present disclosure, due to synergistic effects provided by the combination of the undercoat layer containing the electron transport material represented by the general formula (P) and the photosensitive layer containing the polyarylate resin and the polycarbonate resin having the structure and the amount, both of fluctuation in the charging potential and fluctuation in the post-exposure potential due to environmental variations may be suppressed.

The photoreceptor according to the present disclosure has the above-described features, so that it may also exhibit a high charge retention property upon repeated image formation. In the related art, in photoreceptors including an undercoat layer containing an imide-based electron transport material (for example, the above-described compounds (A), (B), and (C)), the imide-based electron transport material has a molecular skeleton including an electron-donating nitrogen atom and there is a tendency of slight hole transport to occur within the undercoat layer upon repeated image formation. By contrast, the photoreceptor according to the present disclosure contains, in the undercoat layer, the electron transport material represented by the general formula (P), so that hole transport may be less likely to occur within the undercoat layer. This may inferentially result in a high charge retention property upon repeated image formation.

The photoreceptor according to the present disclosure has the above-described features and may also exhibit a high retention property of the post-exposure potential upon repeated image formation.

In the related art, in photoreceptors including an undercoat layer containing an imide-based electron transport material (for example, the above-described compounds (A), (B), and (C)), the imide tends to cause disorientation of the electron transport material within the undercoat layer and the electron transport material tends to have decreased uniformity within the layer. By contrast, the photoreceptor according to the present disclosure contains, in the undercoat layer, the electron transport material that is represented by the general formula (P) and may exhibit excellent molecular orientation, so that the electron transport material may tend to have increased uniformity within the layer. In addition, the photosensitive layer contains at least one of the polyarylate resin having the specified structure and the polycarbonate resin having the specified amount and the specified structure. This may cause reduction in the difference between the electron injection property from the photosensitive layer to the undercoat layer upon exposure and the hole injection property from the charge generation material to the charge transport material in the photosensitive layer (in the case of a multilayer photosensitive layer, from the charge generation layer to the charge transport layer), so that charge accumulation caused by repeated exposure and charging may be suppressed. This may inferentially result in a high retention property of the post-exposure potential even under physical stress caused by repeated image formation.

The chemical composition of the undercoat layer can be determined by publicly known methods. For example, the layers above the undercoat layer in the electrophotographic photoreceptor are stripped off and the remaining member is ground to prepare a test piece; the test piece is subjected to infrared absorption spectroscopy (IR) to analyze the overall structure and partial structures of the components contained in the test piece and subjected to X-ray photoelectron spectroscopy (XPS) to analyze the elements in the components and the bonding state of the elements. The test piece is, for example, immersed in a solvent to extract or disperse the components to separate the components; the sample is concentrated and subjected to NMR (nuclear magnetic resonance) analysis to analyze the overall structure and partial structures, subjected to MS analysis (mass spectrometry) to analyze the molecular weights, subjected to LC (liquid chromatography) to identify the components, or subjected to GPC (gel permeation chromatography) to analyze the molecular weights of the resins. In this way, the electron transport material and resins contained in the undercoat layer are identified.

The chemical composition of the photosensitive layer can be determined in the following manner.

The photosensitive layer (in the case of a multilayer photosensitive layer, the charge transport layer) is stripped from the photoreceptor and used as a test piece. The test piece is subjected to a reprecipitation method to separate a precipitate containing a resin component and a charge transport material; the precipitate is subsequently subjected to infrared absorption spectroscopy (IR), NMR (nuclear magnetic resonance) analysis, or MS analysis (mass spectrometry), or subjected to optionally alkaline treatment to cause decomposition into monomers and subjected to similar analyses to thereby identify the resin.

Hereinafter, layers of the photoreceptor according to the present disclosure will be described in detail.

### Undercoat Layer

The undercoat layer contains a binder resin and an electron transport material represented by a general formula (P) below.

The undercoat layer may contain another material other than the binder resin and the electron transport material represented by the following general formula (P).

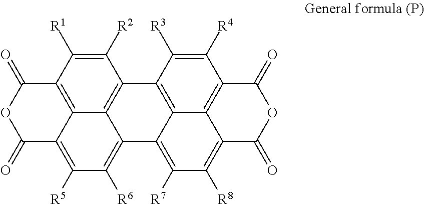

In the general formula (P), R¹, R², R³, R⁴, R⁵, R⁶, R⁷, and R⁸ each independently represent a hydrogen atom, an alkyl group, an alkoxy group, an aralkyl group, an aryl group, an alkoxycarbonyl group, or a halogen atom.

The electron transport material represented by the general formula (P) may exhibit high electron transport properties and low hole transport properties. Thus, when the undercoat layer contains the electron transport material represented by the general formula (P), the electron transport material in the undercoat layer may have higher molecular orientation. As a result, the undercoat layer may have high electron transport properties and dark decay may be reduced, so that both of fluctuation in the charging potential and fluctuation in the post-exposure potential due to environmental variations may be suppressed. In addition, a high charge retention property upon repeated image formation may be provided. In addition, a high retention property of the post-exposure potential even under physical stress caused by repeated image formation may be provided.

In the general formula (P), R¹, R², R³, R⁴, R⁵, R⁶, R⁷, and R⁸ each independently represent preferably a hydrogen atom or a halogen atom, more preferably a hydrogen atom.

In the general formula (P), when R¹ to R⁸ are a hydrogen atom or a halogen atom (more preferably a hydrogen atom), the electron transport material in the undercoat layer may have higher molecular orientation. As a result, the undercoat layer may have higher electron transport properties and dark decay may be further reduced, so that both of fluctuation in the charging potential and fluctuation in the post-exposure potential due to environmental variations may be further suppressed. In addition, a higher charge retention property upon repeated image formation may be provided. In addition, a higher retention property of post-exposure potential even under physical stress caused by repeated image formation may be provided.

In the general formula (P), the alkyl groups represented by R¹ to R⁸ may be substituted or unsubstituted alkyl groups.

In the general formula (P), for R¹ to R⁸, the unsubstituted alkyl group may be a linear alkyl group having 1 or more and 20 or less carbon atoms (preferably having 1 or more and 10 or less carbon atoms, more preferably having 1 or more and 6 or less carbon atoms), a branched alkyl group having 3 or more and 20 or less carbon atoms (preferably having 3 or more and 10 or less carbon atoms), or a cyclic alkyl group having 3 or more and 20 or less carbon atoms (preferably having 3 or more and 10 or less carbon atoms).

Examples of the linear alkyl group having 1 or more and 20 or less carbon atoms include a methyl group, an ethyl group, an n-propyl group, an n-butyl group, an n-pentyl group, an n-hexyl group, an n-heptyl group, an n-octyl group, an n-nonyl group, an n-decyl group, an n-undecyl group, an n-dodecyl group, a tridecyl group, an n-tetradecyl group, an n-pentadecyl group, an n-heptadecyl group, an n-octadecyl group, an n-nonadecyl group, and an n-icosyl group.

Examples of the branched alkyl group having 3 or more and 20 or less carbon atoms include an isopropyl group, an isobutyl group, a sec-butyl group, a tert-butyl group, an isopentyl group, a neopentyl group, a tert-pentyl group, an isohexyl group, a sec-hexyl group, a tert-hexyl group, an isoheptyl group, a sec-heptyl group, a tert-heptyl group, an isooctyl group, a sec-octyl group, a tert-octyl group, an isononyl group, a sec-nonyl group, a tert-nonyl group, an isodecyl group, a sec-decyl group, a tert-decyl group, an isododecyl group, a sec-dodecyl group, a tert-dodecyl group, a tert-tetradecyl group, and a tert-pentadecyl group.

Examples of the cyclic alkyl group having 3 or more and 20 or less carbon atoms include a cyclopropyl group, a cyclobutyl group, a cyclopentyl group, a cyclohexyl group, a cycloheptyl group, a cyclooctyl group, a cyclononyl group, a cyclodecyl group, and polycyclic (for example, bicyclo, tricyclo, or spiro ring) alkyl groups in which the foregoing monocyclic alkyl groups are linked together.

Among the above, the unsubstituted alkyl group is preferably a linear alkyl group such as a methyl group or an ethyl group.

In the alkyl group, the substituent may be an alkoxy group, a hydroxy group, a carboxy group, a nitro group, or a halogen atom (such as a fluorine atom, a bromine atom, or an iodine atom).

In the alkyl group, the alkoxy group substituting a hydrogen atom may be the same as the unsubstituted alkoxy groups represented by R¹ to R⁸ in the general formula (P).

In the general formula (P), for R¹ to R⁸, the alkoxy group may be a substituted or unsubstituted alkoxy group.

In the general formula (P), for R¹ to R⁸, the unsubstituted alkoxy group may be a linear, branched, or cyclic alkoxy group having 1 or more and 10 or less carbon atoms (preferably having 1 or more and 6 or less carbon atoms, more preferably 1 or more and 4 or less carbon atoms).

Specific examples of the linear alkoxy group include a methoxy group, an ethoxy group, an n-propoxy group, an n-butoxy group, an n-pentyloxy group, an n-hexyloxy group, an n-heptyloxy group, an n-octyloxy group, an n-nonyloxy group, and an n-decyloxy group.

Specific examples of the branched alkoxy group include an isopropoxy group, an isobutoxy group, a sec-butoxy group, a tert-butoxy group, an isopentyloxy group, a neopentyloxy group, a tert-pentyloxy group, an isohexyloxy group, a sec-hexyloxy group, a tert-hexyloxy group, an isoheptyloxy group, a sec-heptyloxy group, a tert-heptyloxy group, an isooctyloxy group, a sec-octyloxy group, a tert-octyloxy group, an isononyloxy group, a sec-nonyloxy group, a tert-nonyloxy group, an isodecyloxy group, a sec-decyloxy group, and a tert-decyloxy group.

Specific examples of the cyclic alkoxy group include a cyclopropoxy group, a cyclobutoxy group, a cyclopentyloxy group, a cyclohexyloxy group, a cycloheptyloxy group, a cyclooctyloxy group, a cyclononyloxy group, and a cyclodecyloxy group.

Among the above, the unsubstituted alkoxy group is preferably the linear alkoxy group.

In the alkoxy group, a substituent may be an aryl group, an alkoxycarbonyl group, an aryloxy carbonyl group, a hydroxy group, a carboxy group, a nitro group, or a halogen atom (such as a fluorine atom, a bromine atom, or an iodine atom).

In the alkoxy group, the aryl group substituting a hydrogen atom may be the same as the unsubstituted aryl groups represented by R¹ to R⁸ in the general formula (P).

In the alkoxy group, the alkoxycarbonyl group substituting a hydrogen atom may be the same as the unsubstituted alkoxycarbonyl groups represented by R¹ to R⁸ in the general formula (P).

In the alkoxy group, the aryloxy carbonyl group substituting a hydrogen atom may be the same as the unsubstituted aryloxy carbonyl groups represented by R¹ to R⁸ in the general formula (P).

In the general formula (P), for R¹ to R⁸, the aralkyl group may be a substituted or unsubstituted aralkyl group.

In the general formula (P), for R¹ to R⁸, the unsubstituted aralkyl group is preferably an aralkyl group having 7 or more and 30 or less carbon atoms, more preferably an aralkyl group having 7 or more and 16 or less carbon atoms, still more preferably an aralkyl group having 7 or more and 12 or less carbon atoms.

Examples of the unsubstituted aralkyl group having 7 or more and 30 or less carbon atoms include a benzyl group, a phenylethyl group, a phenylpropyl group, a 4-phenylbutyl group, a phenylpentyl group, a phenylhexyl group, a phenylheptyl group, a phenyloctyl group, a phenylnonyl group, a naphthylmethyl group, a naphthylethyl group, an anthracenylmethyl group, and a phenyl-cyclopentylmethyl group.

In the aralkyl group, a substituent may be an alkoxy group, an alkoxycarbonyl group, or a halogen atom (such as a fluorine atom, a bromine atom, or an iodine atom).

In the aralkyl group, the alkoxy group substituting a hydrogen atom may be the same as the unsubstituted alkoxy groups represented by R¹ to R⁸ in the general formula (P).

In the aralkyl group, the alkoxycarbonyl group substituting a hydrogen atom may be the same as the unsubstituted alkoxycarbonyl groups represented by R¹ to R⁸ in the general formula (P).

In the general formula (P), for R¹ to R⁸, the aryl group may be a substituted or unsubstituted aryl group.

In the general formula (P), for R¹ to R⁸, the unsubstituted aryl group is preferably an aryl group having 6 or more and 30 or less carbon atoms, more preferably an aryl group having 6 or more and 14 or less carbon atoms, still more preferably an aryl group having 6 or more and 10 or less carbon atoms.

Examples of the aryl group having 6 or more and 30 or less carbon atoms include a phenyl group, a biphenyl group, a 1-naphthyl group, a 2-naphthyl group, a 9-anthryl group, a 9-phenanthryl group, a 1-pyrenyl group, a 5-naphthacenyl group, a 1-indenyl group, a 2-azulenyl group, a 9-fluorenyl group, a biphenylenyl group, an indacenyl group, a fluoranthenyl group, an acenaphthylenyl group, an aceanthrylenyl group, a phenalenyl group, a fluorenyl group, an anthryl group, a bianthracenyl group, a teranthracenyl group, a quateranthracenyl group, an anthraquinonyl group, a phenanthryl group, a triphenylenyl group, a pyrenyl group, a chrysenyl group, a naphthacenyl group, a pleiadenyl group, a picenyl group, a perylenyl group, a pentaphenyl group, a pentacenyl group, a tetraphenylenyl group, a hexaphenyl group, a hexacenyl group, a rubicenyl group, and a coronenyl group. Among the above, preferred is a phenyl group.

In the aryl group, a substituent may be an alkyl group, an alkoxy group, an alkoxycarbonyl group, an aryloxy carbonyl group, or a halogen atom (such as a fluorine atom, a bromine atom, or an iodine atom).

In the aryl group, the alkyl group substituting a hydrogen atom may be the same as the unsubstituted alkyl groups represented by R¹ to R⁸ in the general formula (P).

In the aryl group, the alkoxy group substituting a hydrogen atom may be the same as the unsubstituted alkoxy groups represented by R¹ to R⁸ in the general formula (P).

In the aryl group, the alkoxycarbonyl group substituting a hydrogen atom may be the same as the unsubstituted alkoxycarbonyl groups represented by R¹ to R⁸ in the general formula (P).

In the general formula (P), for R¹ to R⁸, the alkoxycarbonyl group may be a substituted or unsubstituted alkoxycarbonyl group.

In the general formula (P), for R¹ to R⁸, the unsubstituted alkoxycarbonyl group has an alkyl chain having preferably 1 or more and 20 or less carbon atoms, more preferably 1 or more and 15 or less carbon atoms, still more preferably 1 or more and 10 or less carbon atoms.

Examples of the alkoxycarbonyl group having an alkyl chain having 1 or more and 20 or less carbon atoms include a methoxycarbonyl group, an ethoxycarbonyl group, a propoxycarbonyl group, an isopropoxycarbonyl group, an n-butoxycarbonyl group, a sec-butoxybutylcarbonyl group, a tert-butoxycarbonyl group, a pentaoxycarbonyl group, a hexaoxycarbonyl group, a heptaoxycarbonyl group, an octaoxycarbonyl group, a nonaoxycarbonyl group, a decaoxycarbonyl group, a dodecaoxycarbonyl group, a tridecaoxycarbonyl group, a tetradecaoxycarbonyl group, a pentadecaoxycarbonyl group, a hexadecaoxycarbonyl group, a heptadecaoxycarbonyl group, an octadecaoxycarbonyl group, a nonadecaoxycarbonyl group, and an icosaoxycarbonyl group.

In the alkoxycarbonyl group, a substituent may be an aryl group, a hydroxy group, or a halogen atom (such as a fluorine atom, a bromine atom, or an iodine atom).

In the alkoxycarbonyl group, the aryl group substituting a hydrogen atom may be the same as the unsubstituted aryl groups represented by R¹ to R⁸ in the general formula (P).

In the general formula (P), examples of the halogen atoms represented by R¹ to R⁸ include fluorine atoms, chlorine atoms, bromine atoms, and iodine atoms.

The following are exemplary compounds of the electron transport material represented by the general formula (P); however, the present disclosure is not limited to these. Note that the numbers of the following exemplary compounds will be each described as an exemplary compound (P−number).

| | Exemplary compound of |
|---|---|
| | electron transport |
| Exemplary | material represented by |
| compound No. | general formula (P) |
| P-1 | 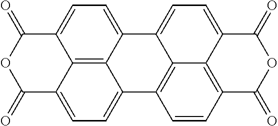 [SMILES: O=C1OC(=O)c2ccc3c4ccc5c6c(ccc(c7ccc1c2c73)c64)C(=O)OC5=O] |
| P-2 | 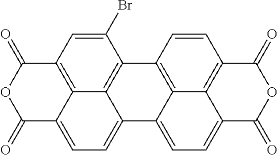 [SMILES: O=C1OC(=O)c2ccc3c4c(Br)cc5c6c(ccc(c7ccc1c2c73)c64)C(=O)OC5=O] |
| P-3 | 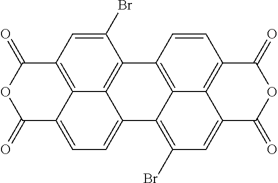 [SMILES: O=C1OC(=O)c2cc(Br)c3c4ccc5c6c(cc(Br)c(c7ccc1c2c73)c64)C(=O)OC5=O] |
| P-4 | 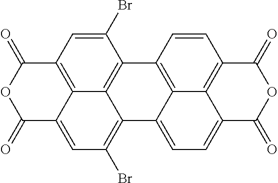 [SMILES: O=C1OC(=O)c2ccc3c4c(Br)cc5c6c(cc(Br)c(c7ccc1c2c73)c64)C(=O)OC5=O] |
| P-5 | 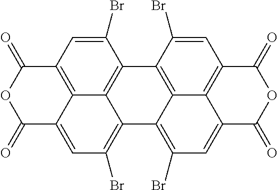 [SMILES: O=C1OC(=O)c2cc(Br)c3c4c(Br)cc5c6c(cc(Br)c(c7c(Br)cc1c2c73)c64)C(=O)OC5=O] |
| P-6 | 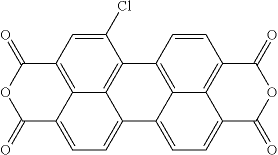 [SMILES: O=C1OC(=O)c2ccc3c4c(Cl)cc5c6c(ccc(c7ccc1c2c73)c64)C(=O)OC5=O] |
| P-7 | 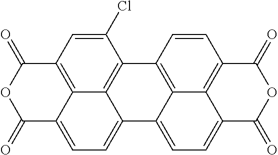 [SMILES: O=C1OC(=O)c2ccc3c4c(Cl)cc5c6c(ccc(c7ccc1c2c73)c64)C(=O)OC5=O] |
| P-8 | 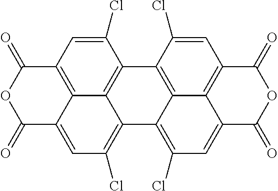 [SMILES: O=C1OC(=O)c2cc(Cl)c3c4c(Cl)cc5c6c(cc(Cl)c(c7c(Cl)cc1c2c73)c64)C(=O)OC5=O] |
| P-9 | 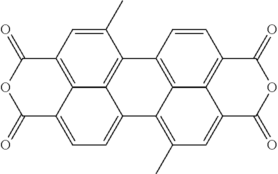 [SMILES: Cc1cc2c3c(ccc4c5c(C)cc6c7c(ccc(c1c34)c75)C(=O)OC6=O)C(=O)OC2=O] |
| P-10 | 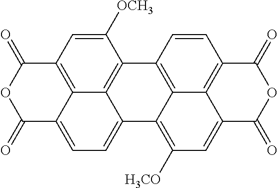 [SMILES: COc1cc2c3c(ccc4c5c(OC)cc6c7c(ccc(c1c34)c75)C(=O)OC6=O)C(=O)OC2=O] |
| P-11 | 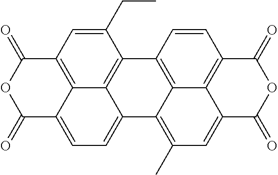 [SMILES: CCc1cc2c3c(ccc4c5c(C)cc6c7c(ccc(c1c34)c75)C(=O)OC6=O)C(=O)OC2=O] |
| P-12 | 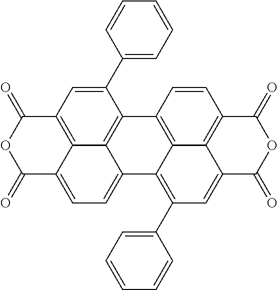 [SMILES: O=C1OC(=O)c2cc(-c3ccccc3)c3c4ccc5c6c(cc(-c7ccccc7)c(c7ccc1c2c73)c64)C(=O)OC5=O] |
| P-13 | 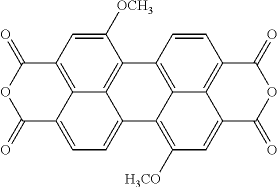 [SMILES: COc1cc2c3c(ccc4c5c(OC)cc6c7c(ccc(c1c34)c75)C(=O)OC6=O)C(=O)OC2=O] |
| P-14 | 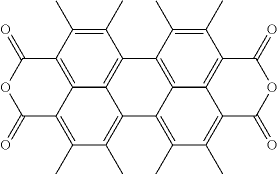 [SMILES: Cc1c2c3c(c(C)c(C)c4c5c(C)c(C)c6c7c(c(C)c(C)c(c(c1C)c34)c75)C(=O)OC6=O)C(=O)OC2=O] |
| P-15 | 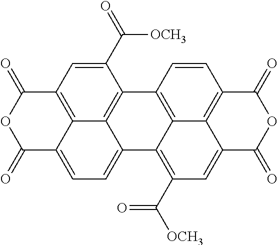 [SMILES: COC(=O)c1cc2c3c(ccc4c5c(C(=O)OC)cc6c7c(ccc(c1c34)c75)C(=O)OC6=O)C(=O)OC2=O] |
| P-16 | 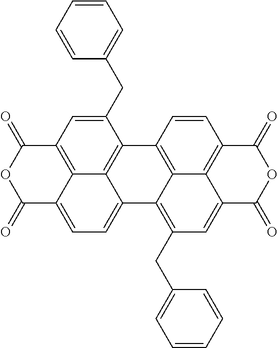 [SMILES: O=C1OC(=O)c2cc(Cc3ccccc3)c3c4ccc5c6c(cc(Cc7ccccc7)c(c7ccc1c2c73)c64)C(=O)OC5=O] |
| P-17 | 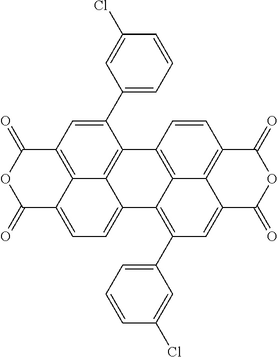 [SMILES: O=C1OC(=O)c2cc(-c3cccc(Cl)c3)c3c4ccc5c6c(cc(-c7cccc(Cl)c7)c(c7ccc1c2c73)c64)C(=O)OC5=O] |
| P-18 | 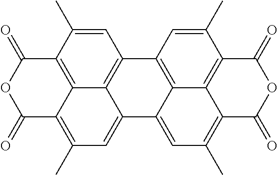 [SMILES: Cc1cc2c3cc(C)c4c5c(c(C)cc(c6cc(C)c7c(c1C(=O)OC7=O)c26)c53)C(=O)OC4=O] |

The electron transport material represented by the general formula (P) preferably has an average primary particle diameter of 1.00 μm or less, more preferably 0.03 μm or more and 1.00 μm or less, still more preferably 0.03 μm or more and 0.80 μm or less, particularly preferably 0.05 μm or more and 0.70 μm or less.

When the electron transport material represented by the general formula (P) has an average primary particle diameter of 1.00 μm or less, the electron transport material may be less likely to be localized within the undercoat layer and highly dispersed, so that higher electron transport properties and lower hole transport properties may tend to be provided. When the electron transport material has an average primary particle diameter of 0.03 μm or more, aggregation of the electron transport material may be suppressed and the electron transport material may be highly dispersed within the undercoat layer, so that higher electron transport properties and lower hole transport properties may tend to be provided. As a result, both of fluctuation in the charging potential and fluctuation in the post-exposure potential due to environmental variations may be further suppressed. In addition, a higher charge retention property upon repeated image formation may be provided. In addition, a higher retention property of the post-exposure potential even under physical stress caused by repeated image formation may be provided.

The average primary particle diameter of the electron transport material represented by the general formula (P) is determined in the following manner.

In a section of the layered structure of the electrophotographic photoreceptor in the thickness direction, the undercoat layer is observed using a SEM (scanning electron microscope) at a magnification of 100000× and the electron transport material represented by the general formula (P) is identified. In the obtained SEM image, of the electron transport material represented by the general formula (P), 10 primary particles are randomly selected and measured for particle diameters. The arithmetic average of the measured particle diameters is determined as the average primary particle diameter of the electron transport material.

The electron transport material represented by the general formula (P) preferably has an aspect ratio of 1.0 or more and 5 or less, more preferably 1.1 or more and 3 or less, still more preferably 1.2 or more and 2.5 or less.

When the electron transport material represented by the general formula (P) has an aspect ratio of 2.5 or less, the electron transport material may tend to be highly dispersed within the undercoat layer, so that higher electron transport properties and lower hole transport properties may tend to be provided. When the electron transport material has an aspect ratio of 1.0 or more and 5 or less, the electron transport material may tend to be highly dispersed within the undercoat layer, so that higher electron transport properties may be provided. As a result, both of fluctuation in the charging potential and fluctuation in the post-exposure potential due to environmental variations may be further suppressed. In addition, a higher charge retention property upon repeated image formation may be provided. In addition, a higher retention property of the post-exposure potential even under physical stress caused by repeated image formation may be provided.

The aspect ratio of the electron transport material represented by the general formula (P) means the ratio of the length of the major axis of the electron transport material to the length of the minor axis of the electron transport material (the length of the major axis/the length of the minor axis).

The length of the major axis of the electron transport material means the longest straight-line distance connecting one end to the other end in the major axis direction of the electron transport material. The length of the minor axis of the electron transport material means the longest straight-line distance connecting one end to the other end in the direction orthogonal to the major axis in the electron transport material.

The photosensitive layer (and optionally a protective layer) is removed from the electrophotographic photoreceptor; the undercoat layer is observed using a field-emission scanning electron microscope (manufactured by JEOL Ltd., JSM-6700F) at a magnification of 3000× to 100000× to identify the electron transport material represented by the general formula (P). In the obtained micrograph, 10 particles of the electron transport material are randomly selected; the lengths of the major axes and the lengths of the minor axes of the particles are measured and the aspect ratios (the length of the major axis/the length of the minor axis) are determined. The arithmetic average of the aspect ratios is determined as the aspect ratio of the electron transport material.

The method for adjusting the average primary particle diameter and the aspect ratio of the electron transport material represented by the general formula (P) to fall within the above-described ranges is not particularly limited, but may be, for example, a method of pulverizing the material using a ball mill, a bead mill, a mortar, a sand mill, a kneader, an attritor, or the like, or a method of dissolving the material in fluoroacetic acid, sulfuric acid, or the like and bringing the resultant solution into contact with water or poor solvent to precipitate fine crystals.

The undercoat layer may further contain another electron transport material other than the electron transport material represented by the general formula (P) as long as advantages of the present disclosure are provided.

In the undercoat layer, the ratio of the electron transport material represented by the general formula (P) to the total amount of the electron transport material is preferably 80 mass % or more and 100 mass % or less, more preferably 90 mass % or more and 100 mass % or less, still more preferably 95 mass % or more and 100 mass % or less.

The content of the electron transport material represented by the general formula (P) relative to the total solid content of the undercoat layer is preferably less than 70 mass %, more preferably 45 mass % or more and less than 60 mass %, still more preferably 50 mass % or more and less than 60 mass %.

When the content of the electron transport material represented by the general formula (P) is 90 mass % or less, film brittleness, low film formability, and surface roughness of the undercoat layer may be suppressed. As a result, both of fluctuation in the charging potential and fluctuation in the post-exposure potential due to environmental variations may be further suppressed. In addition, a higher retention property of the post-exposure potential even under physical stress caused by repeated image formation may be provided.

On the other hand, when the content of the electron transport material is 30 mass % or more, a sufficiently high electron transport capability may be provided and a higher charge retention property may be provided. As a result, both of fluctuation in the charging potential and fluctuation in the post-exposure potential due to environmental variations may be further suppressed. In addition, a higher charge retention property upon repeated image formation may be provided. In addition, a higher retention property of the post-exposure potential even under physical stress caused by repeated image formation may be provided.

Examples of the binder resin include publicly known polymers such as acetal resins (such as polyvinyl butyral), polyvinyl alcohol resins, polyvinyl acetal resins, casein resins, diallyl phthalate resins, polyamide resins, nylon resins, nylon polyamide resins, cellulose resins, gelatin, urethane resins, melamine resins, benzoguanamine resins (such as methylated benzoguanamine resins), polyester resins, unsaturated polyester resins, methacrylic resins, acrylic resins, polyvinyl chloride resins, polyvinyl acetate resins, vinyl chloride-vinyl acetate-maleic anhydride resins, silicone resins, silicone-alkyd resins, urea resins, phenol resins (such as resol-type phenol resins), phenol-formaldehyde resins, alkyd resins, and epoxy resins; zirconium chelate compounds; titanium chelate compounds; aluminum chelate compounds; titanium alkoxide compounds; organic titanium compounds; and publicly known materials such as silane coupling agents.

Other examples of the binder resin used for the undercoat layer include electron transport resins having an electron transport group and conductive resins (such as polyaniline). Such binder resins may be used alone or in combination of two or more thereof. In the case of using two or more binder resins in combination, the mixing ratio thereof is appropriately set.

In this Specification, the binder resin is a concept encompassing resins obtained by reactions between the exemplified resins and curing agents and resins obtained by reactions of curing agents.

In this Specification, the resins obtained by reactions between urethane resins and curing agents are referred to as “cured urethane resins” for convenience.

The binder resin may be either a thermoplastic resin or a thermosetting resin, but is preferably a thermosetting resin. This is because, when the binder resin is a thermosetting resin, the film does not dissolve or swell during formation of the overlying coating film.

In particular, the binder resin used for the undercoat layer is preferably a resin that is insoluble in the coating solvent of the overlying layer, preferably a resin obtained by a reaction between a curing agent and at least one resin selected from the group consisting of a diallyl phthalate resin, a polyamide resin, a nylon resin, a urethane resin, a melamine resin, a benzoguanamine resin, and a phenol resin, and more preferably includes at least one resin selected from the group consisting of a urethane resin, a melamine resin, and a benzoguanamine resin. When the binder resin includes at least one resin selected from the group, high hole-blocking properties may be provided and a high charge retention property may be provided. As a result, both of fluctuation in the charging potential and fluctuation in the post-exposure potential due to environmental variations may be further suppressed. In addition, a higher charge retention property upon repeated image formation may be provided. In addition, a higher retention property of the post-exposure potential even under physical stress caused by repeated image formation may be provided.

In the undercoat layer, the ratio of the at least one resin selected from the group consisting of a urethane resin, a melamine resin, and a benzoguanamine resin to the total amount of the binder resin is preferably 80 mass % or more and 100 mass % or less, more preferably 90 mass % or more and 100 mass % or less, still more preferably 95 mass % or more and 100 mass % or less.

The undercoat layer may further contain inorganic particles.

The inorganic particles may be, for example, inorganic particles having a powder resistivity (volume resistivity) of 10² Ω·cm or more and 10¹¹ Ω·cm or less.

In particular, inorganic particles having such a resistivity value are preferably, for example, metal oxide particles such as tin oxide particles, titanium oxide particles, zinc oxide particles, or zirconium oxide particles, particularly preferably zinc oxide particles.

The inorganic particles may have a specific surface area of, for example, 10 m²/g or more, as measured by the BET method. When the specific surface area is 10 m²/g or more, the decrease in chargeability may tend to be suppressed.

The inorganic particles preferably have a volume-average particle diameter of, for example, 50 nm or more and 2000 nm or less (preferably 60 nm or more and 1000 nm or less).

The content of the inorganic particles is, for example, relative to the total solid content of the undercoat layer, preferably 0 mass % or more and 80 mass % or less, more preferably 0 mass % or more and 70 mass % or less.

The inorganic particles may be surface-treated. As the inorganic particles, a mixture of two or more types of particles that are surface-treated differently or two or more types of particles having different particle diameters may be used.

Examples of the surface treatment agent include silane coupling agents, titanate-based coupling agents, aluminum-based coupling agents, and surfactants. In particular, preferred are silane coupling agents and more preferred are silane coupling agents having an amino group.

Non-limiting examples of the silane coupling agents having an amino group include 3-aminopropyltriethoxysilane, N-2-(aminoethyl)-3-aminopropyltrimethoxysilane, N-2-(aminoethyl)-3-aminopropylmethyldimethoxysilane, and N,N-bis(2-hydroxyethyl)-3-aminopropyltriethoxysilane.

Two or more silane coupling agents may be mixed and used. For example, a silane coupling agent having an amino group and another silane coupling agent may be used in combination. Non-limiting examples of the other silane coupling agent include vinyltrimethoxysilane, 3-methacryloxypropyl-tris(2-methoxyethoxy) silane, 2-(3,4-epoxycyclohexyl)ethyltrimethoxysilane, 3-glycidoxypropyltrimethoxysilane, vinyltriacetoxysilane, 3-mercaptopropyltrimethoxysilane, 3-aminopropyltriethoxysilane, N-2-(aminoethyl)-3-aminopropyltrimethoxysilane, N-2-(aminoethyl)-3-aminopropylmethyldimethoxysilane, N,N-bis(2-hydroxyethyl)-3-aminopropyltriethoxysilane, and 3-chloropropyltrimethoxysilane.

The surface treatment process using the surface treatment agent may be any publicly known process and may be either a dry process or a wet process.

The amount of the surface treatment agent used may be, for example, relative to the inorganic particles, 0.5 mass % or more and 10 mass % or less.

The dry process is, for example, a process in which, a surface treatment agent itself or dissolved in an organic solvent is added dropwise or sprayed together with dry air or nitrogen gas onto inorganic particles under stirring using a high-shear mixer or the like to cause the surface treatment agent to adhere to the surfaces of the inorganic particles. The surface treatment agent may be added dropwise or sprayed at a temperature of the boiling point of the solvent or less. After the surface treatment agent is added dropwise or sprayed, baking at 100° C. or more may be performed. The baking conditions are not particularly limited as long as the temperature and the time are sufficient to provide electrophotographic characteristics.

The wet process is, for example, a process in which, while inorganic particles are dispersed in a solvent by, for example, stirring or using ultrasonic waves, a sand mill, an attritor, or a ball mill, a surface treatment agent is added and stirred or dispersed, and the solvent is subsequently removed, to cause the surface treatment agent to adhere to the surfaces of the inorganic particles. The solvent may be removed by, for example, filtration or distillation. After the solvent is removed, baking at 100° C. or more may be further performed. The baking conditions are not particularly limited as long as the temperature and the time are sufficient to provide electrophotographic characteristics. In the wet process, before addition of the surface treatment agent, moisture contained in the inorganic particles may be removed; for example, heating in a solvent under stirring may be performed to remove the moisture or azeotropic distillation with a solvent may be performed to remove the moisture.

The undercoat layer may further contain various additives in order to improve electrical characteristics, environmental stability, and image quality.

Examples of the additives include publicly known materials such as electron transport materials having a polycyclic fused-ring structure, an azo-based structure, or the like, zirconium chelate compounds, titanium chelate compounds, aluminum chelate compounds, titanium alkoxide compounds, organic titanium compounds, and silane coupling agents. As described above, a silane coupling agent may be used for surface treatment of the inorganic particles, but a silane coupling agent may be further added as an additive to the undercoat layer.

Examples of the silane coupling agent serving as an additive include vinyltrimethoxysilane, 3-methacryloxypropyl-tris(2-methoxyethoxy) silane, 2-(3,4-epoxycyclohexyl)ethyltrimethoxysilane, 3-glycidoxypropyltrimethoxysilane, vinyltriacetoxysilane, 3-mercaptopropyltrimethoxysilane, 3-aminopropyltriethoxysilane, N-2-(aminoethyl)-3-aminopropyltrimethoxysilane, N-2-(aminoethyl)-3-aminopropylmethyldimethoxysilane, N,N-bis(2-hydroxyethyl)-3-aminopropyltriethoxysilane, and 3-chloropropyltrimethoxysilane.

Examples of the zirconium chelate compounds include zirconium butoxide, zirconium ethyl acetoacetate, zirconium triethanolamine, zirconium butoxide acetylacetonate, zirconium butoxide ethyl acetoacetate, zirconium acetate, zirconium oxalate, zirconium lactate, zirconium phosphonate, zirconium octanoate, zirconium naphthenate, zirconium laurate, zirconium stearate, zirconium isostearate, methacrylate zirconium butoxide, stearate zirconium butoxide, and isostearate zirconium butoxide.

Examples of the titanium chelate compounds include tetraisopropyl titanate, tetra-n-butyl titanate, butyl titanate dimer, tetra(2-ethylhexyl) titanate, titanium acetylacetonate, polytitanium acetylacetonate, titanium octyleneglycolate, titanium lactate ammonium salt, titanium lactate, titanium lactate ethyl ester, titanium triethanolaminato, and polyhydroxy titanium stearate.

Examples of the aluminum chelate compounds include aluminum isopropylate, monobutoxyaluminum diisopropylate, aluminum butyrate, diethyl acetoacetato aluminum diisopropylate, and aluminum tris(ethyl acetoacetate).

Such additives may be used alone or as a mixture or a polycondensate of a plurality of compounds.

The undercoat layer may have a volume resistivity of 1×10¹⁰ Ω·cm or more and 1×10¹² Ω·cm or less.

The undercoat layer may have a Vickers hardness of 35 or more.

The surface roughness (ten-point average roughness) of the undercoat layer may be adjusted to be in the range of 1/(4n) (n is the refractive index of the overlying layer) to ½ of the wavelength λ of the exposure laser used, in order to suppress moiré patterns.

In order to adjust surface roughness, resin particles or the like may be added to the undercoat layer. Examples of the resin particles include silicone resin particles and crosslinked polymethyl methacrylate resin particles. In order to adjust surface roughness, the surface of the undercoat layer may be polished. Examples of the polishing method include buffing, sandblasting, wet honing, and grinding.

### Method for Forming Undercoat Layer

The method for forming the undercoat layer is not particularly limited and may be selected from well-known formation methods; for example, the above-described components are added to a solvent; the resultant undercoat layer-forming coating liquid is used to form a coating film; and the coating film is dried and optionally heated.

Examples of the solvent for preparing the undercoat layer-forming coating liquid include publicly known organic solvents such as alcohol-based solvents, aromatic hydrocarbon solvents, halogenated hydrocarbon solvents, ketone-based solvents, ketone-alcohol-based solvents, ether-based solvents, and ester-based solvents.

Specific examples of the solvent include known organic solvents such as methanol, ethanol, n-propanol, iso-propanol, n-butanol, benzyl alcohol, methyl cellosolve, ethyl cellosolve, acetone, methyl ethyl ketone, cyclohexanone, methyl acetate, ethyl acetate, n-butyl acetate, dioxane, tetrahydrofuran, methylene chloride, chloroform, chlorobenzene, and toluene.

During preparation of the undercoat layer-forming coating liquid, the inorganic particles may be dispersed by, for example, a publicly known method such as using a roll mill, a ball mill, a vibratory ball mill, an attritor, a sand mill, a colloid mill, a paint shaker, or the like.

The electron transport material (in particular, the electron transport material represented by the general formula (P)), which is less likely to dissolve in the organic solvent, may be dispersed in the organic solvent. The material may be dispersed by, for example, a publicly known method such as using a roll mill, a ball mill, a vibratory ball mill, an attritor, a sand mill, a colloid mill, a paint shaker, or the like. When the undercoat layer is formed so as to contain metal oxide particles, the metal oxide particles may also be dispersed by a dispersion method similar to the above-described method in the organic solvent.

The undercoat layer-forming coating liquid may be applied onto a conductive substrate by, for example, a known method such as a blade coating method, a wire bar coating method, a spray coating method, a dip coating method, a bead coating method, an air knife coating method, or a curtain coating method.

In the undercoat layer, the metal oxide content relative to the total solid content of the undercoat layer is preferably 5 mass % or less, more preferably 3 mass % or less, still more preferably 0 mass % (that is, with no metal oxide contained) or 2 mass % or less.

In general, metal oxides tend to have low resistance. Thus, when the undercoat layer has a metal oxide content of 5 mass % or less, a decrease in the chargeability due to a reduction in the resistance of the undercoat layer may be suppressed. As a result, both of fluctuation in the charging potential and fluctuation in the post-exposure potential due to environmental variations may be further suppressed. In addition, a higher charge retention property upon repeated image formation may be provided. In addition, a higher retention property of the post-exposure potential even under physical stress caused by repeated image formation may be provided. In addition, the metal oxide content may be reduced from the viewpoint of environmentally conscious manufacturing.

The thickness of the undercoat layer is, from the viewpoint of further suppressing both of fluctuation in the charging potential and fluctuation in the post-exposure potential due to environmental variations and from the viewpoint of providing a higher charge retention property upon repeated image formation, preferably 5 μm or more and 15 μm or less, more preferably 7 μm or more and 14 μm or less, still more preferably 8 μm or more and 13 μm or less.

The thickness of the undercoat layer may be 15 μm or more, or 20 μm or more and 50 μm or less.

In the related art, organic pigment-based electron transport materials have, in addition to electron transport properties, a certain degree of hole transport properties; in the case of using such a material for the undercoat layer of an electrophotographic photoreceptor, hole injection from the conductive substrate or hole injection to the overlying charge generation layer tends to occur during charging of the electrophotographic photoreceptor, which tends to result in a problem of a decrease in chargeability or an increase in dark decay after charging, or adverse effects on image quality due to deterioration of a charge retention property. This tendency becomes more pronounced as the undercoat layer becomes thicker. Thus, the undercoat layer has been formed so as to have a small thickness (for example, 5 μm or less) in practical use.

However, when the undercoat layer is thin and foreign matter (such as toner carriers or worn fragments of plastic components), in particular, needle-like foreign matter such as carbon fibers adheres to the surface of the photoreceptor during image formation, the contact pressure with the intermediate transfer body causes the foreign matter to penetrate through the surface of the photoreceptor, which cause leakage current in some cases. By contrast, in the present disclosure, the undercoat layer contains the electron transport material represented by the general formula (P) that may have high electron transport properties, low hole transport properties, and a high charge retention property, so that the undercoat layer may be formed so as to have a larger thickness (for example, 5 μm or more) than the related-art undercoat layers using organic pigments as main components. Thus, even when foreign matter penetrates the surface of the electrophotographic photoreceptor and reaches the undercoat layer, leakage current may be less likely to be caused and a high charge retention property upon repeated image formation may be inferentially provided.

When the undercoat layer has a thickness of at least 15 μm or less, sufficiently high electron transport properties may be exhibited within the time of the electrophotographic photoreceptor process and the bulk resistance of the undercoat layer may also be maintained at a high level, so that resistance to leakage caused by foreign matter and retention of a charge retention property upon repeated image formation may be provided. In addition, a higher retention property of the post-exposure potential even under physical stress caused by repeated image formation may be provided.

### Photosensitive Layer

The photosensitive layer contains at least one resin of a polyarylate resin (hereafter also referred to as “polyarylate resin (PA)”) containing a dicarboxylic unit represented by the following formula (A) and a diol unit represented by the following formula (B), and a polycarbonate resin (hereafter also referred to as “polycarbonate resin (PC)”) containing a biphenyl-containing constitutional unit represented by the following formula (BP) in an amount of more than 15 mol % relative to all constitutional units.

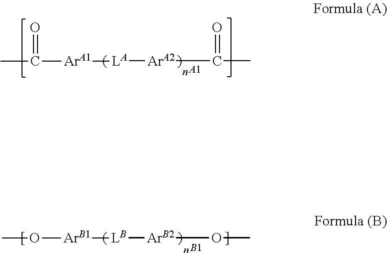

In the formula (A), Ar^{A1} and Ar^{A2} are each independently an aromatic ring that may have a substituent, L^{A} is a single bond or a divalent linking group, and n^{A1} is 0, 1, or 2.

In the formula (B), Ar^{B1} and Ar^{B2} are each independently an aromatic ring that may have a substituent, L^{B} is a single bond, an oxygen atom, a sulfur atom, or —C(Rb¹)(Rb²)—, n^{B1} is 0, 1, or 2. Rb¹ and Rb² are each independently a hydrogen atom, an alkyl group having 1 or more and 20 or less carbon atoms, an aryl group having 6 or more and 12 or less carbon atoms, or an aralkyl group having 7 or more and 20 or less carbon atoms, and Rb¹ and Rb² may be bonded together to form a cyclic alkyl group.

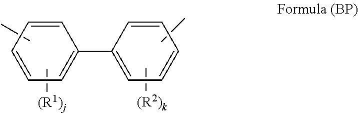

In the formula (BP), j is an integer of 0 or more and 4 or less, j R¹'s are each independently a methyl group or an ethyl group, k is an integer of 0 or more and 4 or less, and k R²'s are each independently a methyl group or an ethyl group.

When the photosensitive layer of the photoreceptor according to the present disclosure is, as in the photoreceptor 10A in FIG. 1, a multilayer photosensitive layer including a charge generation layer and a charge transport layer, at least the charge transport layer contains at least one resin of the polyarylate resin (PA) and the polycarbonate resin (PC). The charge generation layer may or may not contain the polyarylate resin (PA) or the polycarbonate resin (PC).

The photosensitive layer contains at least one resin of the polyarylate resin (PA) and the polycarbonate resin (PC), and may contain both of the polyarylate resin (PA) and the polycarbonate resin (PC).

The photosensitive layer may further contain, in addition to the polyarylate resin (PA), a polycarbonate resin other than the polycarbonate resin (PC).

The photosensitive layer may further contain, in addition to the polycarbonate resin (PC), a polyarylate resin other than the polyarylate resin (PA).

The photosensitive layer may further contain another resin other than the polyarylate resin (PA), the polycarbonate resin (PC), and the polyarylate resin other than the polyarylate resin (PA), and another resin other than the polycarbonate resin other than the polycarbonate resin (PC).

### Polyarylate Resin (PA)

The polyarylate resin (PA), in which stacking of aromatic rings causes resin molecules to be associated via intermolecular forces, may improve abrasion resistance of the charge transport layer. Such polyarylate resins (PA) may be used alone or in combination of two or more thereof.

The polyarylate resin (PA) includes a dicarboxylic unit represented by the following formula (A) and a diol unit represented by the following formula (B).

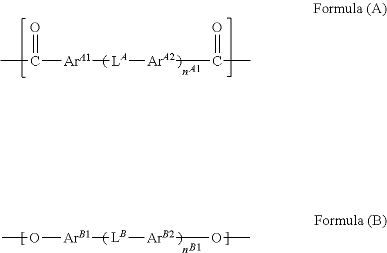

In the formula (A), Ar^{A1} and Ar^{A2} are each independently an aromatic ring that may have a substituent, L^{A} is a single bond or a divalent linking group, and n^{A1} is 0, 1, or 2.

In the formula (B), Ar^{B1} and Ar^{B2} are each independently an aromatic ring that may have a substituent, L^{B} is a single bond, an oxygen atom, a sulfur atom, or —C(Rb¹)(Rb²)—, and n^{B1} is 0, 1, or 2. Rb¹ and Rb² are each independently a hydrogen atom, an alkyl group having 1 or more and 20 or less carbon atoms, an aryl group having 6 or more and 12 or less carbon atoms, or an aralkyl group having 7 or more and 20 or less carbon atoms, and Rb¹ and Rb² may be bonded together to form a cyclic alkyl group.

The dicarboxylic unit (A) is a constitutional unit represented by the following formula (A).

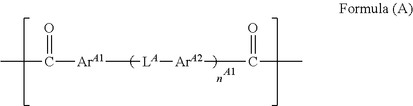

In the formula (A), Ar^{A1} and Ar^{A2} are each independently an aromatic ring that may have a substituent, L^{A} is a single bond or a divalent linking group, and n^{A1} is 0, 1, or 2.

For Ar^{A1}, the aromatic ring may be either monocyclic or polycyclic. The aromatic ring may be, for example, a benzene ring, a naphthalene ring, an anthracene ring, or a phenanthrene ring, and preferred are a benzene ring and a naphthalene ring.

For Ar^{A1}, a hydrogen atom on the aromatic ring may be substituted with an alkyl group, an aryl group, an aralkyl group, an alkoxy group, an aryloxy group, a halogen atom, or the like. In such a case where the aromatic ring of Ar^{A1} is substituted, the substituent is preferably an alkyl group having 1 or more and 10 or less carbon atoms, an aryl group having 6 or more and 12 or less carbon atoms, or an alkoxy group having 1 or more and 6 or less carbon atoms.

For Ar^{A2}, the aromatic ring may be either monocyclic or polycyclic. The aromatic ring may be, for example, a benzene ring, a naphthalene ring, an anthracene ring, or a phenanthrene ring, and preferred are a benzene ring and a naphthalene ring.

For Ar^{A2}, a hydrogen atom on the aromatic ring may be substituted with an alkyl group, an aryl group, an aralkyl group, an alkoxy group, an aryloxy group, a halogen atom, or the like. In such a case where the aromatic ring of Ar^{A2} is substituted, the substituent is preferably an alkyl group having 1 or more and 10 or less carbon atoms, an aryl group having 6 or more and 12 or less carbon atoms, or an alkoxy group having 1 or more and 6 or less carbon atoms.

When L^{A} is a divalent linking group, the divalent linking group may be, for example, an oxygen atom, a sulfur atom, or —C(Ra¹) (Ra²)—. Ra¹ and Ra² are each independently a hydrogen atom, an alkyl group having 1 or more and 10 or less carbon atoms, an aryl group having 6 or more and 12 or less carbon atoms, or an aralkyl group having 7 or more and 20 or less carbon atoms, and Ra¹ and Ra² may be bonded together to form a cyclic alkyl group.

For Ra¹ and Ra², the alkyl group having 1 or more and 10 or less carbon atoms may be linear, branched, or cyclic. The alkyl group preferably has 1 or more and 6 or less carbon atoms, more preferably 1 or more and 4 or less carbon atoms, still more preferably 1 or 2 carbon atoms.

For Ra¹ and Ra², the aryl group having 6 or more and 12 or less carbon atoms may be either monocyclic or polycyclic. The aryl group preferably has 6 or more and 10 or less carbon atoms, more preferably 6 carbon atoms.

For Ra¹ and Ra², in the aralkyl group having 7 or more and 20 or less carbon atoms, the alkyl group may be linear, branched, or cyclic. In the aralkyl group having 7 or more and 20 or less carbon atoms, the alkyl group preferably has 1 or more and 4 or less carbon atoms, more preferably 1 or more and 3 or less carbon atoms, still more preferably 1 or 2 carbon atoms.

For Ra¹ and Ra², in the aralkyl group having 7 or more and 20 or less carbon atoms, the aryl group may be either monocyclic or polycyclic. The aryl group preferably has 6 or more and 10 or less carbon atoms, more preferably 6 carbon atoms.

The dicarboxylic unit (A), from the viewpoint of further suppressing both of fluctuation in the charging potential and fluctuation in the post-exposure potential due to environmental variations, preferably contains at least one selected from the group consisting of a dicarboxylic unit (A1) represented by the following formula (A1), a dicarboxylic unit (A2) represented by the following formula (A2), a dicarboxylic unit (A3) represented by the following formula (A3), a dicarboxylic unit (A4) represented by the following formula (A4), and a dicarboxylic unit (A5) represented by the following formula (A5). The dicarboxylic unit (A) more preferably contains at least one selected from the group consisting of the dicarboxylic unit (A2), the dicarboxylic unit (A3), and the dicarboxylic unit (A4), and still more preferably contains the dicarboxylic unit (A2).

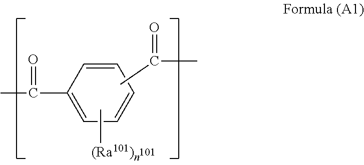

In the formula (A1), n¹⁰¹ is an integer of 0 or more and 4 or less, and n¹⁰¹ Ra¹⁰¹'s are each independently an alkyl group having 1 or more and 10 or less carbon atoms, an aryl group having 6 or more and 12 or less carbon atoms, or an alkoxy group having 1 or more and 6 or less carbon atoms.

n¹⁰¹ is preferably 0, 1, or 2, more preferably 0 or 1, and still more preferably 0.

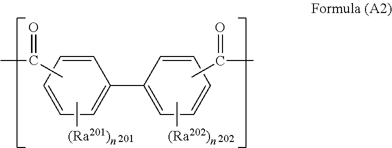

In the formula (A2), n²⁰¹ and n²⁰² are each independently an integer of 0 or more and 4 or less, n²⁰¹ Ra²⁰¹'s and n²⁰² Ra²⁰²'s are each independently an alkyl group having 1 or more and 10 or less carbon atoms, an aryl group having 6 or more and 12 or less carbon atoms, or an alkoxy group having 1 or more and 6 or less carbon atoms.

n²⁰¹ is preferably 0, 1, or 2, more preferably 0 or 1, and still more preferably 0.

n²⁰² is preferably 0, 1, or 2, more preferably 0 or 1, and still more preferably 0.

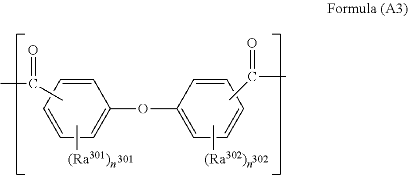

In the formula (A3), n³⁰¹ and n³⁰² are each independently an integer of 0 or more and 4 or less, n³⁰¹ Ra³⁰¹'s and n³⁰² Ra³⁰²'s are each independently an alkyl group having 1 or more and 10 or less carbon atoms, an aryl group having 6 or more and 12 or less carbon atoms, or an alkoxy group having 1 or more and 6 or less carbon atoms.

n³⁰¹ is preferably 0, 1, or 2, more preferably 0 or 1, and still more preferably 0.

n³⁰² is preferably 0, 1, or 2, more preferably 0 or 1, and still more preferably 0.

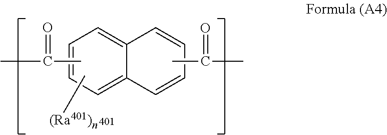

In the formula (A4), n⁴⁰¹ is an integer of 0 or more and 6 or less, and n⁴⁰¹ Ra⁴⁰¹'s are each independently an alkyl group having 1 or more and 10 or less carbon atoms, an aryl group having 6 or more and 12 or less carbon atoms, or an alkoxy group having 1 or more and 6 or less carbon atoms.

n⁴⁰¹ is preferably an integer of 0 or more and 4 or less, more preferably 0, 1, or 2, and still more preferably 0.

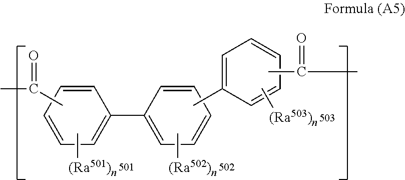

In the formula (A5), n⁵⁰¹, n⁵⁰², and n⁵⁰³ are each independently an integer of 0 or more and 4 or less, n⁵⁰¹ Ra⁵⁰¹'s, n⁵⁰² Ra⁵⁰²'s, and n⁵⁰³ Ra⁵⁰³'s are each independently an alkyl group having 1 or more and 10 or less carbon atoms, an aryl group having 6 or more and 12 or less carbon atoms, or an alkoxy group having 1 or more and 6 or less carbon atoms.

n⁵⁰¹ is preferably 0, 1, or 2, more preferably 0 or 1, and still more preferably 0.

n⁵⁰² is preferably 0, 1, or 2, more preferably 0 or 1, and still more preferably 0.

n⁵⁰³ is preferably 0, 1, or 2, more preferably 0 or 1, and still more preferably 0.

Ra¹⁰¹ in the formula (A1), Ra²⁰¹ and Ra²⁰² in the formula (A2), Ra³⁰¹ and Ra³⁰² in the formula (A3), Ra⁴⁰¹ in the formula (A4), and Ra⁵⁰¹, Ra⁵⁰², and Ra⁵⁰³ in the formula (A5) are similar in terms of specific forms and exemplary forms and hence Ra¹⁰¹, Ra²⁰¹, Ra²⁰², Ra³⁰¹ Ra³⁰², Ra⁴⁰¹, Ra⁵⁰¹, Ra⁵⁰², and Ra⁵⁰³ will be collectively described as “Ra”.

For Ra, the alkyl group having 1 or more and 10 or less carbon atoms may be linear, branched, or cyclic. The alkyl group preferably has 1 or more and 6 or less carbon atoms, more preferably 1 or more and 4 or less carbon atoms, still more preferably 1 or 2 carbon atoms.

Examples of the linear alkyl group having 1 or more and 10 or less carbon atoms include a methyl group, an ethyl group, an n-propyl group, an n-butyl group, an n-pentyl group, an n-hexyl group, an n-heptyl group, an n-octyl group, an n-nonyl group, and an n-decyl group.

Examples of the branched alkyl group having 3 or more and 10 or less carbon atoms include an isopropyl group, an isobutyl group, a sec-butyl group, a tert-butyl group, an isopentyl group, a neopentyl group, a tert-pentyl group, an isohexyl group, a sec-hexyl group, a tert-hexyl group, an isoheptyl group, a sec-heptyl group, a tert-heptyl group, an isooctyl group, a sec-octyl group, a tert-octyl group, an isononyl group, a sec-nonyl group, a tert-nonyl group, an isodecyl group, a sec-decyl group, and a tert-decyl group.

Examples of the cyclic alkyl group having 3 or more and 10 or less carbon atoms include a cyclopropyl group, a cyclobutyl group, a cyclopentyl group, a cyclohexyl group, a cycloheptyl group, a cyclooctyl group, a cyclononyl group, a cyclodecyl group, and polycyclic (for example, bicyclo, tricyclo, or spiro ring) alkyl groups in which the foregoing monocyclic alkyl groups are linked together.

For Ra, the aryl group having 6 or more and 12 or less carbon atoms may be either monocyclic or polycyclic. The aryl group preferably has 6 or more and 10 or less carbon atoms, more preferably 6 carbon atoms.

Examples of the aryl group having 6 or more and 12 or less carbon atoms include a phenyl group, a biphenyl group, a 1-naphthyl group, and a 2-naphthyl group.

For Ra, in the alkoxy group having 1 or more and 6 or less carbon atoms, the alkyl group may be linear, branched, or cyclic. In the alkoxy group having 1 or more and 6 or less carbon atoms, the alkyl group preferably has 1 or more and 4 or less carbon atoms, more preferably 1 or more and 3 or less carbon atoms, and still more preferably 1 or 2 carbon atoms.

Examples of the linear alkoxy group having 1 or more and 6 or less carbon atoms include a methoxy group, an ethoxy group, an n-propoxy group, an n-butoxy group, an n-pentyloxy group, and an n-hexyloxy group.

Examples of the branched alkoxy group having 3 or more and 6 or less carbon atoms include an isopropoxy group, an isobutoxy group, a sec-butoxy group, a tert-butoxy group, an isopentyloxy group, a neopentyloxy group, a tert-pentyloxy group, an isohexyloxy group, a sec-hexyloxy group, and a tert-hexyloxy group.

Examples of the cyclic alkoxy group having 3 or more and 6 or less carbon atoms include a cyclopropoxy group, a cyclobutoxy group, a cyclopentyloxy group, and a cyclohexyloxy group.

The following are specific examples of the dicarboxylic unit (A1) that are dicarboxylic units (A1-1) to (A1-9). However, the dicarboxylic unit (A1) is not limited to these.

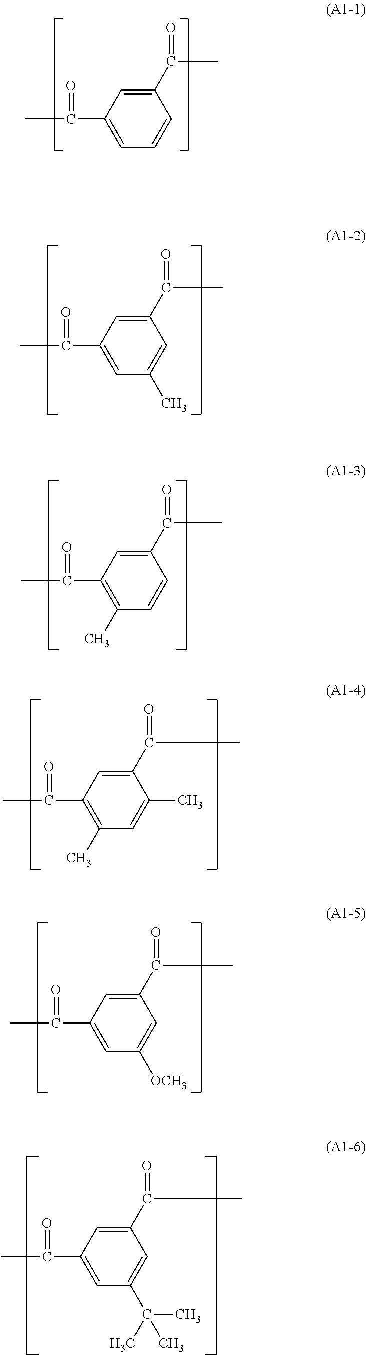

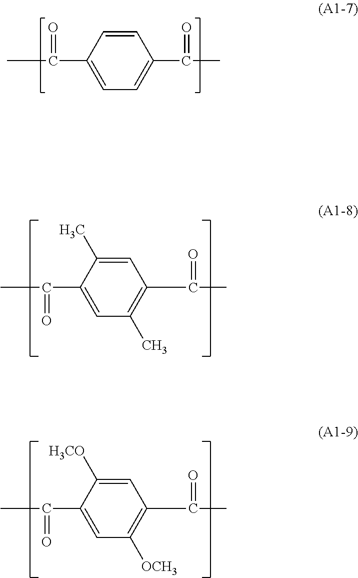

The following are specific examples of the dicarboxylic unit (A2) that are dicarboxylic units (A2-1) to (A2-3). However, the dicarboxylic unit (A2) is not limited to these.

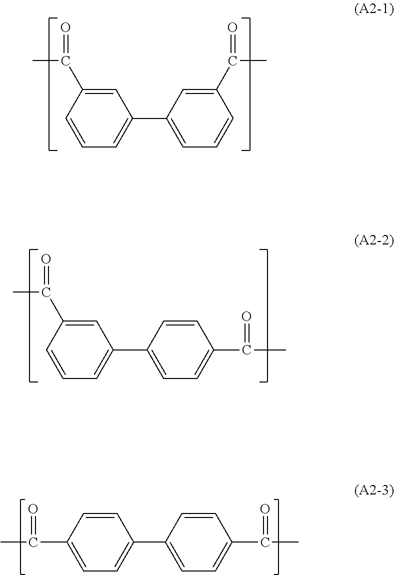

The following are specific examples of the dicarboxylic unit (A3) that are dicarboxylic units (A3-1) and (A3-2). However, the dicarboxylic unit (A3) is not limited to these.

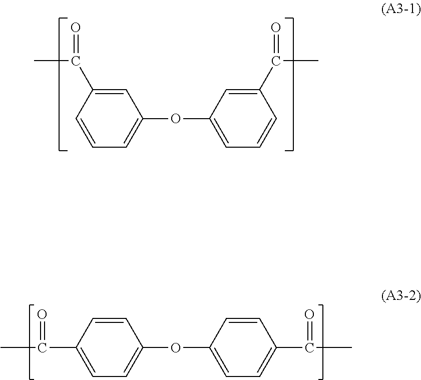

The following are specific examples of the dicarboxylic unit (A4) that are dicarboxylic units (A4-1) to (A4-3). However, the dicarboxylic unit (A4) is not limited to these.

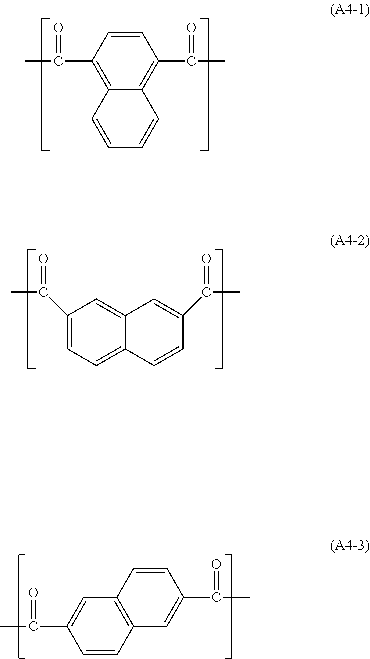

The following are specific examples of the dicarboxylic unit (A5) that are dicarboxylic units (A5-1) to (A5-4). However, the dicarboxylic unit (A5) is not limited to these.

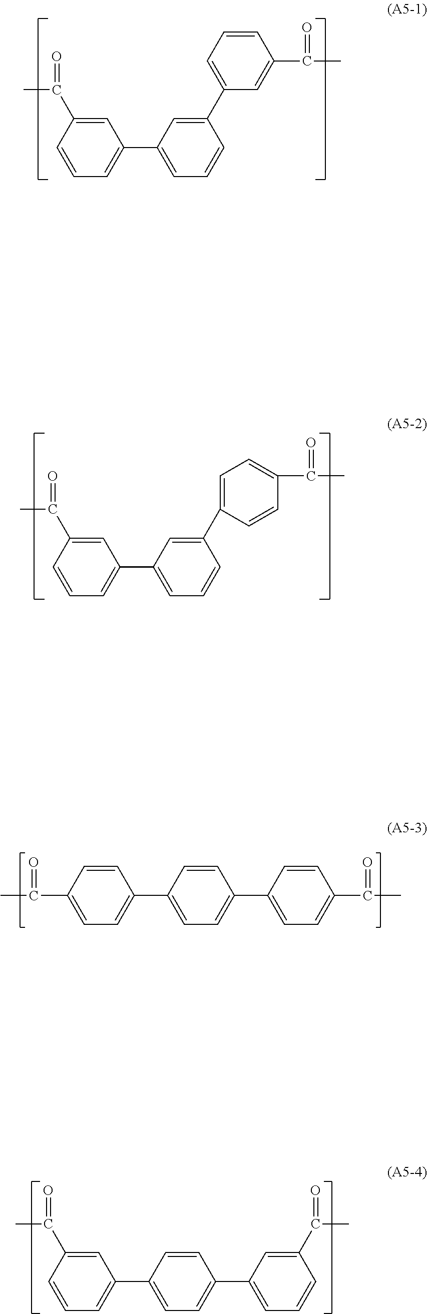

The dicarboxylic unit (A) contained is preferably at least one selected from the group consisting of the above-described specific examples (A1-1), (A1-7), (A2-3), (A3-2), and (A4-3), more preferably at least one selected from the group consisting of (A2-3), (A3-2), and (A4-3), still more preferably at least (A2-3).

The polyarylate resin (PA) may contain one type or two or more types of such dicarboxylic units (A).

The mass ratio of the dicarboxylic unit (A) to the polyarylate resin (PA) is preferably 15 mass % or more and 60 mass % or less.

When the mass ratio of the dicarboxylic unit (A) is 15 mass % or more, the charge transport layer may have high abrasion resistance. From this viewpoint, the mass ratio of the dicarboxylic unit (A) is more preferably 20 mass % or more, still more preferably 25 mass % or more.

When the mass ratio of the dicarboxylic unit (A) is 60 mass % or less, separation of the charge transport layer may be suppressed. From this viewpoint, the mass ratio of the dicarboxylic unit (A) is more preferably 55 mass % or less, still more preferably 50 mass % or less.

The polyarylate resin (PA) may contain another dicarboxylic unit other than the dicarboxylic unit (A). Examples of the other dicarboxylic unit include aliphatic dicarboxylic acid (such as oxalic acid, malonic acid, maleic acid, fumaric acid, citraconic acid, itaconic acid, glutaconic acid, succinic acid, alkenylsuccinic acids, adipic acid, and sebacic acid) units, alicyclic dicarboxylic acid (such as cyclohexane dicarboxylic acid) units, and lower (such as having 1 or more and 5 or less carbon atoms) alkyl ester units of the foregoing. Such dicarboxylic units contained in the polyarylate resin (PA) may be used alone or in combination of two or more thereof.

The diol unit (B) is a constitutional unit represented by the following formula (B).

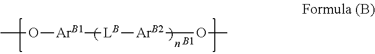

In the formula (B), Ar^{B1} and Ar^{B2} are each independently an aromatic ring that may have a substituent, L^{B} is a single bond, an oxygen atom, a sulfur atom, or —C(Rb¹)(Rb²)—, and n^{B1} is 0, 1, or 2. Rb¹ and Rb² are each independently a hydrogen atom, an alkyl group having 1 or more and 20 or less carbon atoms, an aryl group having 6 or more and 12 or less carbon atoms, or an aralkyl group having 7 or more and 20 or less carbon atoms, and Rb¹ and Rb² may be bonded together to form a cyclic alkyl group.

For Ar^{B1}, the aromatic ring may be either monocyclic or polycyclic. The aromatic ring may be, for example, a benzene ring, a naphthalene ring, an anthracene ring, or a phenanthrene ring, and preferred are a benzene ring and a naphthalene ring.

For Ar^{B1}, a hydrogen atom on the aromatic ring may be substituted with an alkyl group, an aryl group, an aralkyl group, an alkoxy group, an aryloxy group, a halogen atom, or the like. In such a case where the aromatic ring of Ar^{B1} is substituted, the substituent is preferably an alkyl group having 1 or more and 10 or less carbon atoms, an aryl group having 6 or more and 12 or less carbon atoms, or an alkoxy group having 1 or more and 6 or less carbon atoms.

For Ar^{B2}, the aromatic ring may be either monocyclic or polycyclic. The aromatic ring may be, for example, a benzene ring, a naphthalene ring, an anthracene ring, or a phenanthrene ring, and preferred are a benzene ring and a naphthalene ring.

For Ar^{B2}, a hydrogen atom on the aromatic ring may be substituted with an alkyl group, an aryl group, an aralkyl group, an alkoxy group, an aryloxy group, a halogen atom, or the like. In such a case where the aromatic ring of Ar^{B2} is substituted, the substituent is preferably an alkyl group having 1 or more and 10 or less carbon atoms, an aryl group having 6 or more and 12 or less carbon atoms, or an alkoxy group having 1 or more and 6 or less carbon atoms.

For Rb¹ and Rb², the alkyl group having 1 or more and 20 or less carbon atoms may be linear, branched, or cyclic. The alkyl group preferably has 1 or more and 18 or less carbon atoms, more preferably 1 or more and 14 or less carbon atoms, still more preferably 1 or more and 10 or less carbon atoms.

For Rb¹ and Rb², the aryl group having 6 or more and 12 or less carbon atoms may be either monocyclic or polycyclic. The aryl group preferably has 6 or more and 10 or less carbon atoms, more preferably 6 carbon atoms.

For Rb¹ and Rb², in the aralkyl group having 7 or more and 20 or less carbon atoms, the alkyl group may be linear, branched, or cyclic. In the aralkyl group having 7 or more and 20 or less carbon atoms, the alkyl group preferably has 1 or more and 4 or less carbon atoms, more preferably 1 or more and 3 or less carbon atoms, still more preferably 1 or 2 carbon atoms.

For Rb¹ and Rb², in the aralkyl group having 7 or more and 20 or less carbon atoms, the aryl group may be either monocyclic or polycyclic. The aryl group preferably has 6 or more and 10 or less carbon atoms, more preferably 6 carbon atoms.

The diol unit (B), from the viewpoint of further suppressing both of fluctuation in the charging potential and fluctuation in the post-exposure potential due to environmental variations, preferably contains at least one selected from the group consisting of a diol unit (B1) represented by a formula (B1) below, a diol unit (B2) represented by a formula (B2) below, a diol unit (B3) represented by a formula (B3) below, a diol unit (B4) represented by a formula (B4) below, a diol unit (B5) represented by a formula (B5) below, a diol unit (B6) represented by a formula (B6) below, a diol unit (B7) represented by a formula (B7) below, and a diol unit (B8) represented by a formula (B8) below.

The diol unit (B) contained is more preferably at least one selected from the group consisting of the diol unit (B1) represented by the formula (B1) below, the diol unit (B2) represented by the formula (B2) below, the diol unit (B4) represented by the formula (B4) below, the diol unit (B5) represented by the formula (B5) below, and the diol unit (B6) represented by the formula (B6) below, still more preferably at least one selected from the group consisting of the diol unit (B1) represented by the formula (B1) below, the diol unit (B2) represented by the formula (B2) below, the diol unit (B5) represented by the formula (B5) below, and the diol unit (B6) represented by the formula (B6) below, yet more preferably at least one selected from the group consisting of the diol unit (B1) represented by the formula (B1) below, the diol unit (B2) represented by the formula (B2) below, and the diol unit (B6) represented by the formula (B6) below, and most preferably at least one selected from the group consisting of the diol unit (B1) represented by the formula (B1) below and the diol unit (B2) represented by the formula (B2) below.

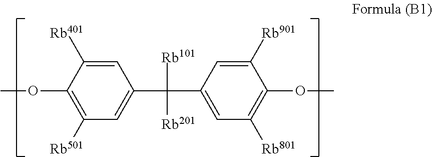

In the formula (B1), Rb¹⁰¹ is a branched alkyl group having 4 or more and 20 or less carbon atoms, Rb²⁰¹ is a hydrogen atom or an alkyl group having 1 or more and 3 or less carbon atoms, and Rb⁴⁰¹, Rb⁵⁰¹, Rb⁸⁰¹, and Rb⁹⁰¹ are each independently a hydrogen atom, an alkyl group having 1 or more and 4 or less carbon atoms, an alkoxy group having 1 or more and 6 or less carbon atoms, or a halogen atom.

For Rb¹⁰¹, the branched alkyl group having 4 or more and 20 or less carbon atoms preferably has 4 or more and 16 or less carbon atoms, more preferably 4 or more and 12 or less carbon atoms, still more preferably 4 or more and 8 or less carbon atoms. Specific examples of Rb¹⁰¹ include an isobutyl group, a sec-butyl group, a tert-butyl group, an isopentyl group, a neopentyl group, a tert-pentyl group, an isohexyl group, a sec-hexyl group, a tert-hexyl group, an isoheptyl group, a sec-heptyl group, a tert-heptyl group, an isooctyl group, a sec-octyl group, a tert-octyl group, an isononyl group, a sec-nonyl group, a tert-nonyl group, an isodecyl group, a sec-decyl group, a tert-decyl group, an isododecyl group, a sec-dodecyl group, a tert-dodecyl group, a tert-tetradecyl group, and a tert-pentadecyl group.

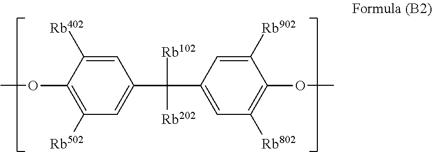

In the formula (B2), Rb¹⁰² is a linear alkyl group having 4 or more and 20 or less carbon atoms, Rb²⁰² is a hydrogen atom or an alkyl group having 1 or more and 3 or less carbon atoms, and Rb⁴⁰², Rb⁵⁰², Rb⁸⁰², and Rb⁹⁰² are each independently a hydrogen atom, an alkyl group having 1 or more and 4 or less carbon atoms, an alkoxy group having 1 or more and 6 or less carbon atoms, or a halogen atom.

For Rb¹⁰², the linear alkyl group having 4 or more and 20 or less carbon atoms preferably has 4 or more and 16 or less carbon atoms, more preferably 4 or more and 12 or less carbon atoms, still more preferably 4 or more and 8 or less carbon atoms. Specific examples of Rb¹⁰² include an n-butyl group, an n-pentyl group, an n-hexyl group, an n-heptyl group, an n-octyl group, an n-nonyl group, an n-decyl group, an n-undecyl group, an n-dodecyl group, a tridecyl group, an n-tetradecyl group, an n-pentadecyl group, an n-heptadecyl group, an n-octadecyl group, an n-nonadecyl group, and an n-icosyl group.

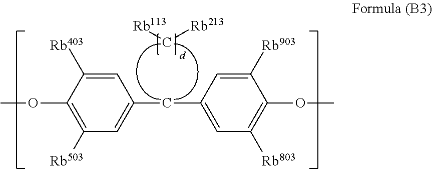

In the formula (B3), Rb¹¹³ and Rb²¹³ are each independently a hydrogen atom, a linear alkyl group having 1 or more and 3 or less carbon atoms, an alkoxy group having 1 or more and 4 or less carbon atoms, or a halogen atom, d is an integer of 7 or more and 15 or less, and Rb⁴⁰³, Rb⁵⁰³, Rb⁸⁰³, and Rb⁹⁰³ are each independently a hydrogen atom, an alkyl group having 1 or more and 4 or less carbon atoms, an alkoxy group having 1 or more and 6 or less carbon atoms, or a halogen atom.

For Rb¹¹³ and Rb²¹³, the linear alkyl group having 1 or more and 3 or less carbon atoms preferably has 1 or 2 carbon atoms, more preferably 1 carbon atom. Specific examples of the group include a methyl group, an ethyl group, and an n-propyl group.

For Rb¹¹³ and Rb²¹³, in the alkoxy group having 1 or more and 4 or less carbon atoms, the alkyl group may be linear, branched, or cyclic. In the alkoxy group having 1 or more and 4 or less carbon atoms, the alkyl group preferably has 1 or more and 3 or less carbon atoms, more preferably 1 or 2 carbon atoms, still more preferably 1 carbon atom. Specific examples of the group include a methoxy group, an ethoxy group, an n-propoxy group, an n-butoxy group, an isopropoxy group, an isobutoxy group, a sec-butoxy group, a tert-butoxy group, a cyclopropoxy group, and a cyclobutoxy group.

For Rb¹¹³ and Rb²¹³, the halogen atom may be a fluorine atom, a chlorine atom, a bromine atom, or an iodine atom.

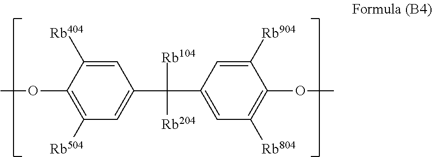

In the formula (B4), Rb¹⁰⁴ and Rb²⁰⁴ are each independently a hydrogen atom or an alkyl group having 1 or more and 3 or less carbon atoms, and Rb⁴⁰⁴, Rb⁵⁰⁴, Rb⁸⁰⁴, and Rb⁹⁰⁴ are each independently a hydrogen atom, an alkyl group having 1 or more and 4 or less carbon atoms, an alkoxy group having 1 or more and 6 or less carbon atoms, or a halogen atom.

For Rb¹⁰⁴, the alkyl group having 1 or more and 3 or less carbon atoms may be linear, branched, or cyclic. The alkyl group preferably has 1 or 2 carbon atoms, more preferably 1 carbon atom. Specific examples of Rb¹⁰⁴ include a methyl group, an ethyl group, an n-propyl group, an isopropyl group, and a cyclopropyl group.

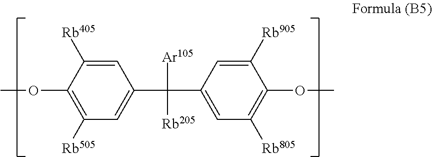

In the formula (B5), Ar¹⁰⁵ is an aryl group having 6 or more and 12 or less carbon atoms or an aralkyl group having 7 or more and 20 or less carbon atoms, Rb²⁰⁵ is a hydrogen atom or an alkyl group having 1 or more and 3 or less carbon atoms, and Rb⁴⁰⁵, Rb⁵⁰⁵, Rb⁸⁰⁵, and Rb⁹⁰⁵ are each independently a hydrogen atom, an alkyl group having 1 or more and 4 or less carbon atoms, an alkoxy group having 1 or more and 6 or less carbon atoms, or a halogen atom.

For Ar¹⁰⁵, the aryl group having 6 or more and 12 or less carbon atoms may be either monocyclic or polycyclic. The aryl group preferably has 6 or more and 10 or less carbon atoms, more preferably 6 carbon atoms.

For Ar¹⁰⁵, in the aralkyl group having 7 or more and 20 or less carbon atoms, the alkyl group may be linear, branched, or cyclic. In the aralkyl group having 7 or more and 20 or less carbon atoms, the alkyl group preferably has 1 or more and 4 or less carbon atoms, more preferably 1 or more and 3 or less carbon atoms, still more preferably 1 or 2 carbon atoms. For Ar¹⁰⁵, in the aralkyl group having 7 or more and 20 or less carbon atoms, the aryl group may be either monocyclic or polycyclic. The aryl group preferably has 6 or more and 10 or less carbon atoms, more preferably 6 carbon atoms. Examples of the aralkyl group having 7 or more and 20 or less carbon atoms include a benzyl group, a phenylethyl group, a phenylpropyl group, a 4-phenylbutyl group, a phenylpentyl group, a phenylhexyl group, a phenylheptyl group, a phenyloctyl group, a phenylnonyl group, a naphthylmethyl group, a naphthylethyl group, an anthracenylmethyl group, and a phenyl-cyclopentylmethyl group.

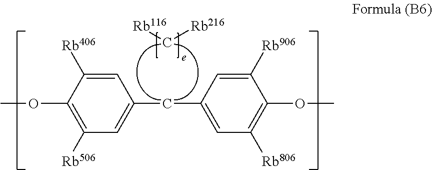

In the formula (B6), Rb¹¹⁶ and Rb²¹⁶ are each independently a hydrogen atom, a linear alkyl group having 1 or more and 3 or less carbon atoms, an alkoxy group having 1 or more and 4 or less carbon atoms, or a halogen atom, e is an integer of 4 or more and 6 or less, and Rb⁴⁰⁶, Rb⁵⁰⁶, Rb⁸⁰⁶, and Rb⁹⁰⁶ are each independently a hydrogen atom, an alkyl group having 1 or more and 4 or less carbon atoms, an alkoxy group having 1 or more and 6 or less carbon atoms, or a halogen atom.

For Rb¹¹⁶ and Rb²¹⁶, the linear alkyl group having 1 or more and 3 or less carbon atoms preferably has 1 or 2 carbon atoms, more preferably 1 carbon atom. Specific examples of the group include a methyl group, an ethyl group, and an n-propyl group.

For Rb¹¹⁶ and Rb²¹⁶, in the alkoxy group having 1 or more and 4 or less carbon atoms, the alkyl group may be linear, branched, or cyclic. In the alkoxy group having 1 or more and 4 or less carbon atoms, the alkyl group preferably has 1 or more and 3 or less carbon atoms, more preferably 1 or 2 carbon atoms, still more preferably 1 carbon atom. Specific examples of the group include a methoxy group, an ethoxy group, an n-propoxy group, an n-butoxy group, an isopropoxy group, an isobutoxy group, a sec-butoxy group, a tert-butoxy group, a cyclopropoxy group, and a cyclobutoxy group.

For Rb¹¹⁶ and Rb²¹⁶, the halogen atom may be a fluorine atom, a chlorine atom, a bromine atom, or an iodine atom.

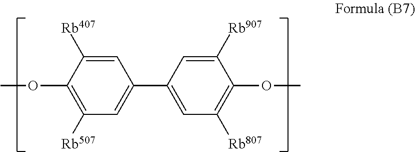

In the formula (B7), Rb⁴⁰⁷, Rb⁵⁰⁷, Rb⁸⁰⁷, and Rb⁹⁰⁷ are each independently a hydrogen atom, an alkyl group having 1 or more and 4 or less carbon atoms, an alkoxy group having 1 or more and 6 or less carbon atoms, or a halogen atom.

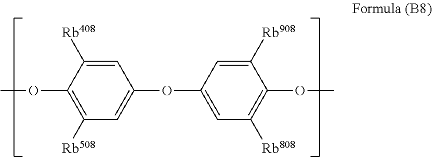

In the formula (B8), Rb⁴⁰⁸, Rb⁵⁰⁸, Rb⁸⁰⁸, and Rb⁹⁰⁸ are each independently a hydrogen atom, an alkyl group having 1 or more and 4 or less carbon atoms, an alkoxy group having 1 or more and 6 or less carbon atoms, or a halogen atom.

Rb²⁰¹ in the formula (B1), Rb²⁰² in the formula (B2), Rb²⁰⁴ in the formula (B4), and Rb²⁰⁵ in the formula (B5) are similar in terms of specific forms and exemplary forms and hence Rb²⁰¹, Rb²⁰², Rb²⁰⁴, and Rb²⁰⁵ will be collectively described as “Rb²⁰⁰”.

For Rb²⁰⁰, the alkyl group having 1 or more and 3 or less carbon atoms may be linear, branched, or cyclic. The alkyl group preferably has 1 or 2 carbon atoms, more preferably 1 carbon atom.

Examples of the alkyl group having 1 or more and 3 or less carbon atoms include a methyl group, an ethyl group, an n-propyl group, an isopropyl group, and a cyclopropyl group.

Rb⁴⁰¹ in the formula (B1), Rb⁴⁰² in the formula (B2), Rb⁴⁰³ in the formula (B3), Rb⁴⁰⁴ in the formula (B4), Rb⁴⁰⁵ in the formula (B5), Rb⁴⁰⁶ in the formula (B6), Rb⁴⁰⁷ in the formula (B7), and Rb⁴⁰⁸ in the formula (B8) are similar in terms of specific forms and exemplary forms and hence Rb⁴⁰¹, Rb⁴⁰², Rb⁴⁰³, Rb⁴⁰⁴, Rb⁴⁰⁵, Rb⁴⁰⁶, Rb⁴⁰⁷, and Rb⁴⁰⁸ will be collectively described as “Rb⁴⁰⁰”.

For Rb⁴⁰⁰, the alkyl group having 1 or more and 4 or less carbon atoms may be linear, branched, or cyclic. The alkyl group preferably has 1 or more and 3 or less carbon atoms, more preferably 1 or 2 carbon atoms, still more preferably 1 carbon atom.

Examples of the linear alkyl group having 1 or more and 4 or less carbon atoms include a methyl group, an ethyl group, an n-propyl group, and an n-butyl group.

Examples of the branched alkyl group having 3 or 4 carbon atoms include an isopropyl group, an isobutyl group, a sec-butyl group, and a tert-butyl group.

Examples of the cyclic alkyl group having 3 or 4 carbon atoms include a cyclopropyl group and a cyclobutyl group.

For Rb⁴⁰⁰, in the alkoxy group having 1 or more and 6 or less carbon atoms, the alkyl group may be linear, branched, or cyclic. In the alkoxy group having 1 or more and 6 or less carbon atoms, the alkyl group preferably has 1 or more and 4 or less carbon atoms, more preferably 1 or more and 3 or less carbon atoms, still more preferably 1 or 2 carbon atoms.

Examples of the linear alkoxy group having 1 or more and 6 or less carbon atoms include a methoxy group, an ethoxy group, an n-propoxy group, an n-butoxy group, an n-pentyloxy group, and an n-hexyloxy group.

Examples of the branched alkoxy group having 3 or more and 6 or less carbon atoms include an isopropoxy group, an isobutoxy group, a sec-butoxy group, a tert-butoxy group, an isopentyloxy group, a neopentyloxy group, a tert-pentyloxy group, an isohexyloxy group, a sec-hexyloxy group, and a tert-hexyloxy group.

Examples of the cyclic alkoxy group having 3 or more and 6 or less carbon atoms include a cyclopropoxy group, a cyclobutoxy group, a cyclopentyloxy group, and a cyclohexyloxy group.

For Rb⁴⁰⁰, examples of the halogen atom include a fluorine atom, a chlorine atom, a bromine atom, and an iodine atom.

Rb⁵⁰¹ in the formula (B1), Rb⁵⁰² in the formula (B2), Rb⁵⁰³ in the formula (B3), Rb⁵⁰⁴ in the formula (B4), Rb⁵⁰⁵ in the formula (B5), Rb⁵⁰⁶ in the formula (B6), Rb⁵⁰⁷ in the formula (B7), and Rb⁵⁰⁸ in the formula (B8) are similar in terms of specific forms and exemplary forms and hence Rb⁵⁰¹, Rb⁵⁰², Rb⁵⁰³, Rb⁵⁰⁴, Rb⁵⁰⁵, Rb⁵⁰⁶, Rb⁵⁰⁷, and Rb⁵⁰⁸ will be collectively described as “Rb⁵⁰⁰”.

For Rb⁵⁰⁰, the alkyl group having 1 or more and 4 or less carbon atoms may be linear, branched, or cyclic. The alkyl group preferably has 1 or more and 3 or less carbon atoms, more preferably 1 or 2 carbon atoms, still more preferably 1 carbon atom.

Examples of the linear alkyl group having 1 or more and 4 or less carbon atoms include a methyl group, an ethyl group, an n-propyl group, and an n-butyl group.

Examples of the branched alkyl group having 3 or 4 carbon atoms include an isopropyl group, an isobutyl group, a sec-butyl group, and a tert-butyl group.

Examples of the cyclic alkyl group having 3 or 4 carbon atoms include a cyclopropyl group and a cyclobutyl group.

For Rb⁵⁰⁰, in the alkoxy group having 1 or more and 6 or less carbon atoms, the alkyl group may be linear, branched, or cyclic. In the alkoxy group having 1 or more and 6 or less carbon atoms, the alkyl group preferably has 1 or more and 4 or less carbon atoms, more preferably 1 or more and 3 or less carbon atoms, still more preferably 1 or 2 carbon atoms.

Examples of the linear alkoxy group having 1 or more and 6 or less carbon atoms include a methoxy group, an ethoxy group, an n-propoxy group, an n-butoxy group, an n-pentyloxy group, and an n-hexyloxy group.

Examples of the branched alkoxy group having 3 or more and 6 or less carbon atoms include an isopropoxy group, an isobutoxy group, a sec-butoxy group, a tert-butoxy group, an isopentyloxy group, a neopentyloxy group, a tert-pentyloxy group, an isohexyloxy group, a sec-hexyloxy group, and a tert-hexyloxy group.

Examples of the cyclic alkoxy group having 3 or more and 6 or less carbon atoms include a cyclopropoxy group, a cyclobutoxy group, a cyclopentyloxy group, and a cyclohexyloxy group.

For Rb⁵⁰⁰, examples of the halogen atom include a fluorine atom, a chlorine atom, a bromine atom, and an iodine atom.

Rb⁸⁰¹ in the formula (B1), Rb⁸⁰² in the formula (B2), Rb⁸⁰³ in the formula (B3), Rb⁸⁰⁴ in the formula (B4), Rb⁸⁰⁵ in the formula (B5), Rb⁸⁰⁶ in the formula (B6), Rb⁸⁰⁷ in the formula (B7), and Rb⁸⁰⁸ in the formula (B8) are similar in terms of specific forms and exemplary forms and hence Rb⁸⁰¹, Rb⁸⁰², Rb⁸⁰³, Rb⁸⁰⁴, Rb⁸⁰⁵, Rb⁸⁰⁶, Rb⁸⁰⁷, and Rb⁸⁰⁸ will be collectively described as “Rb⁸⁰⁰”.

For Rb⁸⁰⁰, the alkyl group having 1 or more and 4 or less carbon atoms may be linear, branched, or cyclic. The alkyl group preferably has 1 or more and 3 or less carbon atoms, more preferably 1 or 2 carbon atoms, still more preferably 1 carbon atom.

Examples of the linear alkyl group having 1 or more and 4 or less carbon atoms include a methyl group, an ethyl group, an n-propyl group, and an n-butyl group.

Examples of the branched alkyl group having 3 or 4 carbon atoms include an isopropyl group, an isobutyl group, a sec-butyl group, and a tert-butyl group.

Examples of the cyclic alkyl group having 3 or 4 carbon atoms include a cyclopropyl group and a cyclobutyl group.

For Rb⁸⁰⁰, in the alkoxy group having 1 or more and 6 or less carbon atoms, the alkyl group may be linear, branched, or cyclic. In the alkoxy group having 1 or more and 6 or less carbon atoms, the alkyl group preferably has 1 or more and 4 or less carbon atoms, more preferably 1 or more and 3 or less carbon atoms, still more preferably 1 or 2 carbon atoms.

Examples of the linear alkoxy group having 1 or more and 6 or less carbon atoms include a methoxy group, an ethoxy group, an n-propoxy group, an n-butoxy group, an n-pentyloxy group, and an n-hexyloxy group.

Examples of the branched alkoxy group having 3 or more and 6 or less carbon atoms include an isopropoxy group, an isobutoxy group, a sec-butoxy group, a tert-butoxy group, an isopentyloxy group, a neopentyloxy group, a tert-pentyloxy group, an isohexyloxy group, a sec-hexyloxy group, and a tert-hexyloxy group.

Examples of the cyclic alkoxy group having 3 or more and 6 or less carbon atoms include a cyclopropoxy group, a cyclobutoxy group, a cyclopentyloxy group, and a cyclohexyloxy group.

For Rb⁸⁰⁰, examples of the halogen atom include a fluorine atom, a chlorine atom, a bromine atom, and an iodine atom.

Rb⁹⁰¹ in the formula (B1), Rb⁹⁰² in the formula (B2), Rb⁹⁰³ in the formula (B3), Rb⁹⁰⁴ in the formula (B4), Rb⁹⁰⁵ in the formula (B5), Rb⁹⁰⁶ in the formula (B6), Rb⁹⁰⁷ in the formula (B7), and Rb⁹⁰⁸ in the formula (B8) are similar in terms of specific forms and exemplary forms and hence Rb⁹⁰¹, Rb⁹⁰², Rb⁹⁰³, Rb⁹⁰⁴, Rb⁹⁰⁵, Rb⁹⁰⁶, Rb⁹⁰⁷, and Rb⁹⁰⁸ will be collectively described as “Rb⁹⁰⁰”.

For Rb⁹⁰⁰, the alkyl group having 1 or more and 4 or less carbon atoms may be linear, branched, or cyclic. The alkyl group preferably has 1 or more and 3 or less carbon atoms, more preferably 1 or 2 carbon atoms, still more preferably 1 carbon atom.

Examples of the linear alkyl group having 1 or more and 4 or less carbon atoms include a methyl group, an ethyl group, an n-propyl group, and an n-butyl group.

Examples of the branched alkyl group having 3 or 4 carbon atoms include an isopropyl group, an isobutyl group, a sec-butyl group, and a tert-butyl group.

Examples of the cyclic alkyl group having 3 or 4 carbon atoms include a cyclopropyl group and a cyclobutyl group.

For Rb⁹⁰⁰, in the alkoxy group having 1 or more and 6 or less carbon atoms, the alkyl group may be linear, branched, or cyclic. In the alkoxy group having 1 or more and 6 or less carbon atoms, the alkyl group preferably has 1 or more and 4 or less carbon atoms, more preferably 1 or more and 3 or less carbon atoms, still more preferably 1 or 2 carbon atoms.

Examples of the linear alkoxy group having 1 or more and 6 or less carbon atoms include a methoxy group, an ethoxy group, an n-propoxy group, an n-butoxy group, an n-pentyloxy group, and an n-hexyloxy group.

Examples of the branched alkoxy group having 3 or more and 6 or less carbon atoms include an isopropoxy group, an isobutoxy group, a sec-butoxy group, a tert-butoxy group, an isopentyloxy group, a neopentyloxy group, a tert-pentyloxy group, an isohexyloxy group, a sec-hexyloxy group, and a tert-hexyloxy group.

Examples of the cyclic alkoxy group having 3 or more and 6 or less carbon atoms include a cyclopropoxy group, a cyclobutoxy group, a cyclopentyloxy group, and a cyclohexyloxy group.

For Rb⁹⁰⁰, examples of the halogen atom include a fluorine atom, a chlorine atom, a bromine atom, and an iodine atom.

The following are specific examples of the diol unit (B1) that are diol units (B1-1) to (B1-6). However, the diol unit (B1) is not limited to these.

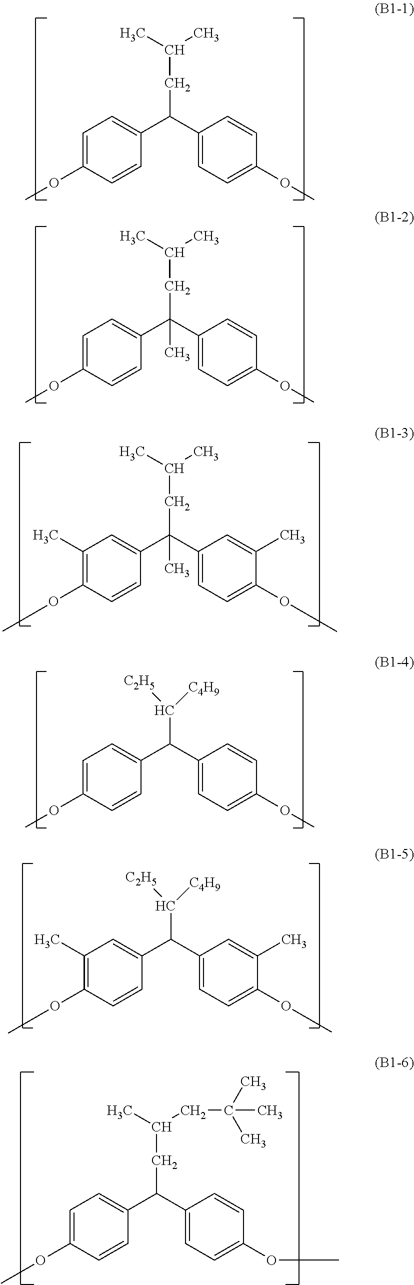

The following are specific examples of the diol unit (B2) that are diol units (B2-1) to (B2-11). However, the diol unit (B2) is not limited to these.

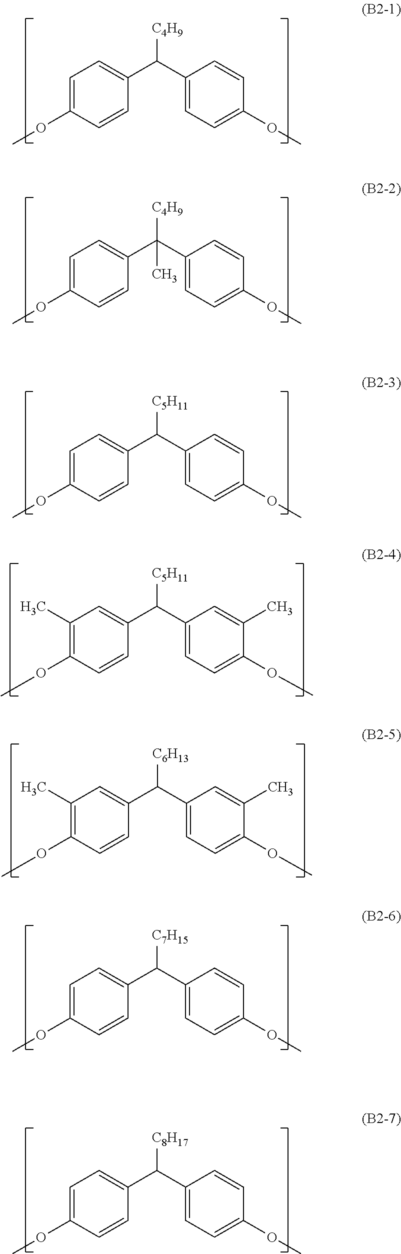

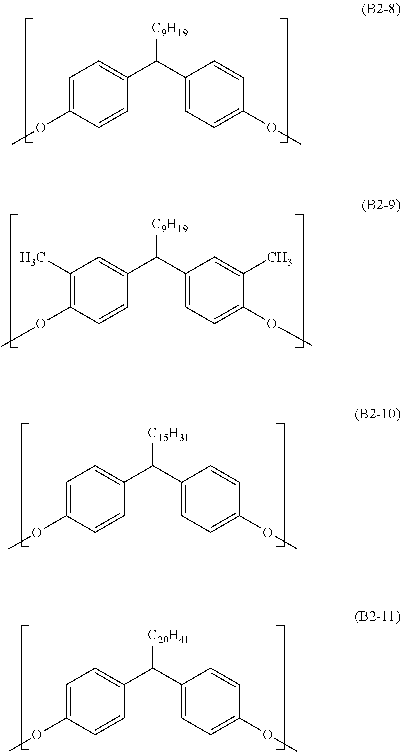

The following are specific examples of the diol unit (B3) that are diol units (B3-1) to (B3-4). However, the diol unit (B3) is not limited to these.

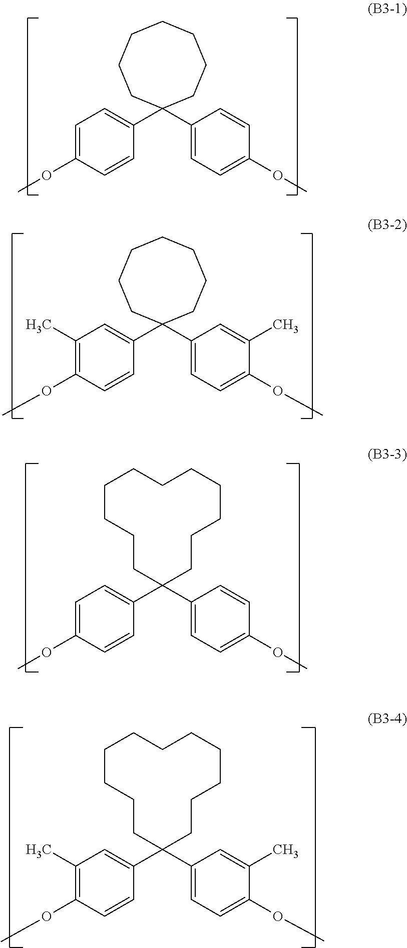

The Following are Specific Examples of the Diol Unit (B4) that are Diol Units (B4-1) to (B4-9). However, the Diol Unit (B4) is not Limited to these.

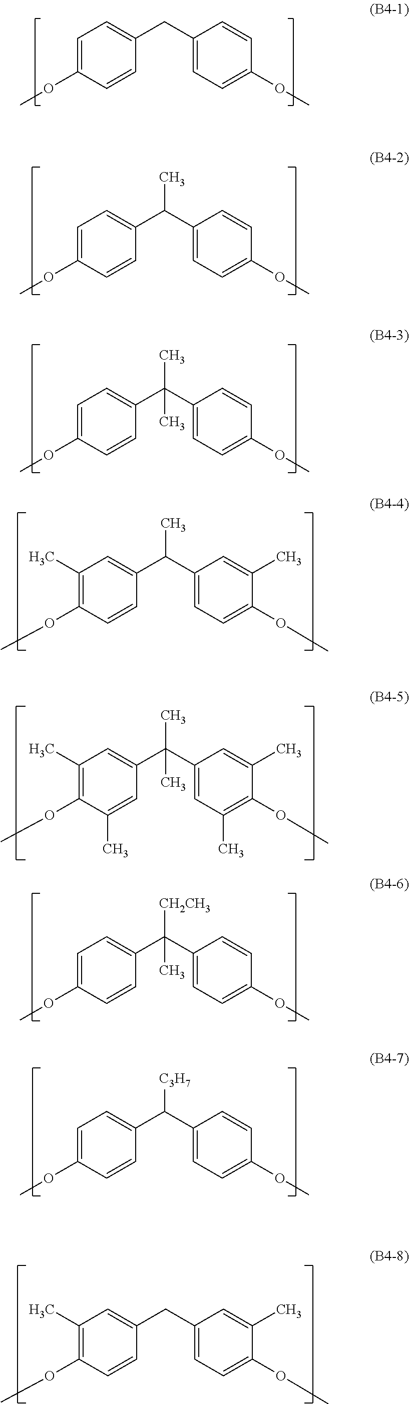

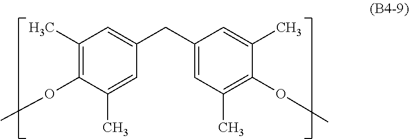

The following are specific examples of the diol unit (B5) that are diol units (B5-1) to (B5-6). However, the diol unit (B5) is not limited to these.

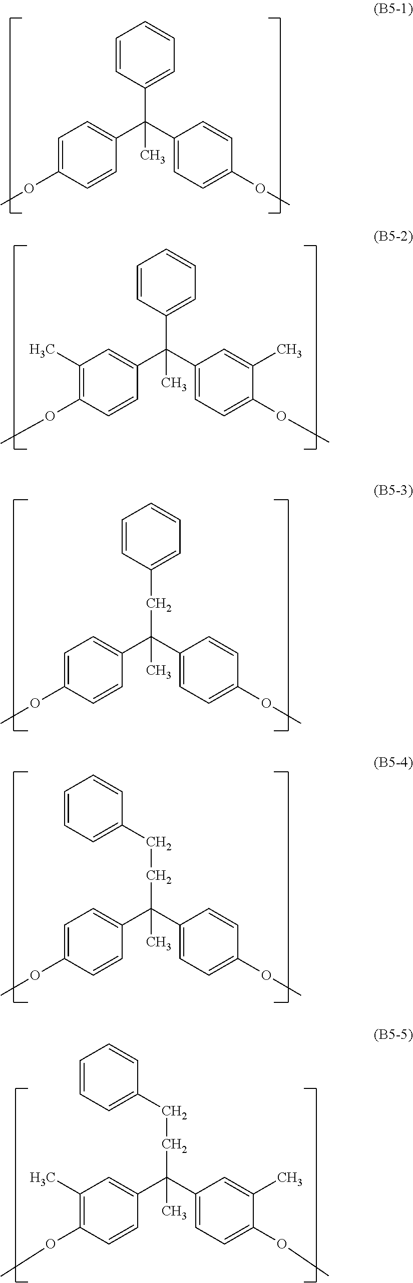

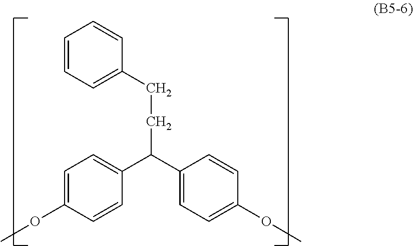

The following are specific examples of the diol unit (B6) that are diol units (B6-1) to (B6-4). However, the diol unit (B6) is not limited to these.

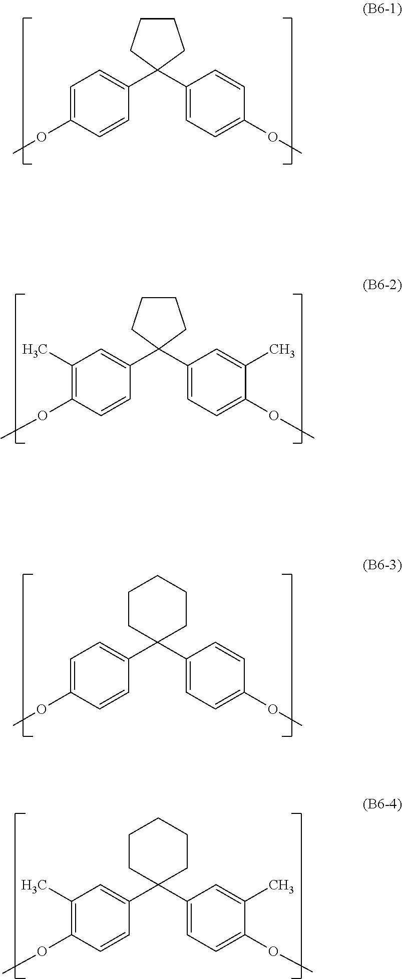

The following are specific examples of the diol unit (B7) that are diol units (B7-1) to (B7-3). However, the diol unit (B7) is not limited to these.

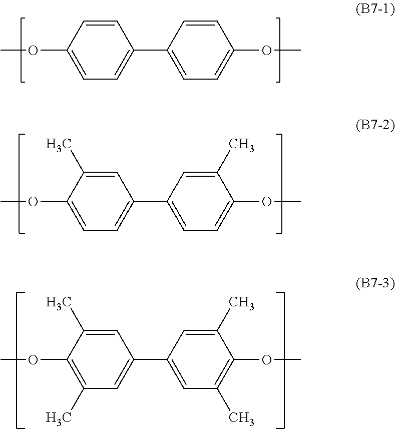

The following are specific examples of the diol unit (B8) that are diol units (B8-1) to (B8-3). However, the diol unit (B8) is not limited to these.

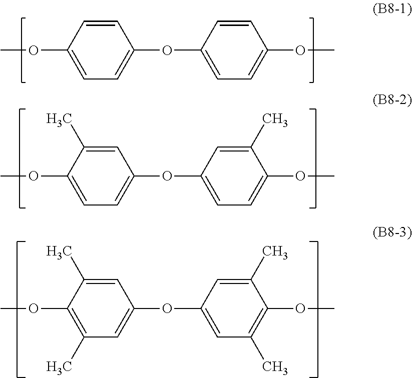

The polyarylate resin (PA) may contain one type or two or more types of the diol units (B).

The mass ratio of the diol unit (B) to the polyarylate resin (PA) is preferably 25 mass % or more and 80 mass % or less.

When the mass ratio of the diol unit (B) is 25 mass % or more, separation of the charge transport layer may be suppressed. From this viewpoint, the mass ratio of the diol unit (B) is more preferably 30 mass % or more, still more preferably 35 mass % or more.

When the mass ratio of the diol unit (B) is 80 mass % or less, abrasion resistance may be improved while maintaining solubility in the coating liquid for forming the charge transport layer. From this viewpoint, the mass ratio of the diol unit (B) is more preferably 75 mass % or less, still more preferably 70 mass % or less.

The polyarylate resin (PA) may contain another diol unit other than the diol unit (B). Examples of the other diol unit include aliphatic diol (such as ethylene glycol, diethylene glycol, triethylene glycol, propylene glycol, butanediol, hexanediol, and neopentyl glycol) units, and alicyclic diol (such as cyclohexanediol, cyclohexanedimethanol, and hydrogenated bisphenol A) units. Such diol units may be contained alone or in combination of two or more thereof in the polyarylate resin (PA).

The ends of the polyarylate resin (PA) may be capped or modified using, for example, a chain terminator or molecular weight modifier used in the production. Examples of the chain terminator or molecular weight modifier include monohydric phenols, monofunctional acid chlorides, monohydric alcohols, and monocarboxylic acids.

Examples of the monohydric phenols include phenol, o-cresol, m-cresol, p-cresol, o-ethylphenol, m-ethylphenol, p-ethylphenol, o-propylphenol, m-propylphenol, p-propylphenol, o-tert-butylphenol, m-tert-butylphenol, p-tert-butylphenol, pentylphenol, hexylphenol, octylphenol, nonylphenol, 2,6-dimethylphenol derivatives, 2-methylphenol derivatives, o-phenylphenol, m-phenylphenol, p-phenylphenol, o-methoxyphenol, m-methoxyphenol, p-methoxyphenol, 2,3,5-trimethylphenol, 2,3,6-trimethylphenol, 2,3-xylenol, 2,4-xylenol, 2,5-xylenol, 2,6-xylenol, 3,4-xylenol, 3,5-xylenol, 2-phenyl-2-(4-hydroxyphenyl) propane, 2-phenyl-2-(2-hydroxyphenyl) propane, and 2-phenyl-2-(3-hydroxyphenyl) propane.

Examples of the monofunctional acid chlorides include monofunctional acid halides such as benzoyl chloride, benzoic acid chloride, methanesulfonyl chloride, phenyl chloroformate, acetyl chloride, butyryl chloride, octanoyl chloride, benzenesulfonyl chloride, benzenesulfinyl chloride, sulfinyl chloride, benzenephosphoryl chloride, and substituted derivatives of the foregoing.

Examples of the monohydric alcohols include methanol, ethanol, n-propanol, isopropanol, n-butanol, 2-butanol, pentanol, hexanol, dodecyl alcohol, stearyl alcohol, benzyl alcohol, and phenethyl alcohol.

Examples of the monocarboxylic acids include acetic acid, propionic acid, octanoic acid, cyclohexanecarboxylic acid, benzoic acid, toluic acid, phenylacetic acid, p-tert-butylbenzoic acid, and p-methoxyphenylacetic acid.

The polyarylate resin (PA) has a weight-average molecular weight (Mw) of preferably 30,000 or more and 300,000 or less, more preferably 40,000 or more and 250,000 or less, still more preferably 50,000 or more and 200,000 or less.

The molecular weight of the polyarylate resin (PA) is a polystyrene-equivalent molecular weight measured by GPC (gel permeation chromatography). GPC is performed using tetrahydrofuran as the eluent.

The polyarylate resin (PA) can be obtained by, for example, subjecting a monomer that is to provide the dicarboxylic unit (A), a monomer that is to provide the diol unit (B), and optionally another monomer to polycondensation by a known method. Examples of the polycondensation method for monomers include an interfacial polymerization method, a solution polymerization method, and a melt polymerization method. The interfacial polymerization method is a polymerization method of mixing a dicarboxylic acid halide dissolved in a water-immiscible organic solvent and a dihydric alcohol dissolved in an alkaline aqueous solution, to obtain a polyester. Examples of documents related to the interfacial polymerization method include W. M. EARECKSON, J. Poly. Sci., XL399, 1959 and Japanese Examined Patent Application Publication No. 40-1959. The interfacial polymerization method may cause a faster reaction than the solution polymerization method and hence may suppress hydrolysis of the dicarboxylic acid halide, which may result in a polyarylate resin (PA) having a high molecular weight.

### Polycarbonate Resin (PC)

The polycarbonate resin (PC) contains a biphenyl-containing constitutional unit represented by the following formula (BP) in an amount of more than 15 mol % relative to all constitutional units. Such polycarbonate resins (PC) may be used alone or in combination of two or more thereof.

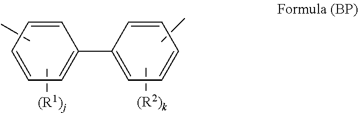

In the formula (BP), j is an integer of 0 or more and 4 or less, j R¹'s are each independently a methyl group or an ethyl group, k is an integer of 0 or more and 4 or less, and k R²'s are each independently a methyl group or an ethyl group.

The polycarbonate resin (PC) contains, relative to all constitutional units, the biphenyl-containing constitutional unit represented by the formula (BP) in an amount of more than 15 mol %, preferably 17 mol % or more and 70 mol % or less, more preferably 18 mol % or more and 60 mol % or less.

When the polycarbonate resin (PC) contains the biphenyl-containing constitutional unit represented by the formula (BP) in an amount of 17 mol % or more relative to all constitutional units, the polycarbonate resin (PC) in the photosensitive layer may have improved aggregatability and fluctuation in the charging potential due to environmental variations may be further suppressed. When the content of the biphenyl-containing constitutional unit represented by the formula (BP) relative to all constitutional units is 70 mol % or less, excessive aggregation of the polycarbonate resin (PC) in the photosensitive layer and variation in dispersibility within the layer may be suppressed, so that both of fluctuation in the charging potential and fluctuation in the post-exposure potential due to environmental variations may be further suppressed.

In the formula (BP), j is an integer of 0 or more and 4 or less, j R¹'s are each independently a methyl group or an ethyl group, k is an integer of 0 or more and 4 or less, and k R²'s are each independently a methyl group or an ethyl group.

The biphenyl represented by the formula (BP) may be the entirety of or a part of a structure in which an ester bond (—C(═O)O—) or a carbonate bond (—OC(═O)O—) is removed from a constitutional unit including the biphenyl represented by the formula (BP). Stated another way, the right end and the left end of the biphenyl represented by the formula (BP) may be each independently bonded directly to an ester bond or a carbonate bond, or may be bonded to an ester bond or a carbonate bond via another atom or atomic group.

j is an integer of 0 or more and 4 or less, preferably an integer of 0 or more and 3 or less, more preferably an integer of 0 or more and 2 or less, still more preferably 0 or 1.

When j is an integer of 1 or more, j R¹'s are each independently a methyl group or an ethyl group, preferably a methyl group.

k is an integer of 0 or more and 4 or less, preferably an integer of 0 or more and 3 or less, more preferably an integer of 0 or more and 2 or less, still more preferably 0 or 1.

When k is an integer of 1 or more, k R²'s are each independently a methyl group or an ethyl group, preferably a methyl group.

The biphenyl represented by the formula (BP) is preferably 4,4′-biphenyl in terms of the linking positions in the main chain.

Specific examples of the constitutional unit including the biphenyl represented by the formula (BP) include the following constitutional units. Of these, from the viewpoint of further suppressing both of fluctuation in the charging potential and fluctuation in the post-exposure potential due to environmental variations, preferred is at least one constitutional unit selected from the group consisting of (1-C3), (1-C4), (1-C5), and (1-C6).

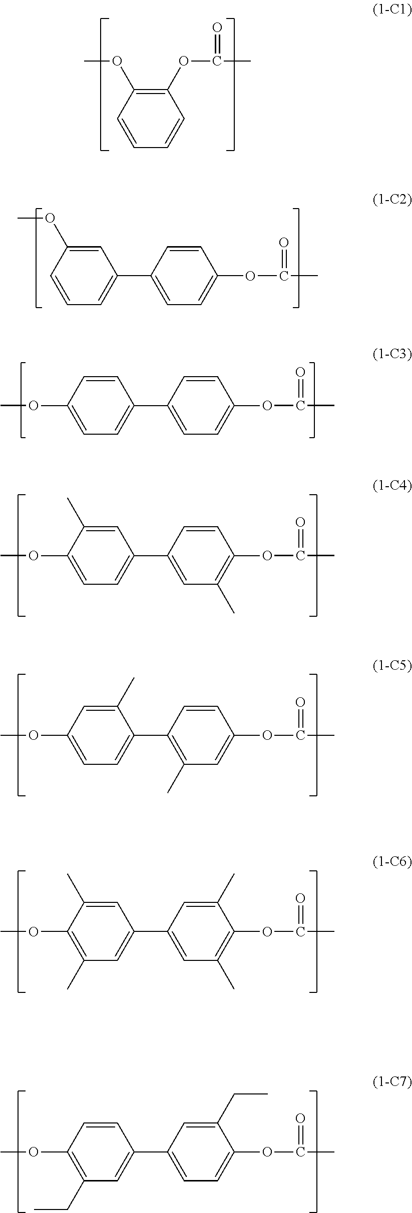

In the photosensitive layer, the polyarylate resin (PA) and the polycarbonate resin (PC) may each contain the biphenyl-containing constitutional unit represented by the formula (BP). In this case, the affinity between the polyarylate resin (PA) and the polycarbonate resin (PC) may be further enhanced and both of fluctuation in the charging potential and fluctuation in the post-exposure potential due to environmental variations may be further suppressed.

The combination of the polyarylate resin (PA) and the polycarbonate resin (PC) is, from the viewpoint of further suppressing both of fluctuation in the charging potential and fluctuation in the post-exposure potential due to environmental variations, particularly preferably a combination of a polyarylate resin containing at least one of the dicarboxylic unit (A2-3), the diol unit (B7-1), and the diol unit (B7-2) and a polycarbonate resin containing the constitutional unit (1-C3) or (1-C4).

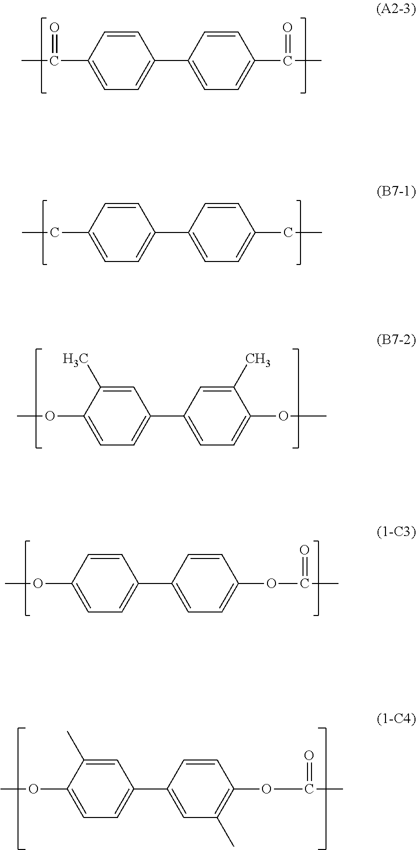

When the photosensitive layer contains both of the polyarylate resin (PA) and the polycarbonate resin (PC), the ratio of the polyarylate resin (PA) to the total amount of the polyarylate resin (PA) and the polycarbonate resin (PC) is, from the viewpoint of enhancing the affinity between the polyarylate resin (PA) and the polycarbonate resin (PC) to further suppress fluctuation in the charging potential due to environmental variations, preferably 20 mass % or more and 80 mass % or less, more preferably 25 mass % or more and 75 mass % or less, still more preferably 30 mass % or more and 70 mass % or less.

Examples of the polycarbonate resin that may be mixed with the polyarylate resin (PA) include the polycarbonate resins disclosed in Japanese Unexamined Patent Application Publication No. 2023-121553. Of these, preferred polycarbonate resins are polycarbonate resins containing the biphenyl-containing constitutional unit represented by the formula (BP).

### Other Resin

The charge transport layer may further contain, as long as advantages of the present disclosure are provided, another resin other than polyarylate resins and polycarbonate resins.

Examples of the other resin include polyester resins other than polyarylate resins, methacrylic resins, acrylic resins, polyvinyl chloride resins, polyvinylidene chloride resins, polystyrene resins, polyvinyl acetate resins, styrene-butadiene copolymers, vinylidene chloride-acrylonitrile copolymers, vinyl chloride-vinyl acetate copolymers, vinyl chloride-vinyl acetate-maleic anhydride copolymers, silicone resins, silicone alkyd resins, phenol-formaldehyde resins, styrene-alkyd resins, poly-N-vinylcarbazole, and polysilanes.

The method for forming the photosensitive layer is similar to a method for forming a charge transport layer and a method for forming a single-layer photosensitive layer described later.

### Conductive Substrate

The conductive substrate may be, for example, a metal plate, a metal drum, or a metal belt containing a metal (such as aluminum, copper, zinc, chromium, nickel, molybdenum, vanadium, indium, gold, or platinum) or an alloy (such as stainless steel). Alternatively, the conductive substrate may be, for example, paper, a resin film, or a belt to which a conductive compound (such as a conductive polymer or indium oxide), a metal (such as aluminum, palladium, or gold), or an alloy is applied, vapor-deposited, or laminated. The term “conductive” means that the volume resistivity is less than 1×10¹³ Ω·cm.

When the electrophotographic photoreceptor is used for a laser printer, in order to suppress interference fringes generated during laser beam irradiation, the surface of the conductive substrate may be roughened to a center-line average roughness Ra of 0.04 μm or more and 0.5 μm or less. When a non-coherent light source is used, the roughening of the surface for preventing interference fringes is not necessarily performed; however, irregularities in the surface of the conductive substrate may suppress generation of defects, which may lead to enhanced service life.

The method for surface roughening may be, for example, wet honing of spraying abrasive suspended in water, to the conductive substrate, centerless grinding of pressing the conductive substrate against a rotating grindstone for continuous grinding, or anodic oxidation treatment.

Another example of the method for surface roughening is a method in which, without roughening the surface of the conductive substrate, a layer is formed on the surface of the conductive substrate using a resin in which a conductive or semiconductive powder is dispersed and the particles dispersed in the layer provide a roughened surface.

The surface roughening treatment by anodization is performed using a conductive substrate formed of a metal (for example, formed of aluminum) as the anode to cause anodic oxidation in an electrolytic solution to thereby form an oxide film on the surface of the conductive substrate. Examples of the electrolytic solution include sulfuric acid solutions and oxalic acid solutions. However, the porous anodic oxide film formed by anodization is chemically active in its untreated state, easily subject to contamination, and undergoes considerable resistance variations due to environmental factors. Thus, the porous anodic oxide film may be subjected to a sealing treatment in which the micropores of the oxide film are sealed by volume expansion through a hydration reaction in pressurized steam or boiling water (optionally containing a salt of a metal such as nickel), to convert the film into a more stable hydrated oxide.

The anodic oxide film may have a film thickness of, for example, 0.3 μm or more and 15 μm or less. When the film thickness is in the range, barrier properties against injection may tend to be exhibited or an increase in the residual potential due to repeated use may tend to be suppressed.

The conductive substrate may be subjected to a treatment using an acidic treatment solution or a boehmite treatment.

The treatment using an acidic treatment solution may be performed in the following manner, for example. First, an acidic treatment solution containing phosphoric acid, chromic acid, and hydrofluoric acid is prepared. In the acidic treatment solution, the mixing proportions of phosphoric acid, chromic acid, and hydrofluoric acid are, for example, in the range of 10 mass % or more and 11 mass % or less for phosphoric acid, in the range of 3 mass % or more and 5 mass % or less for chromic acid, and in the range of 0.5 mass % or more and 2 mass % or less for hydrofluoric acid, with the total concentration of these acids being in the range of 13.5 mass % or more and 18 mass % or less. The treatment temperature may be, for example, 42° C. or more and 48° C. or less. The film may have a film thickness of 0.3 μm or more and 15 μm or less.

The boehmite treatment may be performed by, for example, immersing the substrate in pure water at 90° C. or more and 100° C. or less for 5 minutes to 60 minutes, or by exposing the substrate to heated steam at 90° C. or more and 120° C. or less for 5 minutes to 60 minutes. The film may have a film thickness of 0.1 μm or more and 5 μm or less. This may be further subjected to an anodic oxidation treatment using a solution of an electrolyte having low film dissolving capability, such as adipic acid, boric acid, borate, phosphate, phthalate, maleate, benzoate, tartarate, or citrate.

### Intermediate Layer

An intermediate layer may be further disposed between the undercoat layer and the photosensitive layer.

The intermediate layer is, for example, a layer containing a resin. Examples of the resin used for the intermediate layer include polymers such as acetal resins (such as polyvinyl butyral), polyvinyl alcohol resins, polyvinyl acetal resins, casein resins, polyamide resins, cellulose resins, gelatin, polyurethane resins, polyester resins, methacrylic resins, acrylic resins, polyvinyl chloride resins, polyvinyl acetate resins, vinyl chloride-vinyl acetate-maleic anhydride resins, silicone resins, silicone-alkyd resins, phenol-formaldehyde resins, and melamine resins.

The intermediate layer may be a layer containing an organic metal compound. Examples of the organic metal compound used for the intermediate layer include organic metal compounds containing atoms of a metal such as zirconium, titanium, aluminum, manganese, or silicon.

Such compounds used for the intermediate layer may be used alone or as a mixture or a polycondensate of a plurality of compounds.

In particular, the intermediate layer is preferably a layer containing an organic metal compound containing zirconium atoms or silicon atoms.

The method for forming the intermediate layer is not particularly limited and may be selected from publicly known formation methods; for example, the above-described components are added to a solvent; the resultant intermediate layer-forming coating liquid is used to form a coating film and the coating film is dried and optionally heated.

Examples of the coating method for forming the intermediate layer include known methods such as a dip coating method, a push-up coating method, a wire bar coating method, a spray coating method, a blade coating method, a knife coating method, and a curtain coating method.

The intermediate layer may have an average thickness of 0.1 μm or more and 3 μm or less.

### Charge Generation Layer

The charge generation layer is, for example, a layer containing a charge generation material and a binder resin. Alternatively, the charge generation layer may be a vapor deposition layer of a charge generation material. The vapor deposition layer of a charge generation material may be used in the case of using a non-coherent light source such as LED (Light Emitting Diode) or an organic EL (Electro-Luminescence) image array.

Examples of the charge generation material include azo pigments such as bisazo or trisazo pigments; condensed aromatic pigments such as dibromoanthanthrone; perylene pigments; pyrrolopyrrole pigments; phthalocyanine pigments; zinc oxide; and trigonal selenium.

Of these, in order to accommodate laser exposure in the near-infrared region, the charge generation material is preferably a metal phthalocyanine pigment or a metal-free phthalocyanine pigment. Specifically, preferred is at least one selected from the group consisting of hydroxygallium phthalocyanine, chlorogallium phthalocyanine, dichlorotin phthalocyanine, and titanyl phthalocyanine, more preferred are hydroxygallium phthalocyanine and/or chlorogallium phthalocyanine, and still more preferred is hydroxygallium phthalocyanine.

On the other hand, in order to accommodate laser exposure in the near-ultraviolet region, the charge generation material is preferably selected from condensed aromatic pigments such as dibromoanthanthrone; thioindigo-based pigments; porphyrazine compounds; zinc oxide; trigonal selenium; and bisazo pigments.

Even in the case of using a non-coherent light source such as an LED or an organic EL image array having an emission peak wavelength of 450 nm or more and 780 nm or less, the above-described charge generation material may be used.

In the case of using, as the charge generation material, an n-type semiconductor such as a condensed aromatic pigment, a perylene pigment, or an azo pigment, dark current may be less likely to occur and, even when formed into a thin film, image defects called black spots may be suppressed. Whether or not a material is of an n-type is determined by the time-of-flight method, which is commonly used, on the basis of the polarity of the photocurrent; materials that transport, as carriers, electrons more readily than holes are determined as n-type.

The binder resin used for the charge generation layer may be selected from a wide range of insulating resins or the binder resin may be selected from organic photoconductive polymers such as poly-N-vinylcarbazole, polyvinylanthracene, polyvinylpyrene, and polysilane.

Examples of the binder resin include polyvinyl butyral resins, polyarylate resins (such as polycondensates of a bisphenol and an aromatic divalent carboxylic acid), polycarbonate resins, polyester resins, phenoxy resins, vinyl chloride-vinyl acetate copolymers, polyamide resins, acrylic resins, polyacrylamide resins, polyvinyl pyridine resins, cellulose resins, urethane resins, epoxy resins, casein, polyvinyl alcohol resins, and polyvinyl pyrrolidone resins. The term “insulating” used herein means that the volume resistivity is 1×10¹³ Ω·cm or more.

Such binder resins may be used alone or in combination of two or more thereof.

The mixing ratio of the charge generation material and the binder resin may be, in a mass ratio, in the range of 10:1 to 1:10.

The charge generation layer may additionally contain a publicly known additive.

The method for forming the charge generation layer is not particularly limited and may be selected from publicly known formation methods; for example, the above-described components are added to a solvent; the resultant charge generation layer-forming coating liquid is used to form a coating film; and the coating film is dried and optionally heated. Alternatively, the charge generation layer may be formed by vapor deposition of the charge generation material. The charge generation layer may be formed by vapor deposition, in particular, in the case of using, as the charge generation material, a condensed aromatic pigment or a perylene pigment.

Examples of the solvent for preparing the charge generation layer-forming coating liquid include methanol, ethanol, n-propanol, n-butanol, benzyl alcohol, methyl cellosolve, ethyl cellosolve, acetone, methyl ethyl ketone, cyclohexanone, methyl acetate, n-butyl acetate, dioxane, tetrahydrofuran, methylene chloride, chloroform, chlorobenzene, and toluene. These solvents are used alone or in combination of two or more thereof.

Particles (such as the charge generation material) may be dispersed in the charge generation layer-forming coating liquid by using, for example, a media-type disperser such as a ball mill, a vibratory ball mill, an attritor, a sand mill, or a horizontal sand mill, or a media-less disperser such as a stirrer, an ultrasonic disperser, a roll mill, or a high-pressure homogenizer. Examples of the high-pressure homogenizer include a collision-type high-pressure homogenizer in which a dispersion liquid is subjected to liquid-liquid collision or liquid-wall collision in a high-pressure state to achieve dispersion and a penetration-type high pressure homogenizer in which a dispersion liquid is caused to pass through a fine flow path in a high-pressure state to achieve dispersion.

During the dispersion, in the charge generation layer-forming coating liquid, the average particle diameter of the charge generation material may be brought to 0.5 μm or less, preferably 0.3 μm or less, more preferably 0.15 μm or less.

Examples of the method for applying the charge generation layer-forming coating liquid onto the undercoat layer (or onto the intermediate layer) include known methods such as a blade coating method, a wire bar coating method, a spray coating method, a dip coating method, a bead coating method, an air knife coating method, and a curtain coating method.

The charge generation layer preferably has an average thickness of 0.1 μm or more and 5.0 μm or less, more preferably 0.2 μm or more and 2.0 μm or less.

### Charge Transport Layer

The charge transport layer is, for example, a layer containing a charge transport material and a binder resin. The charge transport layer may be a layer containing a polymeric charge transport material.

Examples of the charge transport material include electron transport compounds such as quinone-based compounds such as p-benzoquinone, chloranil, bromanil, and anthraquinone; tetracyanoquinodimethane-based compounds; fluorenone compounds such as 2,4,7-trinitrofluorenone; xanthone-based compounds; benzophenone-based compounds; cyanovinyl-based compounds; and ethylene-based compounds. Other examples of the charge transport material include hole transport compounds such as triarylamine-based compounds, benzidine-based compounds, arylalkane-based compounds, aryl-substituted ethylene-based compounds, stilbene-based compounds, anthracene-based compounds, and hydrazone-based compounds. Such non-limiting charge transport materials may be used alone or in combination of two or more thereof.

Examples of the polymeric charge transport material include publicly known chemical substances having charge transport properties such as poly-N-vinylcarbazole and polysilane. For example, preferred are polyester-based polymeric charge transport materials. Such polymeric charge transport materials may be used alone or in combination with a binder resin.

Other examples of the charge transport material and the polymeric charge transport material include polycyclic aromatic compounds, aromatic nitro compounds, aromatic amine compounds, heterocyclic compounds, hydrazone compounds, styryl compounds, enamine compounds, benzidine compounds, triarylamine compounds (in particular, triphenylamine compounds), diamine compounds, oxadiazole compounds, carbazole compounds, organic polysilane compounds, pyrazoline compounds, indole compounds, oxazole compounds, isooxazole compounds, thiazole compounds, thiadiazole compounds, imidazole compounds, pyrazole compounds, triazole compounds, cyano compounds, benzofuran compounds, aniline compounds, butadiene compounds, and resins including groups derived from the foregoing substances. Specific examples include the compounds described in Paragraphs 0078 to 0080 of Japanese Unexamined Patent Application Publication No. 2021-117377, Paragraphs 0046 to 0048 of Japanese Unexamined Patent Application Publication No. 2019-035900, Paragraphs 0052 to 0053 of Japanese Unexamined Patent Application Publication No. 2019-012141, Paragraphs 0122 to 0134 of Japanese Unexamined Patent Application Publication No. 2021-071565, Paragraphs 0101 to 0110 of Japanese Unexamined Patent Application Publication No. 2021-015223, Paragraph 0116 of Japanese Unexamined Patent Application Publication No. 2013-097300, Paragraphs 0309 to 0316 of International Publication No. 2019/070003, Paragraphs 0103 to 0107 of Japanese Unexamined Patent Application Publication No. 2018-159087, and Paragraphs 0102 to 0113 of Japanese Unexamined Patent Application Publication No. 2021-148818.

The charge transport material, from the viewpoint of charge mobility, may contain at least one selected from the group consisting of a compound (C1) represented by a formula (C1) below, a compound (C2) represented by a formula (C2) below, a compound (C3) represented by a formula (C3) below, and a compound (C4) represented by a formula (C4) below.

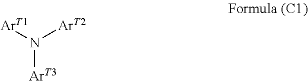

In the formula (C1), Ar^{T1}, Ar^{T2}, and Ar^{T3} are each independently an aryl group, —C₆H₄—C(R^{T4})═C(R^{T5})(R^{T6}), or —C₆H₄—CH═CH—CH═C(R^{T7})(R^{T8}). R^{T4}, R^{T5}, R^{T6}, R^{T7}, and R^{T8} are each independently a hydrogen atom, an alkyl group, or an aryl group. When R^{T5} and R^{T6} are aryl groups, the aryl groups may be linked together via a divalent group of —C(R⁵¹)(R⁵²)— and/or —C(R⁶¹)═C(R⁶²)—. R⁵¹, R⁵², R⁶¹, and R⁶² are each independently a hydrogen atom or an alkyl group having 1 or more and 3 or less carbon atoms.

In the formula (C1), groups may be substituted with a substituted amino group substituted with a halogen atom, an alkyl group having 1 or more and 5 or less carbon atoms, an alkoxy group having 1 or more and 5 or less carbon atoms, or an alkyl group having 1 or more and 3 or less carbon atoms.

The compound (C1) is, from the viewpoint of charge mobility, preferably a compound having at least one aryl group or —C₆H₄—CH═CH—CH═C(R^{T7})(R^{T8}), more preferably a compound (C′1) represented by the following formula (C′1).

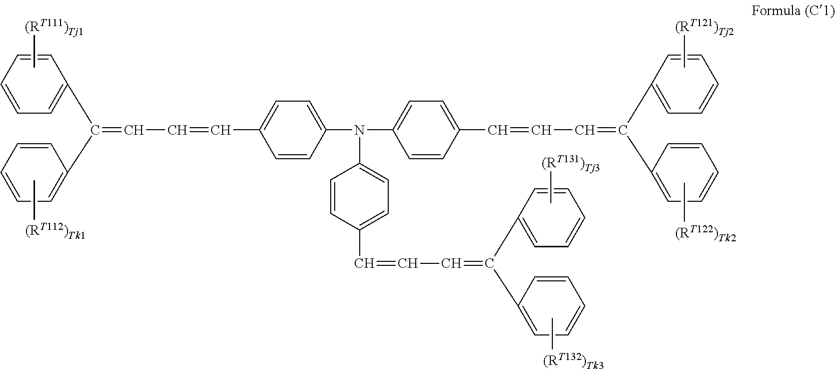

In the formula (C′1), R^{T111}, R^{T112}, R^{T121}, R^{T122}, R^{T131}, and R^{T132} are each independently a hydrogen atom, a halogen atom, an alkyl group (preferably an alkyl group having 1 or more and 3 or less carbon atoms), an alkoxy group (preferably an alkoxy group having 1 or more and 3 or less carbon atoms), a phenyl group, or a phenoxy group. Tj1, Tj2, Tj3, Tk1, Tk2, and Tk3 are each independently 0, 1, or 2.

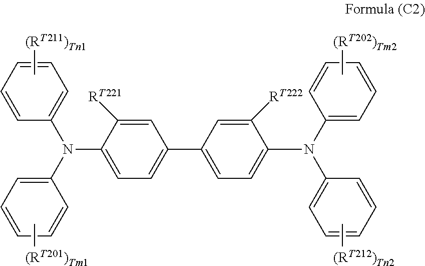

In the formula (C2), R^{T201}, R^{T202}, R^{T211}, and R^{T212} are each independently a halogen atom, an alkyl group having 1 or more and 5 or less carbon atoms, an alkoxy group having 1 or more and 5 or less carbon atoms, an amino group substituted with an alkyl group having 1 or 2 carbon atoms, an aryl group, —C(R^{T21})═C(R^{T22})(R^{T23}), or —CH═CH—CH═C(R^{T24})(R^{T25}). R^{T21}, R^{T22}, R^{T23}, R^{T24}, and R^{T25} are each independently a hydrogen atom, an alkyl group, or an aryl group. R^{T221} and R^{T222} are each independently a hydrogen atom, a halogen atom, an alkyl group having 1 or more and 5 or less carbon atoms, or an alkoxy group having 1 or more and 5 or less carbon atoms. Tm1, Tm2, Tn1, and Tn2 are each independently 0, 1, or 2.

In the formula (C2), groups may be substituted with a halogen atom, an alkyl group having 1 or more and 5 or less carbon atoms, an alkoxy group having 1 or more and 5 or less carbon atoms, or a substituted amino group substituted with an alkyl group having 1 or more and 3 or less carbon atoms.

The compound (C2) is, from the viewpoint of charge mobility, preferably a compound including at least one of an alkyl group, an aryl group, and —CH═CH—CH═C(R^{T24})(R^{T25}), more preferably a compound including two of alkyl groups, aryl groups, and —CH═CH—CH═C(R^{T24})(R^{T25}).

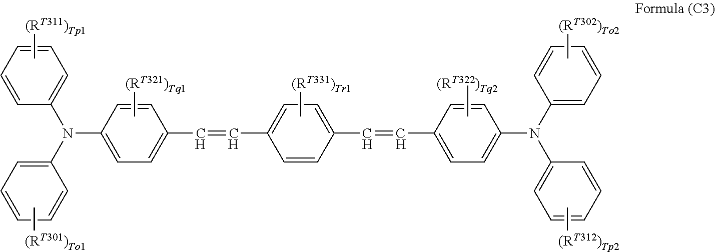

In the formula (C3), R^{T301}, R^{T302}, R^{T311}, and R^{T312} are each independently a halogen atom, an alkyl group having 1 or more and 5 or less carbon atoms, an alkoxy group having 1 or more and 5 or less carbon atoms, an amino group substituted with an alkyl group having 1 or 2 carbon atoms, an aryl group, —C(R^{T31})═C(R^{T32})(R^{T33}), or —CH═CH—CH═C(R^{T34})(R^{T35}). R^{T31}, R^{T32}, R^{T33}, R^{T34}, and R^{T35} are each independently a hydrogen atom, an alkyl group, or an aryl group. R^{T321}, R^{T322}, and R^{T331} are each independently a hydrogen atom, a halogen atom, an alkyl group having 1 or more and 5 or less carbon atoms, or an alkoxy group having 1 or more and 5 or less carbon atoms. To1, To2, Tp1, Tp2, Tq1, Tq2, and Tr1 are each independently 0, 1, or 2.

In the formula (C3), groups may be substituted with a halogen atom, an alkyl group having 1 or more and 5 or less carbon atoms, an alkoxy group having 1 or more and 5 or less carbon atoms, or a substituted amino group substituted with an alkyl group having 1 or more and 3 or less carbon atoms.

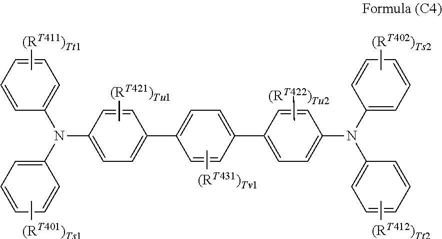

In the formula (C4), R^{T401}, R^{T402}, R^{T411}, and R^{T412} are each independently a halogen atom, an alkyl group having 1 or more and 5 or less carbon atoms, an alkoxy group having 1 or more and 5 or less carbon atoms, an amino group substituted with an alkyl group having 1 or 2 carbon atoms, an aryl group, —C(R^{T41})═C(R^{T42})(R^{T43}), or —CH═CH—CH═C(R^{T44})(R^{T45}). R^{T41}, R^{T42}, R^{T43}, R^{T44}, and R^{T45} are each independently a hydrogen atom, an alkyl group, or an aryl group. R^{T421}, R^{T422}, and R^{T431} are each independently a hydrogen atom, a halogen atom, an alkyl group having 1 or more and 5 or less carbon atoms, or an alkoxy group having 1 or more and 5 or less carbon atoms. Ts1, Ts2, Tt1, Tt2, Tu1, Tu2, and Tv1 are each independently 0, 1, or 2.

In the formula (C4), groups may be substituted with a halogen atom, an alkyl group having 1 or more and 5 or less carbon atoms, an alkoxy group having 1 or more and 5 or less carbon atoms, or a substituted amino group substituted with an alkyl group having 1 or more and 3 or less carbon atoms.

The content of the charge transport material contained in the charge transport layer relative to the total mass of the charge transport layer may be 20 mass % or more and 70 mass % or less.

The charge transport layer contains, as a binder resin, at least a polyester resin (1).

The ratio of the polyester resin (1) to the total amount of the binder resin contained in the charge transport layer is preferably 40 mass % or more, more preferably 50 mass % or more, still more preferably 60 mass % or more, particularly preferably 70 mass % or more.

When the polyester resin (1) is used in combination with another resin, the other resin used in combination may be a polycarbonate resin.

In an exemplary embodiment, the charge transport layer contains, as a binder resin, the polyester resin (1) and a polycarbonate resin. In this case, the mass ratio of the resins is preferably polyester resin (1): polycarbonate resin=95:5 to 30:70, more preferably 95:5 to 40:60.

The mass ratio of the total of the polyester resin (1) and the polycarbonate resin to the charge transport layer is preferably 15 mass % or more and 80 mass % or less, more preferably 20 mass % or more and 75 mass % or less, still more preferably 25 mass % or more and 70 mass % or less.

The polycarbonate resin is preferably a polycarbonate resin in which constitutional units having an aromatic ring are continuously arranged, and specific examples thereof include polycarbonate resins used in Examples described later.

The charge transport layer may contain another binder resin other than the polyester resin (1) and the polycarbonate resin. Examples of the other binder resin include polyester resins other than the polyester resin (1), methacrylic resins, acrylic resins, polyvinyl chloride resins, polyvinylidene chloride resins, polystyrene resins, polyvinyl acetate resins, styrene-butadiene copolymers, vinylidene chloride-acrylonitrile copolymers, vinyl chloride-vinyl acetate copolymers, vinyl chloride-vinyl acetate-maleic anhydride copolymers, silicone resins, silicone-alkyd resins, phenol-formaldehyde resins, styrene-alkyd resins, poly-N-vinylcarbazole, and polysilanes. Such binder resins may be used alone or in combination of two or more thereof.

In addition, the charge transport layer may contain a publicly known additive. The additive may be, for example, an antioxidant, a leveling agent, a defoaming agent, a filler, or a viscosity modifier.

As the antioxidant, a hindered phenol compound is preferably contained. In general, hindered phenol compounds are compounds in which at least one of ortho positions of the hydroxy group of phenol is substituted with a bulky group and may further inhibit oxidation of the composition.

Such antioxidants may be used alone or in combination of two or more thereof.

Specific examples of the hindered phenol compound include the hindered phenol compounds described in to of Japanese Unexamined Patent Application Publication No. 2024-14422 and the hindered phenol compounds described in to of Japanese Patent No. 7609333.

The content of the hindered phenol compound is, from the viewpoint of an oxidation inhibition property, relative to the total mass of the charge transport layer, preferably 0.5 mass % or more and 10.0 mass % or less, more preferably 1.5 mass % or more and 7.5 mass % or less, still more preferably 2.0 mass % or more and 5.0 mass % or less.

The method for forming the charge transport layer is not particularly limited and may be a publicly known formation method; for example, the above-described components are added to a solvent; the resultant charge transport layer-forming coating liquid is used to form a coating film, and the coating film is dried and optionally heated.

Examples of the solvent for preparing the charge transport layer-forming coating liquid include known organic solvents such as aromatic hydrocarbons such as benzene, toluene, xylene, and chlorobenzene; ketones such as acetone and 2-butanone; halogenated aliphatic hydrocarbons such as methylene chloride, chloroform, and ethylene chloride; and cyclic or linear ethers such as tetrahydrofuran and ethyl ether. These solvents may be used alone or in combination of two or more thereof.

Examples of the coating method of applying the charge transport layer-forming coating liquid onto the charge generation layer include known methods such as a blade coating method, a wire bar coating method, a spray coating method, a dip coating method, a bead coating method, an air knife coating method, and a curtain coating method.

The charge transport layer has an average thickness of, from the viewpoint of photosensitivity and wear life of the photoreceptor, preferably 20 μm or more, more preferably 22 μm or more, still more preferably 25 μm or more.

The average thickness of the charge transport layer is, from the viewpoint of residual potential, preferably 50 μm or less, more preferably 47 μm or less, still more preferably 45 μm or less.

### Single-Layer Photosensitive Layer

The single-layer photosensitive layer (charge generation/charge transport layer) is, for example, a layer containing a charge generation material, a charge transport material, and optionally a binder resin and another publicly known additive. These materials are the same as the materials having been described for the charge generation layer and the charge transport layer.

In the single-layer photosensitive layer, the content of the charge generation material relative to the total solid content may be 0.1 mass % or more and 10 mass % or less, and is preferably 0.8 mass % or more and 5 mass % or less. In the single-layer photosensitive layer, the content of the charge transport material relative to the total solid content may be 5 mass % or more and 50 mass % or less.

The method for forming the single-layer photosensitive layer is similar to the method for forming the charge generation layer or the charge transport layer.

The single-layer photosensitive layer may have a layer thickness of, for example, 5 μm or more and 50 μm or less, preferably 10 μm or more and 40 μm or less.

### Protective Layer

A protective layer is optionally disposed on the photosensitive layer. The protective layer may be disposed for the purpose of, for example, preventing a chemical change of the photosensitive layer being charged or further increasing the mechanical strength of the photosensitive layer.

Thus, as the protective layer, a layer formed of a cured film (crosslinked film) may be applied. Examples of the layer include the following layers in 1) and 2).
1) a layer formed of a cured film of a composition containing a reactive group-containing charge transport material including a reactive group and a charge transport skeleton in the same molecule (in other words, a layer containing a polymer or crosslinked product of the reactive group-containing charge transport material)
2) a layer formed of a cured film of a composition containing a nonreactive charge transport material and a reactive group-containing non-charge transport material not having a charge transport skeleton but having a reactive group (in other words, a layer containing the nonreactive charge transport material and a polymer or crosslinked product of the reactive group-containing non-charge transport material)

In the reactive group-containing charge transport material, examples of the reactive group include publicly known reactive groups such as chain polymerization groups, an epoxy group, —OH, —OR [where R represents an alkyl group], —NH₂, —SH, —COOH, and —SiR^{Q1}_{3-Qn} (OR^{Q2})_{Qn} [where R^{Q1} represents a hydrogen atom, an alkyl group, or a substituted or unsubstituted aryl group, R^{Q2} represents a hydrogen atom, an alkyl group, or a trialkylsilyl group, and Qn represents an integer of 1 to 3].

Such a chain polymerization group is not particularly limited as long as it is a functional group that can undergo radical polymerization and may be, for example, at least a functional group including a group containing a carbon double bond. Specifically, the group is, for example, a group containing at least one selected from a vinyl group, a vinyl ether group, a vinyl thioether group, a phenylvinyl group, a vinylphenyl group, an acryloyl group, a methacryloyl group, and derivatives of the foregoing. In particular, the chain polymerization group is preferably, from the viewpoint of having high reactivity, a group containing at least one selected from a vinyl group, a phenylvinyl group, a vinylphenyl group, an acryloyl group, a methacryloyl group, and derivatives of the foregoing.

In the reactive group-containing charge transport material, the charge transport skeleton is not particularly limited as long as it is a publicly known structure in electrophotographic photoreceptors, and may be, for example, a skeleton derived from a nitrogen-containing hole transport compound such as a triarylamine-based compound, a benzidine-based compound, or a hydrazone-based compound, the skeleton having a structure conjugated with a nitrogen atom. Of these, preferred is a triarylamine skeleton.

The reactive group-containing charge transport material including a reactive group and a charge transport skeleton, the nonreactive charge transport material, and the reactive group-containing non-charge transport material may be selected from publicly known materials. The protective layer may further contain a publicly known additive.

The method for forming the protective layer is not particularly limited and may be selected from publicly known formation methods; for example, the above-described components are added to a solvent; the resultant protective layer-forming coating liquid is used to form a coating film, and the coating film is dried and optionally subjected to a curing treatment such as heating.

Examples of the solvent for preparing the protective layer-forming coating liquid include aromatic solvents such as toluene and xylene; ketone-based solvents such as methyl ethyl ketone, methyl isobutyl ketone, and cyclohexanone; ester-based solvents such as ethyl acetate and butyl acetate; ether-based solvents such as tetrahydrofuran and dioxane; cellosolve-based solvents such as ethylene glycol monomethyl ether; and alcohol-based solvents such as isopropyl alcohol and butanol. These solvents are used alone or in combination of two or more thereof.

Alternatively, the protective layer-forming coating liquid may be a solventless coating liquid.

Examples of the method for applying the protective layer-forming coating liquid onto a photosensitive layer (such as a charge transport layer) include known methods such as a dip coating method, a push-up coating method, a wire bar coating method, a spray coating method, a blade coating method, a knife coating method, and a curtain coating method.

The protective layer preferably has an average thickness of 1 μm or more and 20 μm or less, more preferably 2 μm or more and 10 μm or less.

### Image Forming Apparatus and Process Cartridge

An image forming apparatus according to the present disclosure includes an electrophotographic photoreceptor, a charging unit that charges a surface of the electrophotographic photoreceptor, an electrostatic latent image forming unit that forms an electrostatic latent image on the charged surface of the electrophotographic photoreceptor, a development unit that uses a developer containing toner to develop the electrostatic latent image formed on the surface of the electrophotographic photoreceptor to form a toner image, and a transfer unit that transfers the toner image onto a surface of a recording medium. As the electrophotographic photoreceptor, the electrophotographic photoreceptor according to the present disclosure is applied.

For the image forming apparatus according to the present disclosure, publicly known image forming apparatuses are applied, such as an apparatus including a fixing unit that fixes a toner image having been transferred onto the surface of a recording medium; a direct-transfer apparatus in which a toner image having been transferred onto the surface of the electrophotographic photoreceptor is directly transferred to a recording medium; an intermediate-transfer apparatus in which a toner image having been formed on the surface of the electrophotographic photoreceptor is subjected to first transfer to the surface of an intermediate transfer body, and the toner image having been transferred to the surface of the intermediate transfer body is subjected to second transfer to the surface of a recording medium; an apparatus including a cleaning unit that cleans the surface of the electrophotographic photoreceptor after transfer of a toner image and before charging; an apparatus including a discharging unit that irradiates the surface of the electrophotographic photoreceptor with discharging light to discharge the surface after transfer of a toner image and before charging; and an apparatus including an electrophotographic-photoreceptor heating member that increases the temperature of the electrophotographic photoreceptor to lower the relative temperature.

In the case of the intermediate-transfer apparatus, the transfer unit includes, for example, an intermediate transfer body onto the surface of which a toner image is transferred, a first transfer unit that performs first transfer of transferring the toner image having been formed on the surface of the electrophotographic photoreceptor, onto the surface of the intermediate transfer body, and a second transfer unit that performs second transfer of transferring the toner image having been transferred onto the surface of the intermediate transfer body, onto the surface of a recording medium.

The image forming apparatus according to the present disclosure may be either a dry-development image forming apparatus or a wet-development (development using a liquid developer) image forming apparatus.

In the image forming apparatus according to the present disclosure, for example, a part including the electrophotographic photoreceptor may have a cartridge structure (process cartridge) that is attachable to and detachable from the image forming apparatus. The process cartridge may be, for example, a process cartridge including the electrophotographic photoreceptor according to the present disclosure. The process cartridge may include, in addition to the electrophotographic photoreceptor, for example, at least one selected from the group consisting of a charging unit, an electrostatic latent image forming unit, a development unit, and a transfer unit.

Hereinafter, a non-limiting example of the image forming apparatus according to the present disclosure will be described. Some parts illustrated in the drawings will be described and the other parts will not be described.

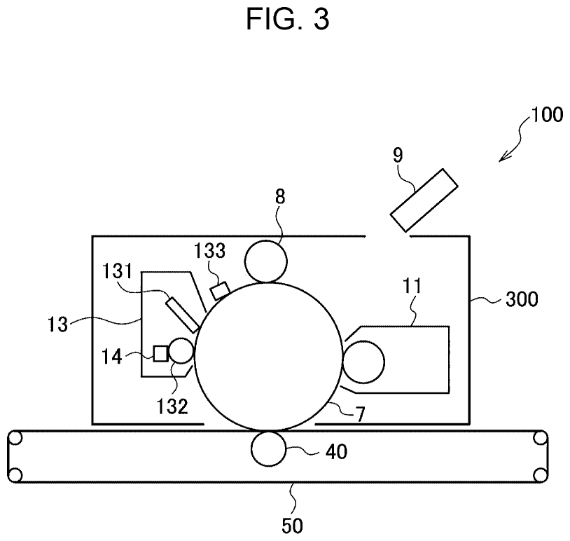

FIG. 3 is a schematic configuration view illustrating an example of the image forming apparatus according to the present disclosure.

An image forming apparatus 100 according to the present disclosure includes, as illustrated in FIG. 3, a process cartridge 300 including an electrophotographic photoreceptor 7, an exposure unit 9 (an example of the electrostatic latent image forming unit), a transfer unit 40 (first transfer unit), and an intermediate transfer body 50. In the image forming apparatus 100, the exposure unit 9 is disposed at a position where it can expose the electrophotographic photoreceptor 7 through an opening of the process cartridge 300; the transfer unit 40 is disposed at a position where it faces, via the intermediate transfer body 50, the electrophotographic photoreceptor 7; the intermediate transfer body 50 is disposed such that a portion thereof is in contact with the electrophotographic photoreceptor 7. The image forming apparatus 100 also includes a second transfer unit (not shown) that transfers a toner image having been transferred onto the intermediate transfer body 50, onto a recording medium (such as a paper sheet). The intermediate transfer body 50, the transfer unit 40 (first transfer unit), and the second transfer unit (not shown) correspond to examples of the transfer unit.

In FIG. 3, the process cartridge 300 collectively supports, within its housing, the electrophotographic photoreceptor 7, a charging unit 8 (an example of the charging unit), a development unit 11 (an example of the development unit), and a cleaning unit 13 (an example of the cleaning unit). The cleaning unit 13 includes a cleaning blade (an example of the cleaning member) 131, and the cleaning blade 131 is disposed so as to be in contact with the surface of the electrophotographic photoreceptor 7. The cleaning member may be, instead of the cleaning blade 131, a conductive or insulating fibrous member; this member may be used alone or in combination with the cleaning blade 131.

FIG. 3 illustrates an exemplary embodiment in which the image forming apparatus includes a fibrous member 132 (in the form of a roller) that supplies a lubricant 14 to the surface of the electrophotographic photoreceptor 7 and a fibrous member 133 (in the form of a flat brush) that assists cleaning; however, these members are optionally disposed.

Hereinafter, units of the image forming apparatus according to the present disclosure will be described.

### Charging Unit

The charging unit 8 may be, for example, a contact charger using a conductive or semiconductive charging roller, a charging brush, a charging film, a charging rubber blade, or a charging tube. Alternatively, a publicly known charger per se may be used such as a non-contact-type roller charger or a corona discharge-based charger such as a scorotron charger or a corotron charger.

### Exposure Unit

The exposure unit 9 is, for example, an optical device that exposes the surface of the electrophotographic photoreceptor 7 to light such as a semiconductor laser beam, an LED beam, or a beam from a liquid crystal shutter, in a predetermined image pattern. The wavelength of the light source is set within the spectral sensitivity range of the electrophotographic photoreceptor. As for the wavelengths of semiconductor lasers, near-infrared having lasing wavelengths at or around 780 nm is mainstream. However, the lasers are not limited to these wavelengths and lasers having lasing wavelengths in the 600 nm range or blue lasers having lasing wavelengths in 400 nm or more and 450 nm or less may alternatively be employed. Alternatively, for color image formation, surface-emitting laser light sources that emit multiple beams may be used.

### Development Unit

The development unit 11 may be, for example, a general development unit that uses a developer in a contact or non-contact manner to perform development. The development unit 11 is not particularly limited as long as it has the above-described function and is selected in accordance with the purpose. Examples include publicly known development devices having a function of causing a one-component developer or a two-component developer to adhere to the electrophotographic photoreceptor 7 using a brush, a roller, or the like. In particular, preferred are development devices using a development roller holding a developer on its surface.

The developer used for the development unit 11 may be a one-component developer of toner alone or a two-component developer including toner and carriers. The developer may be magnetic or non-magnetic. Such developers are publicly known developers.

### Cleaning Unit

The cleaning unit 13 may be a cleaning blade-type unit including the cleaning blade 131. Instead of the cleaning blade-type, a fur brush cleaning-type or a simultaneous development and cleaning-type may be employed.

### Transfer Unit

The transfer unit 40 may be, for example, a publicly known transfer charger per se, such as a contact-type transfer charger using a belt, a roller, a film, a rubber blade, or the like, or a corona discharge-based transfer charger such as a scorotron transfer charger or a corotron transfer charger.

### Intermediate Transfer Body

The intermediate transfer body 50 has the form of a belt (intermediate transfer belt) containing polyimide, polyamide-imide, polycarbonate, polyarylate, polyester, rubber, or the like to which semiconductive properties are imparted. The form of the intermediate transfer body may be, instead of the belt form, a drum form.

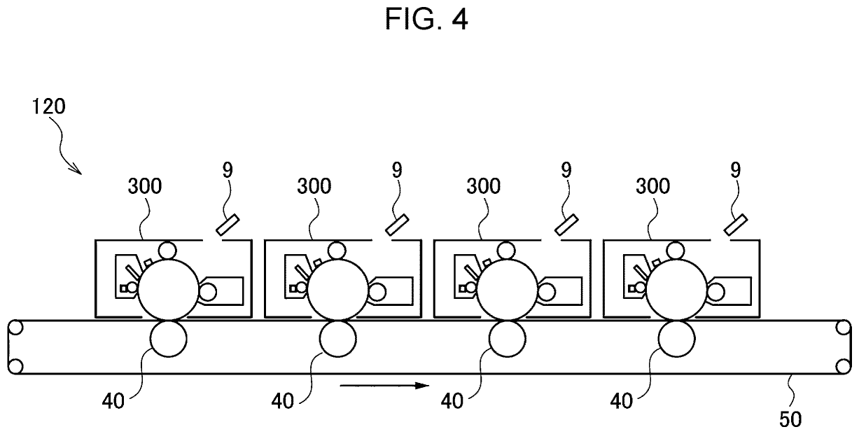

FIG. 4 is a schematic configuration view illustrating another example of the image forming apparatus according to the present disclosure.

FIG. 4 illustrates an image forming apparatus 120, which is a tandem-system multicolor image forming apparatus on which four process cartridges 300 are mounted. In the image forming apparatus 120, the four process cartridges 300 are disposed in parallel on the intermediate transfer body 50, and one electrophotographic photoreceptor is used for each color. The image forming apparatus 120 has the same configuration as the image forming apparatus 100 except that it employs the tandem system.

### EXAMPLES

Hereinafter, exemplary embodiments of the present disclosure will be described in detail with reference to Examples; however, exemplary embodiments of the present disclosure are not limited to these Examples.

In the descriptions below, “part” and “%” are based on mass unless otherwise specified.

In the descriptions below, synthesis, production, treatment, measurement, and the like are performed at room temperature (25° C.±3° C.) unless otherwise specified.

### Preparation of Polyarylate Resins

Polyarylate resins (PA1) to (PA11) are synthesized.

Table 1 describes the constitutional units and compositions of the polyarylate resins.

In Table 1, A2-3 and the like are specific examples of the above-described dicarboxylic unit (A).

In Table 1, B1-2 and the like are specific examples of the above-described diol unit (B).

In Table 1, the symbols “−” indicate that the corresponding materials are not contained.

In Table 1, the unit “k” of weight-average molecular weight (Mw) represents kilo, that is, 1000.

TABLE 1

| Polyarylate resin | Dicarboxylic unit (A) | | | | Diol unit (B) | | | | Mw |
|---|---|---|---|---|---|---|---|---|---|
| No. | No. | mol % | No. | mol % | No. | mol % | No. | mol % | k |
| PA1 | A2-3 | 50 | — | — | B1-2 | 50 | — | — | 110 |
| PA2 | A3-2 | 50 | — | — | B4-4 | 50 | — | — | 120 |
| PA3 | A3-2 | 25 | A4-3 | 25 | B4-6 | 50 | — | — | 115 |
| PA4 | A3-2 | 25 | A4-3 | 25 | B6-4 | 50 | — | — | 120 |
| PA5 | A3-2 | 25 | A4-3 | 25 | B4-4 | 50 | — | — | 125 |
| PA6 | A2-3 | 50 | — | — | B1-4 | 50 | — | — | 110 |
| PA7 | A3-2 | 50 | — | — | B3-4 | 50 | — | — | 120 |
| PA8 | A2-3 | 50 | — | — | B2-6 | 50 | — | — | 105 |
| PA9 | A2-3 | 50 | — | — | B5-5 | 50 | — | — | 105 |
| PA10 | A3-2 | 50 | — | — | B1-2 | 50 | — | — | 110 |
| PA11 | A1-1 | 25 | A1-7 | 25 | B4-3 | 50 | — | — | 115 |

### Preparation of Charge Transport Materials

As materials forming charge transport layers, in addition to the polyarylate resins, the following are prepared.
Charge transport material CTM-1
Charge transport material CTM-2
Charge transport material CTM-3
Charge transport material CTM-4
Charge transport material CTM-5

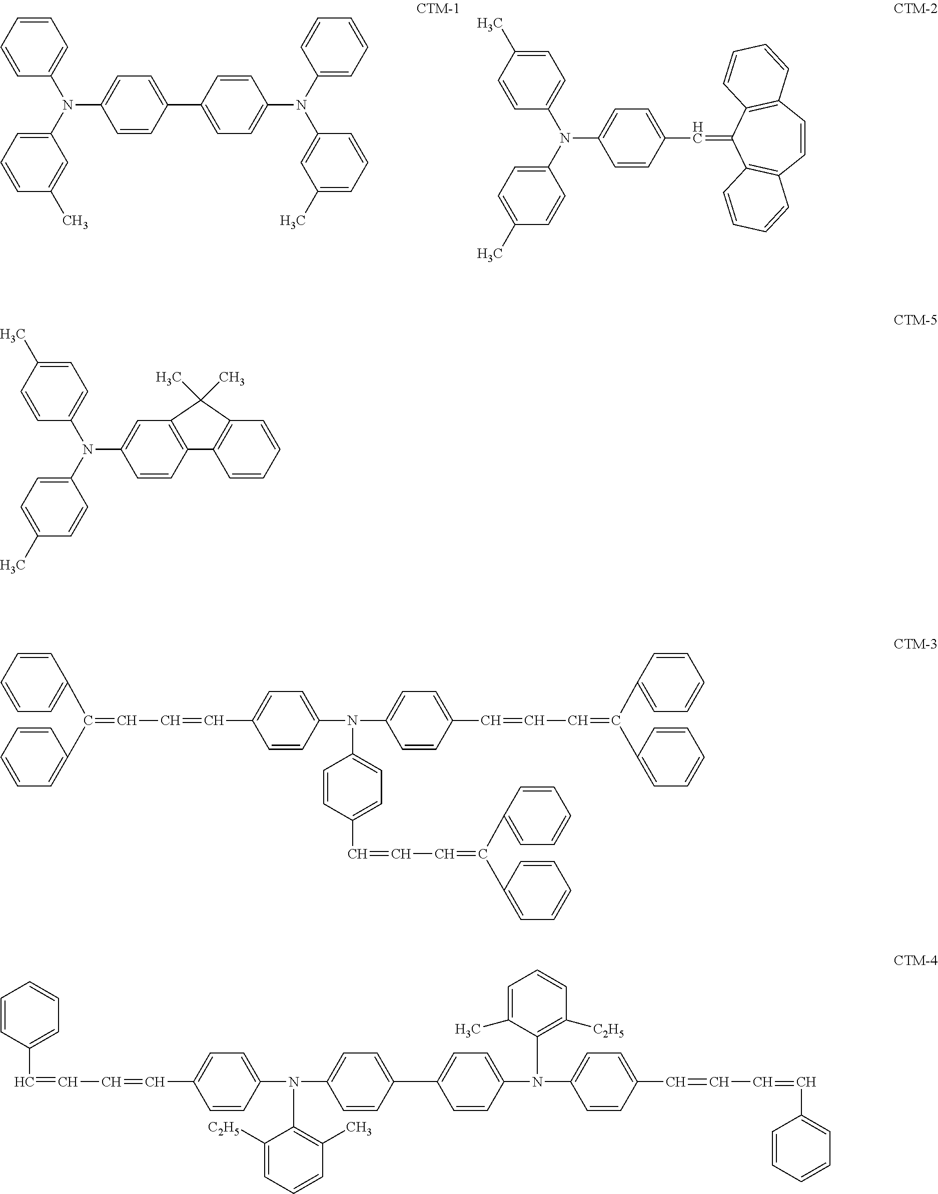 [SMILES: Cc1cccc(N(c2ccccc2)c2ccc(-c3ccc(N(c4ccccc4)c4cccc(C)c4)cc3)cc2)c1 ; Cc1ccc(N(c2ccc(C)cc2)c2ccc(C=C3c4ccccc4C=Cc4ccccc43)cc2)cc1 ; Cc1ccc(N(c2ccc(C)cc2)c2ccc3c(c2)C(C)(C)c2ccccc2-3)cc1 ; C(=Cc1ccc(N(c2ccc(C=CC=C(c3ccccc3)c3ccccc3)cc2)c2ccc(C=CC=C(c3ccccc3)c3ccccc3)cc2)cc1)C=C(c1ccccc1)c1ccccc1 ; CCc1cccc(C)c1N(c1ccc(C=CC=Cc2ccccc2)cc1)c1ccc(-c2ccc(N(c3ccc(C=CC=Cc4ccccc4)cc3)c3c(C)cccc3CC)cc2)cc1]

### Preparation of Polycarbonate Resins

Polycarbonate resin (PC1)
Polycarbonate resin (PC2)
Polycarbonate resin (PC3)
Polycarbonate resin (PC-C1)
Polycarbonate resin (PC-C2)

In the following Table, “Molar ratio” means the molar ratio of the constitutional unit 1 to the constitutional unit 2 (=constitutional unit 1/constitutional unit 2) in each of the polycarbonate resins.

| Polycarbonate resin | Constitutional unit 1 | Constitutional unit 2 | Molar ratio |
|---|---|---|---|
| PC1 | 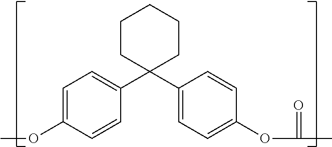 | 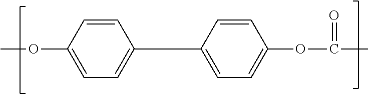 | 80/20 |
| PC2 | 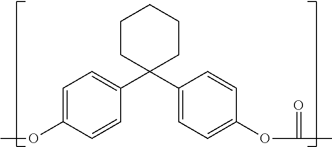 | 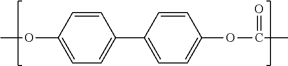 | 75/25 |
| PC3 | 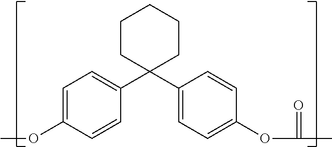 | 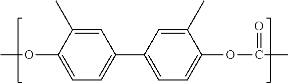 | 60/40 |
| PC-C1 | 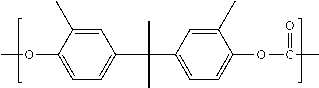 | 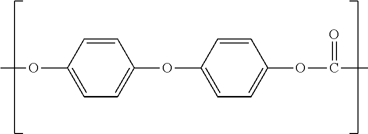 | 85/15 |
| PC-C2 | 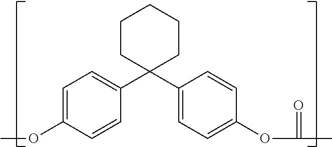 | | 100/0 |

### Preparation of Antioxidants.

Hindered phenol compound: AO-30: ADK STAB AO-30, ADEKA CORPORATION
Hindered phenol compound: AO-60: ADK STAB AO-60, ADEKA CORPORATION
Hindered phenol compound: AO-80: ADK STAB AO-80, ADEKA CORPORATION
Hindered phenol compound: AO-330: ADK STAB AO-330, ADEKA CORPORATION Preparation of undercoat layers

### Formation of Undercoat Layer 1

A resol-type phenol resin (thermosetting resin, PL-2215, manufactured by Gun Ei Chemical Industry Co., Ltd., 15 parts by mass) and 5.0 parts by mass of a butyral resin (S-LEC BL-1, manufactured by SEKISUI CHEMICAL CO., LTD.) are dissolved in 120 parts by mass of methyl ethyl ketone and 60 parts by mass of isopropanol; to the resultant solution, 30 parts by mass of the electron transport material (P−1) is added and dispersed using 1 mmΦ glass beads in a sand mill for 300 minutes, to obtain a dispersion liquid.

The glass beads are filtered off; to the resultant dispersion liquid, 0.003 parts by mass of blocked sulfonic acid (Nacure 2500) manufactured by King Industries, Inc. is added as a catalyst, to obtain an undercoat layer-forming coating liquid. This coating liquid is applied onto a conductive substrate by a dip coating method and dried and cured at 150° C. for 60 minutes, to obtain an undercoat layer containing a phenol resin and the electron transport material represented by the general formula (P) and having a thickness of 10 μm.

### Formation of Undercoat Layer 2

The electron transport material (P−1) having a primary particle diameter of 1 μm (10 parts by mass), 10 parts by mass of sodium chloride, and 150 parts by mass of 0.3 mm zirconia beads are placed into a zirconia vessel, and pulverized using a planetary mill manufactured by FRITSCH GmbH at 500 rpm for 1 hour. The zirconia beads are filtered off using a polypropylene 50 μm mesh and washing with methanol is performed. The resultant crystals are repeatedly washed with distilled water and subsequently dried in a freeze dryer for 48 hours, to obtain 7.5 parts by mass of the electron transport material (P−1). This treatment is repeated four times, to obtain 30 parts by mass of the pulverized electron transport material (P−1) in total. In a SEM image of the material, 10 crystals randomly selected have an average primary particle diameter of 0.08 μm.

The obtained electron transport material (P−1) (30 parts by mass), 15 parts by mass of a diallyl phthalate prepolymer (DAISO DAP (registered trademark) A, manufactured by OSAKA GAS CO., LTD.), 5.0 parts by mass of trimethylolpropane trimethacrylate, and 170 ml of methyl ethyl ketone are mixed together, and subjected to a dispersion treatment using 1 mmΦ glass beads in a paint shaker for 180 minutes, to obtain a dispersion liquid. To the obtained dispersion liquid, 1.0 part by mass of PERBUTYL (registered trademark) Z (manufactured by NOF CORPORATION) serving as a polymerization initiator is added, to obtain an undercoat layer-forming coating liquid. This coating liquid is applied onto a conductive substrate by a dip coating method and dried and cured in a nitrogen atmosphere at 160° C. for 60 minutes, to obtain an undercoat layer having a thickness of 10 μm and containing a diallyl phthalate resin (thermosetting resin) and the electron transport material represented by the general formula (P).

### Formation of Undercoat Layer 3

A nylon polyamide (thermoplastic resin, CM8000, manufactured by Toray Industries, Inc.) (20 g), which is a copolymer of nylon and polyamide, is dissolved in 200 ml of methanol; to the resultant solution, 30 g of the electron transport material (P−1) pulverized as with the undercoat layer 2 is added, and subjected to a dispersion treatment using 1 mmΦ glass beads in a paint shaker for 180 minutes, to obtain a dispersion liquid. This coating liquid is applied onto a conductive substrate by a dip coating method, and dried in a nitrogen atmosphere at 150° C. for 45 minutes, to obtain an undercoat layer having a thickness of 10 μm and containing nylon polyamide and the electron transport material represented by the general formula (P).

### Formation of Undercoat Layer 4 to Undercoat Layer 10

The same procedures as in an undercoat layer 18 are performed except that, in the undercoat layer 18, the electron transport material (P−1) is replaced by an electron transport material in Table 2; in this way, undercoat layers are obtained.

### Formation of Undercoat Layer 11 and Undercoat Layer 14

The same procedures as in the undercoat layer 18 are performed except that, in the undercoat layer 18, the pulverization time for the electron transport material is adjusted so as to provide an average primary particle diameter in Table 2; in this way, undercoat layers are obtained.

### Formation of Undercoat Layer 12 and Undercoat Layer 13

The same procedures as in the undercoat layer 18 are performed except that, in the undercoat layer 18, the thickness of the undercoat layer is changed to a thickness in Table 2; in this way, undercoat layers are obtained.

### Formation of Undercoat Layer 15

The same procedures as in the undercoat layer 18 are performed except that, in the undercoat layer 18, the electron transport material (P−1) is replaced by the electron transport material (P−1) having a particle diameter of 1.20 μm and obtained by recrystallization in sulfuric acid, to obtain an undercoat layer.

### Formation of Undercoat Layer 16

A curable urethane resin (thermosetting resin, blocked isocyanate CORONATE BI-301, manufactured by Tosoh Corporation, solid content: 75%) (15 parts by mass) and 6.3 parts by mass of a butyral resin (S-LEC BL-S, manufactured by SEKISUI CHEMICAL CO., LTD.) are dissolved in 170 parts by mass of methyl ethyl ketone; to the resultant solution, 32 parts by mass of the electron transport material (P−1) and 5 parts by mass of zinc oxide fine particles (manufactured by TAYCA CORPORATION, average particle diameter: 75 nm, specific surface area: 14 m²/g) are added; the resultant mixture is subjected to a dispersion treatment using 1 mmΦ glass beads in a sand mill for 300 minutes, to obtain a dispersion liquid.

The glass beads are filtered off; to the resultant dispersion liquid, 0.005 parts by mass of bismuth carboxylate manufactured by King Industries, Inc. (K-KAT XK-640) is added as a catalyst, to obtain an undercoat layer-forming coating liquid. This coating liquid is applied onto a conductive substrate by a dip coating method and dried and cured at 160° C. for 60 minutes, to obtain an undercoat layer having a thickness of 10 μm and containing a cured urethane resin and the electron transport material represented by the general formula (P).

### Formation of Undercoat Layer 17

The same procedures as in the undercoat layer 18 are performed except that, in the undercoat layer 18, the content of the electron transport material (P−1) is changed to a content in Table 2 relative to the total solid content of the undercoat layer, to obtain an undercoat layer.

### Formation of Undercoat Layer 18

A curable urethane resin (thermosetting resin, blocked isocyanate CORONATE BI-301, manufactured by Tosoh Corporation, solid content: 75%) (15 parts by mass) and 6.3 parts by mass of a butyral resin (S-LEC BL-S, manufactured by SEKISUI CHEMICAL CO., LTD.) are dissolved in 170 parts by mass of methyl ethyl ketone; to the resultant solution, 32 parts by mass of the electron transport material (P−1) is added; the resultant mixture is subjected to a dispersion treatment using 1 mmΦ glass beads in a sand mill for 300 minutes, to obtain a dispersion liquid.

The glass beads are filtered off; to the resultant dispersion liquid, 0.005 parts by mass of bismuth carboxylate manufactured by King Industries, Inc. (K-KAT XK-640) is added as a catalyst, to obtain an undercoat layer-forming coating liquid. This coating liquid is applied onto a conductive substrate by a dip coating method, and dried and cured at 160° C. for 60 minutes, to obtain an undercoat layer having a thickness of 10 μm and containing a cured urethane resin and the electron transport material represented by the general formula (P).

### Formation of Undercoat Layer 19

The same procedures as in an undercoat layer 20 are performed except that, in the undercoat layer 20, the methylated benzoguanamine resin is replaced by a melamine resin (thermosetting resin, product name: MX-750, manufactured by SANWA Chemical Co., Ltd.), to obtain an undercoat layer.

### Formation of Undercoat Layer 20

A methylated benzoguanamine resin (thermosetting resin, BL-60, manufactured by SANWA Chemical Co., Ltd., solid content: 60%) (25 parts by mass) and 5 parts by mass of a methylated melamine (MW-390, manufactured by SANWA Chemical Co., Ltd.) are dissolved in 120 parts by mass of methyl ethyl ketone and 60 parts by mass of isopropanol; to the resultant solution, 30 parts by mass of the electron transport material (P−1) is added; the resultant mixture is subjected to a dispersion treatment using 1 mmΦ glass beads in a sand mill for 300 minutes, to obtain a dispersion liquid. The glass beads are filtered off; to the resultant dispersion liquid, 0.003 parts by mass of blocked sulfonic acid manufactured by King Industries, Inc. (Nacure 5225) is added as a catalyst, to obtain an undercoat layer-forming coating liquid. This coating liquid is applied onto a conductive substrate by a dip coating method, and dried and cured at 150° C. for 60 minutes, to obtain an undercoat layer having a thickness of 10 μm and containing a benzoguanamine resin and the electron transport material represented by the general formula (P).

### Formation of Comparative Undercoat Layer 1

The same procedures as in the undercoat layer 18 are performed except that, in the undercoat layer 18, the electron transport material (P−1) is replaced by the following imide compound (A), to form a comparative undercoat layer 1.

### Formation of Comparative Undercoat Layer 2

The same procedures as in the undercoat layer 18 are performed except that, in the undercoat layer 18, the electron transport material (P−1) is replaced by the following imide compound (B), to form a comparative undercoat layer 2.

### Formation of Comparative Undercoat Layer 3

The same procedures as in the undercoat layer 18 are performed except that, in the undercoat layer 18, the electron transport material (P−1) is replaced by the following imide compound (C), to form a comparative undercoat layer 3.

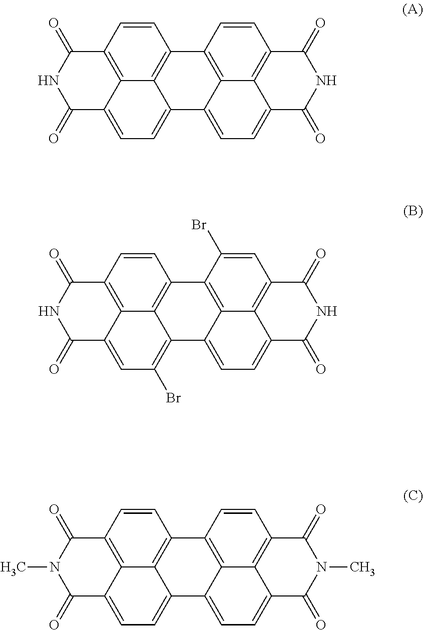

### Formation of Comparative Undercoat Layer 4

The same procedures as in the undercoat layer 18 are performed except that, in the undercoat layer 18, the electron transport material (P−1) is replaced by a mixture of the following perinone compound (1-1) and perinone compound (2-1) in a mass ratio of 50:50, to form a comparative undercoat layer 4.

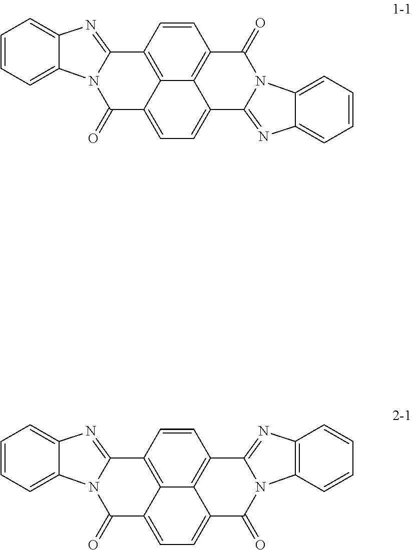 [SMILES: O=c1c2ccc3c4c(ccc(c24)c2nc4ccccc4n12)c(=O)n1c2ccccc2nc31 ; O=c1c2ccc3c(=O)n4c5ccccc5nc4c4ccc(c2c34)c2nc3ccccc3n12]

### Example 1 to Example 20, Example 34 to Example 37, and Example 41 to Example 43 Formation of Charge Generation Layers

A mixture composed of a charge generation material that is 15 parts of hydroxygallium phthalocyanine (having diffraction peaks at Bragg angles (20+) 0.2° of at least 7.5°, 9.9°, 12.5°, 16.3°, 18.6°, 25.1°, and 28.3° in an X-ray diffraction spectrum measured using CuKα characteristic X-rays), a binder resin that is 10 parts of a vinyl chloride-vinyl acetate copolymer resin (trade name: VMCH, Nippon Unicar Company Limited), and 200 parts of n-butyl acetate is dispersed using glass beads having a diameter of 1 mm in a sand mill for 4 hours. To the dispersion liquid, 175 parts of n-butyl acetate and 180 parts of methyl ethyl ketone are added, and the liquid is stirred to obtain a charge generation layer-forming coating liquid. The charge generation layer-forming coating liquid is applied onto an undercoat layer in Table 2 or Table 3 by dip coating and dried at room temperature; in this way, charge generation layers having a thickness of 0.25 μm of Examples are formed.

### Formation of Charge Transport Layers

Charge transport material: CTM-1:47 parts
Charge transport material: CTM-3:20 parts
Resin: polyarylate resin (a type in Table 2 or Table 3): 96 parts (corresponding to 100% of the total resin content)
Antioxidant: (a type in Table 2 or Table 3): 4.9 parts
Solvent: tetrahydrofuran: 570 parts
Solvent: toluene: 57 parts

The above-described materials are stirred and mixed to obtain a charge transport layer-forming coating liquid. The charge transport layer-forming coating liquid is applied onto the charge generation layer by dip coating and dried at 143° C. for 30 minutes, to form a charge transport layer having a layer thickness of 33 μm. In this way, photoreceptors are obtained.

### Example 21 to Example 23, Comparative Example 4, and Comparative Example 6

The same procedures as in Example 1 are performed except that the composition of the charge transport layer is changed as described below, to obtain photoreceptors.
Charge transport material: CTM-1:47 parts
Charge transport material: CTM-3:20 parts
Resin: polycarbonate resin (a type in Table 2 or Table 3): 96 parts (corresponding to 100% of the total resin content)
Antioxidant (a type in Table 2 or Table 3): 4.9 parts
Solvent: tetrahydrofuran: 570 parts
Solvent: toluene: 57 parts

### Example 24, Example 32, and Example 33

The same procedures as in Example 1 are performed except that the composition of the charge transport layer is changed as described below, to obtain photoreceptors.
Charge transport material: CTM-1:47 parts
Charge transport material: CTM-3:20 parts
Resin: polyarylate resin (PA1): 58 parts (corresponding to 60% of the total resin content)·
Resin: polycarbonate resin (a type in Table 2): 38 parts (corresponding to 40% of the total resin content)
Antioxidant (a type in Table 2): 4.9 parts
Solvent: tetrahydrofuran: 570 parts
Solvent: toluene: 57 parts

### Example 25

The same procedures as in Example 1 are performed except that the composition of the charge transport layer is changed as described below, to obtain a photoreceptor.
Charge transport material: CTM-1:47 parts
Resin: polyarylate resin (PA1): 28 parts (corresponding to 30% of the total resin content)
Resin: polycarbonate resin (PC2): 66 parts (corresponding to 70% of the total resin content)
Antioxidant (the type in Table 2): 4.9 parts
Solvent: tetrahydrofuran: 570 parts
Solvent: toluene: 57 parts

### Example 26 to Example 31

The same procedures as in Example 1 are performed except that the composition of the charge transport layer is changed as described below, to obtain photoreceptors.
Charge transport material: CTM-1:47 parts
Charge transport material: CTM-3:20 parts
Resin: polyarylate resin (a type in Table 2): 96 parts (corresponding to 100% of the total resin content)
Antioxidant (a type in Table 2): 4.9 parts
Solvent: tetrahydrofuran: 570 parts
Solvent: toluene: 57 parts

### Example 38 to Example 40

The same procedures as in Example 1 are performed except that the composition of the charge transport layer is changed as described below, to obtain photoreceptors.
Charge transport material: 67 parts in total (the ratio of CTM-1/a charge transport material described in Table 3 is set to a mass ratio described in Table 3)
Resin: polyarylate resin (PA1): 96 parts (corresponding to 100% of the total resin content)
Antioxidant (a type in Table 3): 4.9 parts
Solvent: tetrahydrofuran: 570 parts
Solvent: toluene: 57 parts

### Example 44

The same procedures as in Example 1 are performed except that the composition of the charge transport layer is changed as described below, to obtain a photoreceptor.
Charge transport material: CTM-1:47 parts
Charge transport material: CTM-3:20 parts
Resin: polyarylate resin (PA1): 77 parts (corresponding to 80% of the total resin content)
Resin: polycarbonate resin (the type in Table 3): 19 parts (corresponding to 20% of the total resin content)
Antioxidant (the type in Table 3): 4.9 parts
Solvent: tetrahydrofuran: 570 parts
Solvent: toluene: 57 parts

### Comparative Example 1 to Comparative Example 3 and Comparative Example 5

The same procedures as in Example 26 are performed except that the specification of the undercoat layer is changed as described in Table 3, to obtain comparative photoreceptors.

In Table 2 and Table 3, in the item [Polyarylate resin], “Ratio to (PA+PC)” refers to a mass ratio of the polyarylate resin to the total of the polyarylate resin and the polycarbonate resin.

In Table 2 and Table 3, in the item [Polycarbonate resin], “Ratio to (PA+PC)” refers to a mass ratio of the polycarbonate resin to the total of the polyarylate resin and the polycarbonate resin.

In Table 2 and Table 3, “Ratio to all constitutional units” refers to mol % of the biphenyl-containing constitutional unit represented by the formula (BP) to all constitutional units of the polycarbonate resin.

In Table 2 and Table 3, “Ratio of metal oxide” refers to the metal oxide content to the total solid content of the undercoat layer.

In Table 2 and Table 3, “Mass ratio in CTM” refers to mass ratios of a plurality of charge transport materials in a charge transport layer. For example, when a charge transport layer contains a single charge transport material alone, the mass ratio in CTM of the charge transport material is 100.

### Evaluation

Three types of evaluations described below are performed by simulation.

### Evaluation of Fluctuation in Charging Potential Due to Environmental Variations

The electrophotographic photoreceptor of each Example is mounted on an image forming apparatus ApeosC7070 (manufactured by FUJIFILM Business Innovation Corp.), and charging conditions are controlled such that the charging potential and the post-exposure potential before and after the print evaluation are −700 V and the post-exposure surface potential is −240 V at room temperature and room humidity (at a temperature of 25° C. and a relative humidity of 50%). A full-page halftone image with an image density of 30% is printed under low temperature/low humidity (at a temperature of 10° C. and a relative humidity of 15%) and high temperature/high humidity (at a temperature of 30° C. and a relative humidity of 85%) conditions, on A3-size paper, 20,000 sheets per run.

The charging potential and the post-exposure residual potential are measured by placing, on the photoreceptor, a probe connected to a surface electrometer (manufactured by TREK, INC., TREK 334), using the first printed sheet after printing 20,000 sheets under each of low temperature/low humidity conditions and high temperature/high humidity conditions.

The difference (V_{L1}−V_{H1}) between a charging potential V_{L1} under the low temperature/low humidity conditions and a charging potential V_{H1} under the high temperature/high humidity conditions is calculated and the absolute value thereof is evaluated on the basis of the following criteria.

### Evaluation Criteria

A: less than 25 V
B: 25 V or more and less than 35 V
C: 35 V or more and less than 45 V
D: 45 V or more and less than 55 V, which corresponds to a problematic level
E: 55 V or more, which corresponds to a problematic level

### Evaluation of Fluctuation in Post-Exposure Potential Due to Environmental Variations

In the above-described evaluation, the difference (V_{L2}−V_{H2}) between a post-exposure residual potential V_{L2} under low temperature/low humidity conditions and a post-exposure residual potential V_{H2} under high temperature/high humidity conditions is calculated and the absolute value thereof is evaluated on the basis of the following criteria.

### Evaluation Criteria

A: less than 25 V
B: 25 V or more and less than 35 V
C: 35 V or more and less than 45 V
D: 45 V or more and less than 55 V, which corresponds to a problematic level
E: 55 V or more, which corresponds to a problematic level

### Evaluation of Charge Retention Property Under Repeated Use

The electrophotographic photoreceptor of each Example is mounted on an image forming apparatus ApeosC7070 (manufactured by FUJIFILM Business Innovation Corp.), charging conditions and exposure conditions are controlled under conditions of a temperature of 30° C. and a relative humidity of 85% RH such that the charging potential and the post-exposure potential are −700 V and the post-exposure surface potential is −240 V before and after evaluation of printing, and a full-page halftone image with an image density of 30% is printed on A3-size paper, 100,000 sheets.

The charging potentials at the time of printing the first printed sheet and the first printed sheet after printing 100,000 printed sheets are measured by placing, on the photoreceptor, a probe connected to a surface electrometer (manufactured by TREK, INC., TREK 334). The difference (V1−V2) between a charging potential V1 at the time of printing the first printed sheet and a charging potential V2 at the time of printing 100,000 printed sheets is calculated and the absolute value thereof is evaluated on the basis of the following criteria.

### Evaluation Criteria

A: less than 20 V
B: 20 V or more and less than 30 V
C: 30 V or more and less than 40 V
D: 40 V or more and less than 50 V, which corresponds to a problematic level
E: 50 V or more, which corresponds to a problematic level

TABLE 2

| | | Charge transport layer | | | | | | | | | |
|---|---|---|---|---|---|---|---|---|---|---|---|
| | | Polyarylate resin | | Polycarbonate resin | | | | | | | |
| | | | Ratio | | Ratio | | Charge transport material | | | | |
| | | | to | | to | Ratio to all | | Mass | | Mass | |
| | | | (PA + | | (PA + | constitutional | | ratio | | ratio | Antioxidant |
| | Type of | Type | PC) | Type | PC) | units | Type | in CTM | Type | in CTM | Type |
| | undercoat layer | No. | mass % | No. | mass % | mass % | No. | mass % | No. | mass % | — |
| Example 1 | Undercoat layer 1 | PA1 | 100 | — | 0 | — | CTM-1 | 70 | CTM-3 | 30 | AO-80 |
| Example 2 | Undercoat layer 2 | PA1 | 100 | — | 0 | — | CTM-1 | 70 | CTM-3 | 30 | AO-80 |
| Example 3 | Undercoat layer 3 | PA1 | 100 | — | 0 | — | CTM-1 | 70 | CTM-3 | 30 | AO-80 |
| Example 4 | Undercoat layer 4 | PA1 | 100 | — | 0 | — | CTM-1 | 70 | CTM-3 | 30 | AO-80 |
| Example 5 | Undercoat layer 5 | PA1 | 100 | — | 0 | — | CTM-1 | 70 | CTM-3 | 30 | AO-80 |
| Example 6 | Undercoat layer 6 | PA1 | 100 | — | 0 | — | CTM-1 | 70 | CTM-3 | 30 | AO-80 |
| Example 7 | Undercoat layer 7 | PA1 | 100 | — | 0 | — | CTM-1 | 70 | CTM-3 | 30 | AO-80 |
| Example 8 | Undercoat layer 8 | PA1 | 100 | — | 0 | — | CTM-1 | 70 | CTM-3 | 30 | AO-80 |
| Example 9 | Undercoat layer 9 | PA1 | 100 | — | 0 | — | CTM-1 | 70 | CTM-3 | 30 | AO-80 |
| Example 10 | Undercoat layer 10 | PA1 | 100 | — | 0 | — | CTM-1 | 70 | CTM-3 | 30 | AO-80 |
| Example 11 | Undercoat layer 11 | PA1 | 100 | — | 0 | — | CTM-1 | 70 | CTM-3 | 30 | AO-80 |
| Example 12 | Undercoat layer 12 | PA1 | 100 | — | 0 | — | CTM-1 | 70 | CTM-3 | 30 | AO-80 |
| Example 13 | Undercoat layer 13 | PA1 | 100 | — | 0 | — | CTM-1 | 70 | CTM-3 | 30 | AO-80 |
| Example 14 | Undercoat layer 14 | PA1 | 100 | — | 0 | — | CTM-1 | 70 | CTM-3 | 30 | AO-80 |
| Example 15 | Undercoat layer 15 | PA1 | 100 | — | 0 | — | CTM-1 | 70 | CTM-3 | 30 | AO-80 |
| Example 16 | Undercoat layer 16 | PA1 | 100 | — | 0 | — | CTM-1 | 70 | CTM-3 | 30 | AO-80 |
| Example 17 | Undercoat layer 17 | PA1 | 100 | — | 0 | — | CTM-1 | 70 | CTM-3 | 30 | AO-80 |
| Example 18 | Undercoat layer 18 | PA1 | 100 | — | 0 | — | CTM-1 | 70 | CTM-3 | 30 | AO-80 |
| Example 19 | Undercoat layer 19 | PA1 | 100 | — | 0 | — | CTM-1 | 70 | CTM-3 | 30 | AO-80 |
| Example 20 | Undercoat layer 20 | PA1 | 100 | — | 0 | — | CTM-1 | 70 | CTM-3 | 30 | AO-80 |
| Example 21 | Undercoat layer 18 | — | 0 | PC1 | 100 | 20 | CTM-1 | 70 | CTM-3 | 30 | AO-80 |
| Example 22 | | — | 0 | PC2 | 100 | 25 | CTM-1 | 70 | CTM-3 | 30 | AO-80 |
| Example 23 | | — | 0 | PC3 | 100 | 40 | CTM-1 | 70 | CTM-3 | 30 | AO-80 |
| Example 24 | | PA1 | 60 | PC2 | 40 | 25 | CTM-1 | 70 | CTM-3 | 30 | AO-80 |
| Example 25 | | PA1 | 30 | PC2 | 70 | 25 | CTM-1 | 100 | — | 0 | AO-80 |
| Example 26 | | PA2 | 100 | — | 0 | — | CTM-1 | 70 | CTM-3 | 30 | AO-80 |
| Example 27 | | PA3 | 100 | — | 0 | — | CTM-1 | 70 | CTM-3 | 30 | AO-80 |
| Example 28 | | PA4 | 100 | — | 0 | — | CTM-1 | 70 | CTM-3 | 30 | AO-80 |
| Example 29 | | PA5 | 100 | — | 0 | — | CTM-1 | 70 | CTM-3 | 30 | AO-80 |
| Example 30 | | PA6 | 100 | — | 0 | — | CTM-1 | 70 | CTM-3 | 30 | AO-80 |
| Example 31 | | PA7 | 100 | — | 0 | — | CTM-1 | 70 | CTM-3 | 30 | AO-80 |
| Example 32 | | PA1 | 60 | PC1 | 40 | 20 | CTM-1 | 70 | CTM-3 | 30 | AO-80 |
| Example 33 | | PA1 | 60 | PC3 | 40 | 40 | CTM-1 | 70 | CTM-3 | 30 | AO-80 |

| | | | | | | | | Evaluation | | |
|---|---|---|---|---|---|---|---|---|---|---|
| | Undercoat layer | | | | | | | Suppression | Suppression of | |
| | | Electron transport material | | | | | | of fluctuation | fluctuation in | Charge |
| | | | | Average | | | Ratio | in charging | post-exposure | retention |
| | | | | primary | | | of | potential | potential | property |
| | Binder resin | | | particle | Aspect | | metal | due to | due to | after |
| | Type | Type | Content | diameter | ratio | Thickness | oxide | environmental | environmental | repeated |
| | — | — | mass % | μm | — | μm | mass % | variations | variations | printing |
| Example 1 | Phenol resin | P-1 | 65 | 0.15 | 3.1 | 10 | 0 | B | B | B |
| Example 2 | Diallyl phthalate resin | P-1 | 59 | 0.08 | 1.5 | 10 | 0 | B | B | B |
| Example 3 | Nylon polyamide | P-1 | 60 | 0.15 | 3.1 | 10 | 0 | C | C | C |
| Example 4 | Urethane resin | P-3 | 65 | 0.15 | 3.1 | 10 | 0 | B | A | A |
| Example 5 | Urethane resin | P-8 | 65 | 0.15 | 3.1 | 10 | 0 | B | A | A |
| Example 6 | Urethane resin | P-9 | 65 | 0.40 | 2.2 | 10 | 0 | C | A | B |
| Example 7 | Urethane resin | P-10 | 65 | 0.21 | 1.7 | 10 | 0 | C | A | B |
| Example 8 | Urethane resin | P-16 | 65 | 0.18 | 4.0 | 10 | 0 | C | B | C |
| Example 9 | Urethane resin | P-12 | 65 | 0.10 | 2.8 | 10 | 0 | C | B | C |
| Example 10 | Urethane resin | P-15 | 65 | 0.50 | 1.8 | 10 | 0 | C | B | C |
| Example 11 | Urethane resin | P-1 | 65 | 0.02 | 1.3 | 10 | 0 | B | B | A |
| Example 12 | Urethane resin | P-1 | 65 | 0.15 | 3.1 | 18 | 0 | C | C | C |
| Example 13 | Urethane resin | P-1 | 65 | 0.15 | 3.1 | 4 | 0 | B | B | B |
| Example 14 | Urethane resin | P-1 | 65 | 0.01 | 1.1 | 10 | 0 | C | C | C |
| Example 15 | Urethane resin | P-1 | 59 | 1.20 | 4.0 | 10 | 0 | C | C | C |
| Example 16 | Urethane resin | P-1 | 59 | 0.15 | 3.1 | 10 | 9.2 | B | B | B |
| Example 17 | Urethane resin | P-1 | 72 | 0.15 | 3.1 | 10 | 0 | B | B | B |
| Example 18 | Urethane resin | P-1 | 65 | 0.15 | 3.1 | 10 | 0 | A | A | A |
| Example 19 | Melamine resin | P-1 | 60 | 0.15 | 2.6 | 10 | 0 | A | A | A |
| Example 20 | Benzoguanamine resin | P-1 | 60 | 0.15 | 3.1 | 10 | 0 | A | A | A |
| Example 21 | Urethane resin | P-1 | 65 | 0.15 | 3.1 | 10 | 0 | A | B | B |
| Example 22 | Urethane resin | P-1 | 65 | 0.15 | 3.1 | 10 | 0 | A | B | A |
| Example 23 | Urethane resin | P-1 | 65 | 0.15 | 3.1 | 10 | 0 | A | A | A |
| Example 24 | Urethane resin | P-1 | 65 | 0.15 | 3.1 | 10 | 0 | A | A | A |
| Example 25 | Urethane resin | P-1 | 65 | 0.15 | 3.1 | 10 | 0 | A | A | A |
| Example 26 | Urethane resin | P-1 | 65 | 0.15 | 3.1 | 10 | 0 | C | C | B |
| Example 27 | Urethane resin | P-1 | 65 | 0.15 | 3.1 | 10 | 0 | C | C | B |
| Example 28 | Urethane resin | P-1 | 65 | 0.15 | 3.1 | 10 | 0 | B | B | A |
| Example 29 | Urethane resin | P-1 | 65 | 0.15 | 3.1 | 10 | 0 | C | C | B |
| Example 30 | Urethane resin | P-1 | 65 | 0.15 | 3.1 | 10 | 0 | A | A | A |
| Example 31 | Urethane resin | P-1 | 65 | 0.15 | 3.1 | 10 | 0 | C | C | C |
| Example 32 | Urethane resin | P-1 | 65 | 0.15 | 3.1 | 10 | 0 | A | A | A |
| Example 33 | Urethane resin | P-1 | 65 | 0.15 | 3.1 | 10 | 0 | A | A | A |

TABLE 3

| | | Charge transport layer | | | | | | | | | |
|---|---|---|---|---|---|---|---|---|---|---|---|
| | | | | Polycarbonate resin | | | Charge transport material | | | | |
| | | Polyarylate resin | | | Ratio | Ratio to all | | Mass | | Mass | |
| | | | Ratio to | | to (PA + | constitutional | | ratio | | ratio | Antioxidant |
| | Type of | Type | (PA + PC) | Type | PC) | units | Type | in CTM | Type | in CTM | Type |
| | undercoat layer | No. | mass % | No. | mass % | mass % | No. | mass % | No. | mass % | — |
| Comparative | Comparative | PA2 | 100 | — | 0 | — | CTM-1 | 70 | CTM-3 | 30 | AO-80 |
| Example 1 | undercoat layer 1 | | | | | | | | | | |
| Comparative | Comparative | PA2 | 100 | — | 0 | — | CTM-1 | 70 | CTM-3 | 30 | AO-80 |
| Example 2 | undercoat layer 2 | | | | | | | | | | |
| Comparative | Comparative | PA2 | 100 | — | 0 | — | CTM-1 | 70 | CTM-3 | 30 | AO-80 |
| Example 3 | undercoat layer 3 | | | | | | | | | | |
| Comparative | Undercoat layer 1 | — | 0 | PC-C1 | 100 | 15 | CTM-1 | 70 | CTM-3 | 30 | AO-80 |
| Example 4 | | | | | | | | | | | |
| Comparative | Comparative | PA2 | 100 | — | 0 | — | CTM-1 | 70 | CTM-3 | 30 | AO-80 |
| Example 5 | undercoat layer 4 | | | | | | | | | | |
| Comparative | Undercoat layer 1 | — | 0 | PC-C2 | 100 | 0 | CTM-1 | 70 | CTM-3 | 30 | AO-80 |
| Example 6 | | | | | | | | | | | |
| Example 34 | Undercoat layer 18 | PA8 | 100 | — | 0 | — | CTM-1 | 70 | CTM-3 | 30 | AO-80 |
| Example 35 | | PA9 | 100 | — | 0 | — | CTM-1 | 70 | CTM-3 | 30 | AO-80 |
| Example 36 | | PA10 | 100 | — | 0 | — | CTM-1 | 70 | CTM-3 | 30 | AO-80 |
| Example 37 | | PA11 | 100 | — | 0 | — | CTM-1 | 70 | CTM-3 | 30 | AO-80 |
| Example 38 | | PA1 | 100 | — | 0 | — | CTM-1 | 65 | CTM-2 | 35 | AO-80 |
| Example 39 | | PA1 | 100 | — | 0 | — | CTM-1 | 75 | CTM-4 | 25 | AO-80 |
| Example 40 | | PA1 | 100 | — | 0 | — | CTM-1 | 65 | CTM-5 | 35 | AO-80 |
| Example 41 | | PA1 | 100 | — | 0 | — | CTM-1 | 70 | CTM-3 | 30 | AO-30 |
| Example 42 | | PA1 | 100 | — | 0 | — | CTM-1 | 70 | CTM-3 | 30 | AO-60 |
| Example 43 | | PA1 | 100 | — | 0 | — | CTM-1 | 70 | CTM-3 | 30 | AO-330 |
| Example 44 | | PA1 | 80 | PC-C2 | 20 | 0 | CTM-1 | 70 | CTM-3 | 30 | AO-80 |

| | | | | | | | | Evaluation | | |
|---|---|---|---|---|---|---|---|---|---|---|
| | Undercoat layer | | | | | | | Suppression | Suppression of | |
| | | Electron transport material | | | | | | of fluctuation | fluctuation in | Charge |
| | | | | Average | | | Ratio | in charging | post-exposure | retention |
| | | | | primary | | | of | potential | potential | property |
| | Binder resin | | | particle | Aspect | | metal | due to | due to | after |
| | Type | Type | Content | diameter | ratio | Thickness | oxide | environmental | environmental | repeated |
| | — | — | mass % | μm | — | μm | mass % | variations | variations | printing |
| Comparative | Urethane resin | (A) | 65 | 0.15 | 3.3 | 10 | 0 | E | D | E |
| Example 1 | | | | | | | | | | |
| Comparative | Urethane resin | (B) | 65 | 0.17 | 2.0 | 10 | 0 | E | D | E |
| Example 2 | | | | | | | | | | |
| Comparative | Urethane resin | (C) | 65 | 0.20 | 1.5 | 10 | 0 | E | D | E |
| Example 3 | | | | | | | | | | |
| Comparative | Urethane resin | P-3 | 65 | 0.15 | 3.1 | 10 | 0 | E | E | B |
| Example 4 | | | | | | | | | | |
| Comparative | Urethane resin | (1-1) | 65 | 0.6 | 1.8 | 10 | 0 | E | D | B |
| Example 5 | | (2-1) | | | | | | | | |
| Comparative | Urethane resin | P-3 | 65 | 0.15 | 3.1 | 10 | 0 | E | E | E |
| Example 6 | | | | | | | | | | |
| Example 34 | Urethane resin | P-1 | 65 | 0.15 | 3.1 | 10 | 0 | A | A | A |
| Example 35 | Urethane resin | P-1 | 65 | 0.15 | 3.1 | 10 | 0 | B | A | B |
| Example 36 | Urethane resin | P-1 | 65 | 0.15 | 3.1 | 10 | 0 | A | A | B |
| Example 37 | Urethane resin | P-1 | 65 | 0.15 | 3.1 | 10 | 0 | C | C | C |
| Example 38 | Urethane resin | P-1 | 65 | 0.15 | 3.1 | 10 | 0 | A | B | A |
| Example 39 | Urethane resin | P-1 | 65 | 0.15 | 3.1 | 10 | 0 | A | A | A |
| Example 40 | Urethane resin | P-1 | 65 | 0.15 | 3.1 | 10 | 0 | A | B | A |
| Example 41 | Urethane resin | P-1 | 65 | 0.15 | 3.1 | 10 | 0 | A | A | A |
| Example 42 | Urethane resin | P-1 | 65 | 0.15 | 3.1 | 10 | 0 | A | A | A |
| Example 43 | Urethane resin | P-1 | 65 | 0.15 | 3.1 | 10 | 0 | A | A | A |
| Example 44 | Urethane resin | P-1 | 65 | 0.15 | 3.1 | 10 | 0 | B | B | B |

As shown in Table 2 and Table 3, the photoreceptors of Examples are, compared with the photoreceptors of Comparative Examples, expected to considerably suppress fluctuation in the charging potential due to environmental variations. In addition, the photoreceptors of Examples are, compared with the photoreceptors of Comparative Examples, expected to have a high charge retention property upon repeated image formation.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

(((1))) An electrophotographic photoreceptor comprising:
a conductive substrate;
an undercoat layer that is disposed on the conductive substrate and contains a binder resin and an electron transport material represented by a general formula (P) below; and
a photosensitive layer that is disposed on the undercoat layer and contains at least one resin of a polyarylate resin containing a dicarboxylic unit represented by a formula (A) below and a diol unit represented by a formula (B) below and a polycarbonate resin containing a biphenyl-containing constitutional unit represented by a formula (BP) below in an amount of more than 15 mol % relative to all constitutional units,

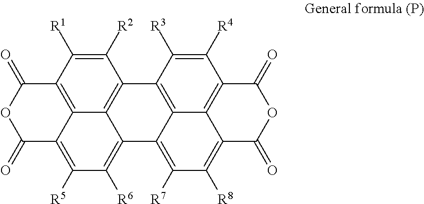

wherein in the general formula (P), R¹, R², R³, R⁴, R⁵, R⁶, R⁷, and R⁸ each independently represent a hydrogen atom, an alkyl group, an alkoxy group, an aralkyl group, an aryl group, an alkoxycarbonyl group, or a halogen atom,

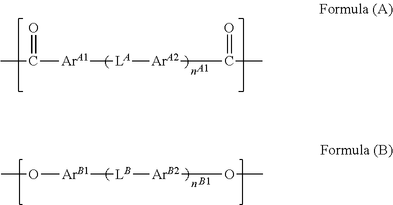

in the formula (A), Ar^{A1} and Ar^{A2} are each independently an aromatic ring that may have a substituent, L^{A} is a single bond or a divalent linking group, n^{A1} is 0, 1, or 2,
in the formula (B), Ar^{B1} and Ar^{B2} are each independently an aromatic ring that may have a substituent, L^{B} is a single bond, an oxygen atom, a sulfur atom, or —C(Rb¹)(Rb²)—, n^{B1} is 0, 1, or 2, Rb¹ and Rb² are each independently a hydrogen atom, an alkyl group having 1 or more and 20 or less carbon atoms, an aryl group having 6 or more and 12 or less carbon atoms, or an aralkyl group having 7 or more and 20 or less carbon atoms, Rb¹ and Rb² may be bonded together to form a cyclic alkyl group,

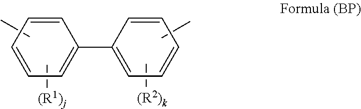

in the formula (BP), j is an integer of 0 or more and 4 or less, j R¹'s are each independently a methyl group or an ethyl group, k is an integer of 0 or more and 4 or less, and k R²'s are each independently a methyl group or an ethyl group.
   (((2))) The electrophotographic photoreceptor according to (((1))), wherein in the general formula (P), R¹, R², R³, R⁴, R⁵, R⁶, R⁷, and R⁸ each independently represent a hydrogen atom or a halogen atom.
   (((3))) The electrophotographic photoreceptor according to (((2))), wherein in the general formula (P), R¹, R², R³, R⁴, R⁵, R⁶, R⁷, and R⁸ represent a hydrogen atom.
   (((4))) The electrophotographic photoreceptor according to any one of (((1))) to (((3))), wherein the electron transport material has an average primary particle diameter of 1.00 μm or less.
   (((5))) The electrophotographic photoreceptor according to (((4))), wherein the electron transport material has an average primary particle diameter of 0.03 μm or more and 1.00 μm or less.
   (((6))) The electrophotographic photoreceptor according to any one of (((1) to (5))), wherein a content of the electron transport material relative to a total solid content of the undercoat layer is less than 70 mass %.
   (((7))) The electrophotographic photoreceptor according to any one of (((1))) to (((6))), wherein the undercoat layer has a thickness of 5 μm or more and 15 μm or less.
   (((8))) The electrophotographic photoreceptor according to any one of (((1))) to (((7))), wherein the binder resin is a thermosetting resin.
   (((9))) The electrophotographic photoreceptor according to (((8))), wherein the thermosetting resin contains at least one resin selected from the group consisting of a urethane resin, a melamine resin, and a benzoguanamine resin.
   (((10))) The electrophotographic photoreceptor according to any one of (((1))) to (((9))), wherein the undercoat layer contains a metal oxide, and
a content of the metal oxide relative to a total solid content of the undercoat layer is 5 mass % or less.
   (((11))) The electrophotographic photoreceptor according to any one of (((1))) to (((10))), wherein the dicarboxylic unit represented by the formula (A) includes at least one selected from the group consisting of a dicarboxylic unit (A1) represented by a formula (A1) below, a dicarboxylic unit (A2) represented by a formula (A2) below, a dicarboxylic unit (A3) represented by a formula (A3) below, a dicarboxylic unit (A4) represented by a formula (A4) below, and a dicarboxylic unit (A5) represented by a formula (A5) below:

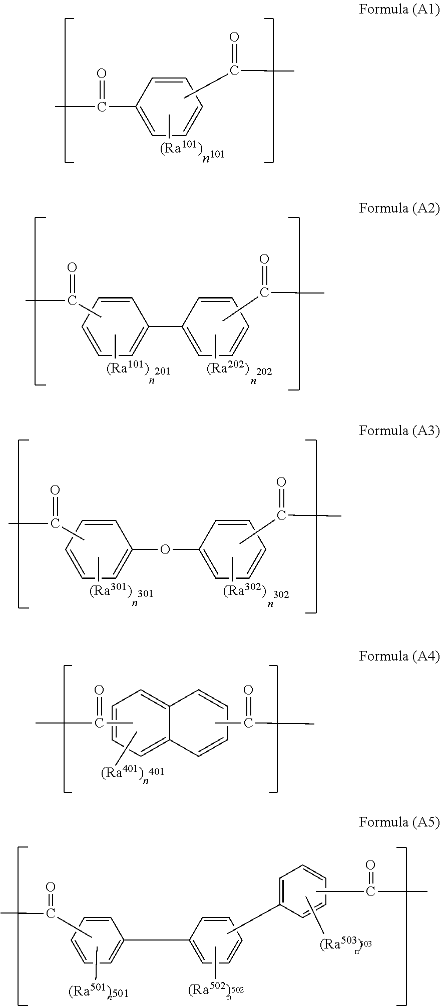

in the formula (A1), n¹⁰¹ is an integer of 0 or more and 4 or less, n¹⁰¹ Ra¹⁰¹'s are each independently an alkyl group having 1 or more and 10 or less carbon atoms, an aryl group having 6 or more and 12 or less carbon atoms, or an alkoxy group having 1 or more and 6 or less carbon atoms,
in the formula (A2), n²⁰¹ and n²⁰² are each independently an integer of 0 or more and 4 or less, n²⁰¹ Ra²⁰¹'s and n²⁰² Ra²⁰²'s are each independently an alkyl group having 1 or more and 10 or less carbon atoms, an aryl group having 6 or more and 12 or less carbon atoms, or an alkoxy group having 1 or more and 6 or less carbon atoms,
in the formula (A3), n³⁰¹ and n³⁰² are each independently an integer of 0 or more and 4 or less, n³⁰¹ Ra³⁰¹'s and n³⁰² Ra³⁰²'s are each independently an alkyl group having 1 or more and 10 or less carbon atoms, an aryl group having 6 or more and 12 or less carbon atoms, or an alkoxy group having 1 or more and 6 or less carbon atoms,
in the formula (A4), n⁴⁰¹ is an integer of 0 or more and 6 or less, n⁴⁰¹ Ra⁴⁰¹'s are each independently an alkyl group having 1 or more and 10 or less carbon atoms, an aryl group having 6 or more and 12 or less carbon atoms, or an alkoxy group having 1 or more and 6 or less carbon atoms, and
in the formula (A5), n⁵⁰¹, n⁵⁰², and n⁵⁰³ are each independently an integer of 0 or more and 4 or less, n⁵⁰¹ Ra⁵⁰¹'s, n⁵⁰² Ra⁵⁰²'s, and n⁵⁰³ Ra⁵⁰³'s are each independently an alkyl group having 1 or more and 10 or less carbon atoms, an aryl group having 6 or more and 12 or less carbon atoms, or an alkoxy group having 1 or more and 6 or less carbon atoms.
   (((12))) The electrophotographic photoreceptor according to any one of (((1))) to (((11))), wherein the diol unit represented by the formula (B) includes at least one selected from the group consisting of a diol unit (B1) represented by a formula (B1) below, a diol unit (B2) represented by a formula (B2) below, a diol unit (B3) represented by a formula (B3) below, a diol unit (B4) represented by a formula (B4) below, a diol unit (B5) represented by a formula (B5) below, a diol unit (B6) represented by a formula (B6) below, a diol unit (B7) represented by a formula (B7) below, and a diol unit (B8) represented by a formula (B8) below:

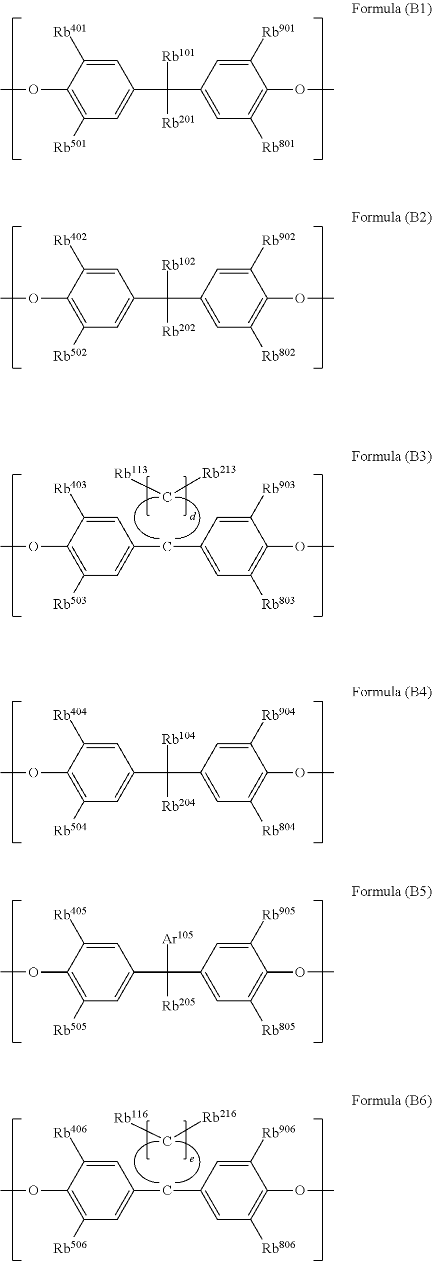

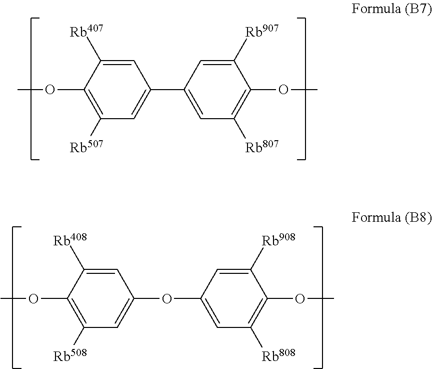

in the formula (B1), Rb¹⁰¹ is a branched alkyl group having 4 or more and 20 or less carbon atoms, Rb²⁰¹ is a hydrogen atom or an alkyl group having 1 or more and 3 or less carbon atoms, Rb⁴⁰¹, Rb⁵⁰¹, Rb⁸⁰¹, and Rb⁹⁰¹ are each independently a hydrogen atom, an alkyl group having 1 or more and 4 or less carbon atoms, an alkoxy group having 1 or more and 6 or less carbon atoms, or a halogen atom,
in the formula (B2), Rb¹⁰² is a linear alkyl group having 4 or more and 20 or less carbon atoms, Rb²⁰² is a hydrogen atom or an alkyl group having 1 or more and 3 or less carbon atoms, Rb⁴⁰², Rb⁵⁰², Rb⁸⁰², and Rb⁹⁰² are each independently a hydrogen atom, an alkyl group having 1 or more and 4 or less carbon atoms, an alkoxy group having 1 or more and 6 or less carbon atoms, or a halogen atom,
in the formula (B3), Rb¹¹³ and Rb²¹³ are each independently a hydrogen atom, a linear alkyl group having 1 or more and 3 or less carbon atoms, an alkoxy group having 1 or more and 4 or less carbon atoms, or a halogen atom, d is an integer of 7 or more and 15 or less, Rb⁴⁰³, Rb⁵⁰³, Rb⁸⁰³, and Rb⁹⁰³ are each independently a hydrogen atom, an alkyl group having 1 or more and 4 or less carbon atoms, an alkoxy group having 1 or more and 6 or less carbon atoms, or a halogen atom,
in the formula (B4), Rb¹⁰⁴ and Rb²⁰⁴ are each independently a hydrogen atom or an alkyl group having 1 or more and 3 or less carbon atoms, Rb⁴⁰⁴, Rb⁵⁰⁴, Rb⁸⁰⁴, and Rb⁹⁰⁴ are each independently a hydrogen atom, an alkyl group having 1 or more and 4 or less carbon atoms, an alkoxy group having 1 or more and 6 or less carbon atoms, or a halogen atom,
in the formula (B5), Ar¹⁰⁵ is an aryl group having 6 or more and 12 or less carbon atoms or an aralkyl group having 7 or more and 20 or less carbon atoms, Rb²⁰⁵ is a hydrogen atom or an alkyl group having 1 or more and 3 or less carbon atoms, Rb⁴⁰⁵, Rb⁵⁰⁵, Rb⁸⁰⁵, and Rb⁹⁰⁵ are each independently a hydrogen atom, an alkyl group having 1 or more and 4 or less carbon atoms, an alkoxy group having 1 or more and 6 or less carbon atoms, or a halogen atom,
in the formula (B6), Rb¹¹⁶ and Rb²¹⁶ are each independently a hydrogen atom, a linear alkyl group having 1 or more and 3 or less carbon atoms, an alkoxy group having 1 or more and 4 or less carbon atoms, or a halogen atom, e is an integer of 4 or more and 6 or less, Rb⁴⁰⁶ Rb⁵⁰⁶, Rb⁸⁰⁶, and Rb⁹⁰⁶ are each independently a hydrogen atom, an alkyl group having 1 or more and 4 or less carbon atoms, an alkoxy group having 1 or more and 6 or less carbon atoms, or a halogen atom,
in the formula (B7), Rb⁴⁰⁷, Rb⁵⁰⁷, Rb⁸⁰⁷, and Rb⁹⁰⁷ are each independently a hydrogen atom, an alkyl group having 1 or more and 4 or less carbon atoms, an alkoxy group having 1 or more and 6 or less carbon atoms, or a halogen atom, and in the formula (B8), Rb⁴⁰⁸, Rb⁵⁰⁸, Rb⁸⁰⁸, and Rb⁹⁰⁸ are each independently a hydrogen atom, an alkyl group having 1 or more and 4 or less carbon atoms, an alkoxy group having 1 or more and 6 or less carbon atoms, or a halogen atom.
   (((13))) The electrophotographic photoreceptor according to any one of (((1))) to (((12))), wherein the photosensitive layer contains the polyarylate resin and the polycarbonate resin.
   (((14))) The electrophotographic photoreceptor according to (((13))), wherein the polyarylate resin and the polycarbonate resin each contain a biphenyl-containing constitutional unit represented by a formula (BP) below:

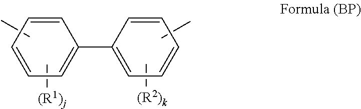

in the formula (BP), j is an integer of 0 or more and 4 or less, j R¹'s are each independently a methyl group or an ethyl group, k is an integer of 0 or more and 4 or less, and k R²'s are each independently a methyl group or an ethyl group.

(((15))) A process cartridge comprising the electrophotographic photoreceptor according to any one of (((1))) to (((14))), and
being attachable to and detachable from an image forming apparatus.
   (((16))) An image forming apparatus comprising:
the electrophotographic photoreceptor according to any one of (((1))) to (((14)));
a charging unit that charges a surface of the electrophotographic photoreceptor;
an electrostatic latent image forming unit that forms an electrostatic latent image on the charged surface of the electrophotographic photoreceptor;
a development unit that develops, using a developer including toner, the electrostatic latent image formed on the surface of the electrophotographic photoreceptor to form a toner image; and
a transfer unit that transfers the toner image onto a surface of a recording medium.

What is claimed is:

1. An electrophotographic photoreceptor comprising:
a conductive substrate;
an undercoat layer that is disposed on the conductive substrate and contains a binder resin and an electron transport material represented by a general formula (P) below; and
a photosensitive layer that is disposed on the undercoat layer and contains at least one resin of a polyarylate resin containing a dicarboxylic unit represented by a formula (A) below and a diol unit represented by a formula (B) below and a polycarbonate resin containing a biphenyl-containing constitutional unit represented by a formula (BP) below in an amount of more than 15 mol % relative to all constitutional units, 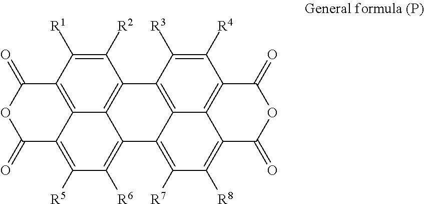
wherein in the general formula (P), R¹, R², R³, R⁴, R⁵, R⁶, R⁷, and R⁸ each independently represent a hydrogen atom, an alkyl group, an alkoxy group, an aralkyl group, an aryl group, an alkoxycarbonyl group, or a halogen atom, 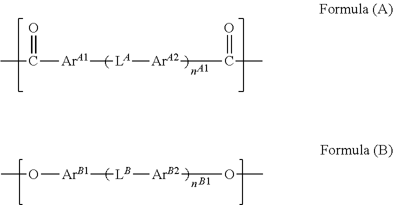
in the formula (A), Ar^{A1} and Ar^{A2} are each independently an aromatic ring that may have a substituent, L^{A} is a single bond or a divalent linking group, n^{A1} is 0, 1, or 2,
in the formula (B), Ar^{B1} and Ar^{B2} are each independently an aromatic ring that may have a substituent, L^{B} is a single bond, an oxygen atom, a sulfur atom, or —C(Rb¹)(Rb²)—, n^{B1} is 0, 1, or 2, Rb¹ and Rb² are each independently a hydrogen atom, an alkyl group having 1 or more and 20 or less carbon atoms, an aryl group having 6 or more and 12 or less carbon atoms, or an aralkyl group having 7 or more and 20 or less carbon atoms, Rb¹ and Rb² may be bonded together to form a cyclic alkyl group, 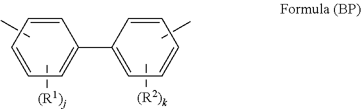
in the formula (BP), j is an integer of 0 or more and 4 or less, j R¹'s are each independently a methyl group or an ethyl group, k is an integer of 0 or more and 4 or less, and k R²'s are each independently a methyl group or an ethyl group.

2. The electrophotographic photoreceptor according to claim 1, wherein in the general formula (P), R¹, R², R³, R⁴, R⁵, R⁶, R⁷, and R⁸ each independently represent a hydrogen atom or a halogen atom.

3. The electrophotographic photoreceptor according to claim 2, wherein in the general formula (P), R¹, R², R³, R⁴, R⁵, R⁶, R⁷, and R⁸ represent a hydrogen atom.

4. The electrophotographic photoreceptor according to claim 1, wherein the electron transport material has an average primary particle diameter of 1.00 μm or less.

5. The electrophotographic photoreceptor according to claim 4, wherein the electron transport material has an average primary particle diameter of 0.03 μm or more and 1.00 μm or less.

6. The electrophotographic photoreceptor according to claim 1, wherein a content of the electron transport material relative to a total solid content of the undercoat layer is less than 70 mass %.

7. The electrophotographic photoreceptor according to claim 1, wherein the undercoat layer has a thickness of 5 μm or more and 15 μm or less.

8. The electrophotographic photoreceptor according to claim 1, wherein the binder resin is a thermosetting resin.

9. The electrophotographic photoreceptor according to claim 8, wherein the thermosetting resin contains at least one resin selected from the group consisting of a urethane resin, a melamine resin, and a benzoguanamine resin.

10. The electrophotographic photoreceptor according to claim 1, wherein the undercoat layer contains a metal oxide, and
a content of the metal oxide relative to a total solid content of the undercoat layer is 5 mass % or less.

11. The electrophotographic photoreceptor according to claim 1, wherein the dicarboxylic unit represented by the formula (A) includes at least one selected from the group consisting of a dicarboxylic unit (A1) represented by a formula (A1) below, a dicarboxylic unit (A2) represented by a formula (A2) below, a dicarboxylic unit (A3) represented by a formula (A3) below, a dicarboxylic unit (A4) represented by a formula (A4) below, and a dicarboxylic unit (A5) represented by a formula (A5) below: 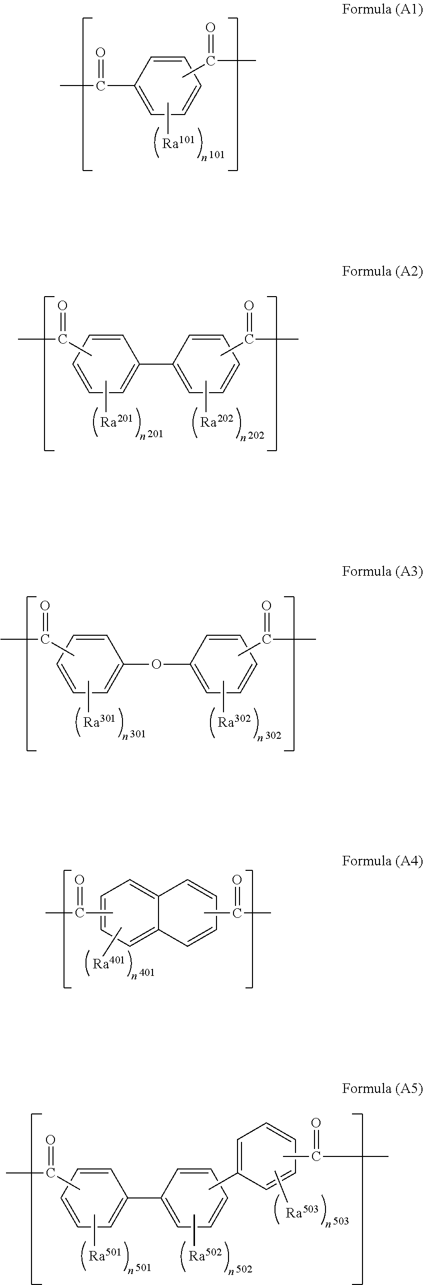
in the formula (A1), n¹⁰¹ is an integer of 0 or more and 4 or less, n¹⁰¹ Ra¹⁰¹'s are each independently an alkyl group having 1 or more and 10 or less carbon atoms, an aryl group having 6 or more and 12 or less carbon atoms, or an alkoxy group having 1 or more and 6 or less carbon atoms,
in the formula (A2), n²⁰¹ and n²⁰² are each independently an integer of 0 or more and 4 or less, n²⁰¹ Ra²⁰¹'s and n²⁰² Ra²⁰²'s are each independently an alkyl group having 1 or more and 10 or less carbon atoms, an aryl group having 6 or more and 12 or less carbon atoms, or an alkoxy group having 1 or more and 6 or less carbon atoms,
in the formula (A3), n³⁰¹ and n³⁰² are each independently an integer of 0 or more and 4 or less, n³⁰¹ Ra³⁰¹'s and n³⁰² Ra³⁰²'s are each independently an alkyl group having 1 or more and 10 or less carbon atoms, an aryl group having 6 or more and 12 or less carbon atoms, or an alkoxy group having 1 or more and 6 or less carbon atoms,
in the formula (A4), n⁴⁰¹ is an integer of 0 or more and 6 or less, n⁴⁰¹ Ra⁴⁰¹'s are each independently an alkyl group having 1 or more and 10 or less carbon atoms, an aryl group having 6 or more and 12 or less carbon atoms, or an alkoxy group having 1 or more and 6 or less carbon atoms, and
in the formula (A5), n⁵⁰¹, n⁵⁰², and n⁵⁰³ are each independently an integer of 0 or more and 4 or less, n⁵⁰¹ Ra⁵⁰¹'s, n⁵⁰² Ra⁵⁰²'s, and n⁵⁰³ Ra⁵⁰³'s are each independently an alkyl group having 1 or more and 10 or less carbon atoms, an aryl group having 6 or more and 12 or less carbon atoms, or an alkoxy group having 1 or more and 6 or less carbon atoms.

12. The electrophotographic photoreceptor according to claim 1, wherein the diol unit represented by the formula (B) includes at least one selected from the group consisting of a diol unit (B1) represented by a formula (B1) below, a diol unit (B2) represented by a formula (B2) below, a diol unit (B3) represented by a formula (B3) below, a diol unit (B4) represented by a formula (B4) below, a diol unit (B5) represented by a formula (B5) below, a diol unit (B6) represented by a formula (B6) below, a diol unit (B7) represented by a formula (B7) below, and a diol unit (B8) represented by a formula (B8) below: 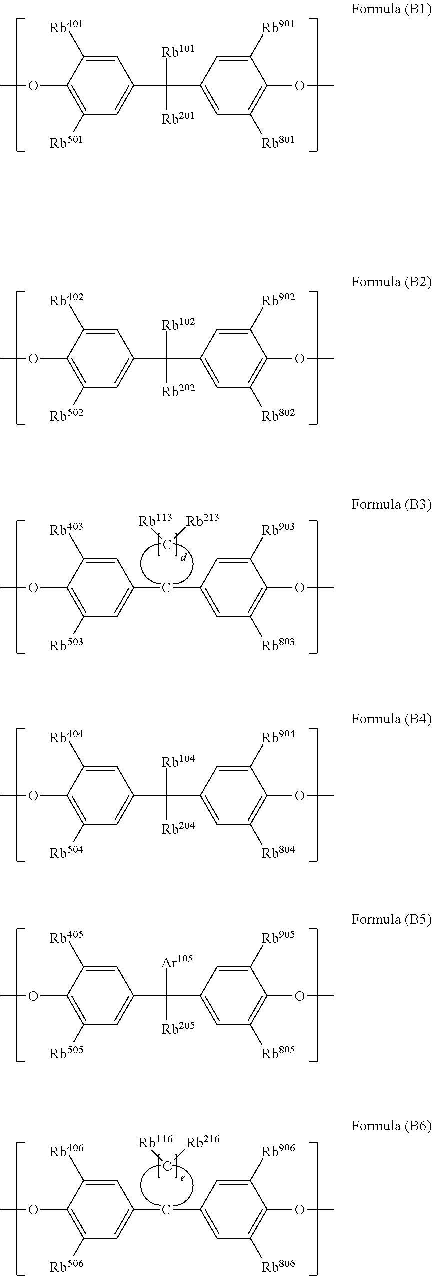 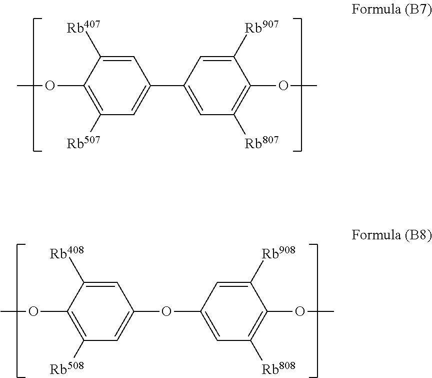
in the formula (B1), Rb¹⁰¹ is a branched alkyl group having 4 or more and 20 or less carbon atoms, Rb²⁰¹ is a hydrogen atom or an alkyl group having 1 or more and 3 or less carbon atoms, Rb⁴⁰¹, Rb⁵⁰¹, Rb⁸⁰¹, and Rb⁹⁰¹ are each independently a hydrogen atom, an alkyl group having 1 or more and 4 or less carbon atoms, an alkoxy group having 1 or more and 6 or less carbon atoms, or a halogen atom,
in the formula (B2), Rb¹⁰² is a linear alkyl group having 4 or more and 20 or less carbon atoms, Rb²⁰² is a hydrogen atom or an alkyl group having 1 or more and 3 or less carbon atoms, Rb⁴⁰², Rb⁵⁰², Rb⁸⁰², and Rb⁹⁰² are each independently a hydrogen atom, an alkyl group having 1 or more and 4 or less carbon atoms, an alkoxy group having 1 or more and 6 or less carbon atoms, or a halogen atom,
in the formula (B3), Rb¹¹³ and Rb²¹³ are each independently a hydrogen atom, a linear alkyl group having 1 or more and 3 or less carbon atoms, an alkoxy group having 1 or more and 4 or less carbon atoms, or a halogen atom, d is an integer of 7 or more and 15 or less, Rb⁴⁰³, Rb⁵⁰³, Rb⁸⁰³, and Rb⁹⁰³ are each independently a hydrogen atom, an alkyl group having 1 or more and 4 or less carbon atoms, an alkoxy group having 1 or more and 6 or less carbon atoms, or a halogen atom,
in the formula (B4), Rb¹⁰⁴ and Rb²⁰⁴ are each independently a hydrogen atom or an alkyl group having 1 or more and 3 or less carbon atoms, Rb⁴⁰⁴, Rb⁵⁰⁴, Rb⁸⁰⁴, and Rb⁹⁰⁴ are each independently a hydrogen atom, an alkyl group having 1 or more and 4 or less carbon atoms, an alkoxy group having 1 or more and 6 or less carbon atoms, or a halogen atom,
in the formula (B5), Ar¹⁰⁵ is an aryl group having 6 or more and 12 or less carbon atoms or an aralkyl group having 7 or more and 20 or less carbon atoms, Rb²⁰⁵ is a hydrogen atom or an alkyl group having 1 or more and 3 or less carbon atoms, Rb⁴⁰⁵, Rb⁵⁰⁵, Rb⁸⁰⁵, and Rb⁹⁰⁵ are each independently a hydrogen atom, an alkyl group having 1 or more and 4 or less carbon atoms, an alkoxy group having 1 or more and 6 or less carbon atoms, or a halogen atom,
in the formula (B6), Rb¹¹⁶ and Rb²¹⁶ are each independently a hydrogen atom, a linear alkyl group having 1 or more and 3 or less carbon atoms, an alkoxy group having 1 or more and 4 or less carbon atoms, or a halogen atom, e is an integer of 4 or more and 6 or less, Rb⁴⁰⁶, Rb⁵⁰⁶, Rb⁸⁰⁶, and Rb⁹⁰⁶ are each independently a hydrogen atom, an alkyl group having 1 or more and 4 or less carbon atoms, an alkoxy group having 1 or more and 6 or less carbon atoms, or a halogen atom,
in the formula (B7), Rb⁴⁰⁷, Rb⁵⁰⁷, Rb⁸⁰⁷, and Rb⁹⁰⁷ are each independently a hydrogen atom, an alkyl group having 1 or more and 4 or less carbon atoms, an alkoxy group having 1 or more and 6 or less carbon atoms, or a halogen atom, and
in the formula (B8), Rb⁴⁰⁸, Rb⁵⁰⁸, Rb⁸⁰⁸, and Rb⁹⁰⁸ are each independently a hydrogen atom, an alkyl group having 1 or more and 4 or less carbon atoms, an alkoxy group having 1 or more and 6 or less carbon atoms, or a halogen atom.

13. The electrophotographic photoreceptor according to claim 1, wherein the photosensitive layer contains the polyarylate resin and the polycarbonate resin.

14. The electrophotographic photoreceptor according to claim 13, wherein the polyarylate resin and the polycarbonate resin each contain a biphenyl-containing constitutional unit represented by a formula (BP) below: 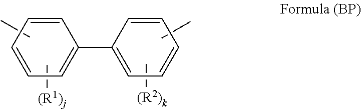
in the formula (BP), j is an integer of 0 or more and 4 or less, j R¹'s are each independently a methyl group or an ethyl group, k is an integer of 0 or more and 4 or less, and k R²'s are each independently a methyl group or an ethyl group.

15. A process cartridge comprising the electrophotographic photoreceptor according to claim 1, and
being attachable to and detachable from an image forming apparatus.

16. A process cartridge comprising the electrophotographic photoreceptor according to claim 2, and
being attachable to and detachable from an image forming apparatus.

17. A process cartridge comprising the electrophotographic photoreceptor according to claim 3, and
being attachable to and detachable from an image forming apparatus.

18. A process cartridge comprising the electrophotographic photoreceptor according to claim 4, and
being attachable to and detachable from an image forming apparatus.

19. A process cartridge comprising the electrophotographic photoreceptor according to claim 5, and
being attachable to and detachable from an image forming apparatus.

20. An image forming apparatus comprising:
the electrophotographic photoreceptor according to claim 1;
a charging unit that charges a surface of the electrophotographic photoreceptor;
an electrostatic latent image forming unit that forms an electrostatic latent image on the charged surface of the electrophotographic photoreceptor;
a development unit that develops, using a developer including toner, the electrostatic latent image formed on the surface of the electrophotographic photoreceptor to form a toner image; and
a transfer unit that transfers the toner image onto a surface of a recording medium.
